(19) United States
(12) Patent Application Publication
(10) Pub. No.: US 2006/0024654 A1
(43) Pub. Date: Feb. 2, 2006

(54) Unified generator of intelligent tutoring

(76) Inventor: Vladimir Antonovich Goodkovsky, Greenbelt, MD (US)

Correspondence Address: Vladimir Goodkovsky, 328 Minor Ridge Road, Charlottesville, VA, 22901-1652, US

(21) Appl. No.: 10/909,101

(22) Filed: Jul. 31, 2004

(51) Int. Cl. G09B 3/00

(52) U.S. Cl. 434/350

(57) ABSTRACT

The invention accelerates successful learning in a wide variety of existing and developing learning environments by generating the most effective dynamic adaptive tutoring tailored to a current learner model. It provides a full coverage of a basic tutoring functionality including passive and active tutoring manners, as well as presenting, testing and diagnosing modes. An innovative component of the invention, a unified generator of intelligent tutoring, deals exclusively with a logical aspect of tutoring leaving all media aspects to be realized by traditional components of tutoring systems. The generator represents a generic logical core (brain) of known specific intelligent tutoring systems comprising a reusable tutoring engine and a reusable tutoring knowledge/data framework including a reusable learner model. All together they transform traditionally sophisticated courseware authoring into a simple fill-in-frameworks routine and automatically generate intelligent tutoring in any specific learning environments including available educational, training, simulation, knowledge management and job support systems.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention belongs to the field of instructional technology for education and training as well as to other closely related fields such as knowledge management, performance support and job aids, covering computer/web-based education and training, so named e-learning, learning management, learning content management, competency-based learning, adaptive model-based learning, and specifically focused on a generative core of intelligent tutoring systems.

Our theoretical analysis shows that educational and training technologies (usually presented in very different forms: from e-books, simulators, games, computer/web-based training courses, up to intelligent tutoring systems) include a nesting hierarchy of the same models (though some of them exists in embryo or hidden form):
a) a domain model representing a piece of the world under learner study. It can be represented in any media form (text, picture, audio, video, animation, simulation, virtual reality, physical models and even real objects). The domain model represents what is given to the learner for study. It supplies the learner with what to learn and thus represents a supplying kind of learning resources: presentations, demonstrations, simulations, and exercises.
b) a task model representing job(s), mission(s), task(s) to perform or question(s) to answer in said domain. The task model represents not only what is given in the domain, but also what is required. What is given is already represented with said domain model. What is required can be assigned to the learner by a tutor with a message in any media form. In other words, the task model is a problem situation in the domain to initiate a specific (problem solving) activity of the learner. It can exist in a form of exercising, testing and diagnosing learning resources.
c) an expert model representing said job(s), mission(s), task(s) performing or question(s) answering expertise, procedure and/or results of a human expert in said domain. In its simplest embodiment, it can be just an alternative of correct answer in a multiple choice question. In the most complex embodiment, it can be an expert system solving certain set of problems in said domain. In general, an expert model represents a goal/objective(s) of learning/tutoring process. Additionally, it can be used as a supplying kind of learning resource to demonstrate correct solutions to the learner.
d) a learner model representing the same job(s), mission(s), and/or task(s) performing expertise, procedure and/or results of a particular learner in said domain. It describes said expert model together with typical deviations of the learner from it. Such deviations can be used by a tutor additionally as a supplying learning resource to demonstrate typical incorrect solutions to the learner.
e) a learning space model combining a plurality of instances of learner models in different time points and for different learners from a target audience and representing their job(s), mission(s), and/or task(s) performing expertise, procedures and/or results in the same domain. It describes learning goal/objective(s) together with all possible deviations of learners. In the simplest form, a learning space model can be represented just as a list of learning cases. If the cases are mutually exclusive, then it is so named “OR” state space model, which is simple in theory, but is too large in practice. In practice, much more compact and affordable is “AND-OR” space model, which can use a few non-exclusive variables (AND) and their exclusive values (OR), to represent an enormous plurality of different learner model cases.
f) a tutoring task model representing job/tasks of a tutor in said learning space. In this task, what may be given is a learner's position in the learning space and available learning activities/resources able to change this position; what is required is an expert's position in said learning space. Actually, this is a control task of the control theory. As a rule, a real position of a learner in the learning space is unknown. So, an observation task is arising. In the observation task, what is given is a learner, learning space model and learning activities/resources of testing/diagnosing kind; what is required is to find learner's position in said learning space. In said “AND-OR” and “OR” learning space models, representation of said control and observation tasks are different. Particularly in the most compact “AND-OR” space model, the observation task consists of a testing task (to check achievement of goal/objectives) and diagnosing tasks (to backtrack faults down to their causes).
g) a tutoring expert model (or a tutor model for short) representing tutoring job/task(s) performing expertise, procedure and results of an expert tutor activity in said learning space. In “OR” learning space model, an adaptive tutoring activity can be represented by twofold. The first, the tutor observes a learning activity of the learner by using testing/diagnosing resources trying to find learner's current position in said learning space. The second, after the position is found and it is not an expert position, the tutor is able to precisely select and supply the learner with the best learning resources for this particular learner trying to “push” him/her by the most effective way in direction to the expert's position in this learning space. Then the tutor observes again to define an updated learner's position for the next best “push” and so on. In said, more compact, “AND-OR” learning space, the same process looks threefold, like an integration of supplying, testing, and diagnosing task solving activities. In reality, there is no strict separation of supplying, testing, and diagnosing resources. From one side, testing/diagnosing resources can cause a change of learner's position in the learning space. From another side, learner's response on supplying learning resources can provide certain evidence about his/her current position in the learning space. That is why in an ideal case, an expert-tutor should solve said control (supplying) and observation (testing and diagnosing) tasks in parallel by intelligent managing all available learning resources in order to achieve learning goal/objectives by the most effective way.

The first three (a-c) models are basic and elaborated pretty well in instructional system design, related generic theories and technologies. See for example (Anderson et al., 1995), (Scandura, 2003). In contrast, the last four (d-g) models are not developed so well so far. Indeed, due to its nesting structure and incrementing complexity, each next model is more complex and less developed than previous one. And the least developed is the tutor model.

Known learner models instantiating said learning spaces are different. The most advanced of them are as follows:
a) Overlay learner model representing a learner expertise in terms of what the learner knows and does not know in a specific domain. See for example, http://www.cs.mdx.ac.uk/staffpages/serengul/Overlay.student.models.htm.
b) Learner model as an expert solution of a specific task as in model tracing tutors (Anderson et al., 1995);
c) Perturbation learner models representing expert systems with intentionally embedded bugs or just bug libraries collecting learners' misunderstanding, false concepts, wrong rules, et cetera. See for example, http://www.cs.mdx.ac.tuk/staffpages/serenigul/perturbation.student.models.htm.

Fuzzy (Goodkovsky, 1992), Bayesian (Mislevy and Gitomer, 1996), and belief (Murray and VanLehn, 2000) networks representing variety of learner models with uncertain assessments and dependencies, which are common in tutoring practice.

Known learning space models include said OR and AND-OR space models. Pure OR space model is illustrated with known “knowledge space theory” (Dietrich Albert Cord Hockemeyer, 1997) and a classical Bayesian model. They are not compact and affordable in practice. AND-OR space model is illustrated with simple, affordable and widely spread overlay learner models.

Known tutoring job/tasks representation, which actually represents an assignment to fill the gap between an expert and learner models in said learning space, is quite different in available theories, technologies, and learning applications. Only commonly recognized tutoring tasks are a plan design, sequencing of learning activities/resources and assessments of different kind. Actually, core tasks of any human complex activity comprise the similar tasks:
a) Planning,
b) Implementation,
c) Assessment of progress,
d) Assessment-based re-planning.

The tutoring expert model (a tutor model), which should be able to fill the gap between the expert and learner models in said learning space by solving above mentioned 1-4 tutoring tasks, is understood and represented quite different as well. Perhaps, the most common is unanimous recognition of complexity of a complete tutor model. Another common feature is a prevailing of approach/domain/task-specific heuristic tutors, which are not reusable for other approaches, domain and tasks. See for example (R. Stottller and N. Harmon, 2003). The third is a triviality of known reusable technological tutoring solutions. For example, existing “high-end” Computer-Based Training authoring tools support only simplest manual script/flowchart-based models of tutoring activity, which in practice is used mostly for linear sequencing of the same learning activities/resources for all learners. Even Advanced Distributed Learning Lab's Sharable Content Object Reference Model, SCORM 2004, supports only simple sequencing as well. See (http://www.adinet.org/index.cfm?fuseaction=scormabt).

The known endeavors in generic planning of tutoring activity (from scratch to the end) are based on implementation of Artificial Intelligence, which appears to be very sophisticated for common practical application (Bruce Mills, 2002). Moreover, due to unpredictability of learning activity, detailed plans developed in advance (from scratch to the end) are getting obsolete very soon and require re-planning after each assessment of real learning progress.

What is really required in tutoring technologies is dynamic adaptive planning of learning activity that departs from a current learning progress (learner's position in said learning space). The problem is that said current learning progress is directly unobservable and should be indirectly assessed and reassessed in real tine. To be effective and efficient such assessment in its turn requires dynamic adaptive planning as well. There are no yet tools for automating such a complex tutoring activity. That is why in practice, the automated tutoring is narrowed to very specific tasks, like in (Liegle; El-Sheikh), or to pre-sequencing of entire learning lessons in contrast to sequencing of fine learning activities/resources within each lesson, like in (Sun-Teck Tan, 1996).

The most of known intelligent tutoring systems are developed by heuristic-based programming from scratch. As a rule they represent a unique monolith of hardwired learning resources, tools, and assessment/decision makers based on a specific learning theory/paradigm/vision. See for example (R. Stottler and N. Harmon, 2003). As a rule, they are not reusable for other theories and applications. Though, implementing object-oriented programming paradigm allows developers to accumulate proprietary building blocks to accelerate building new ITSs, there is no any evidence of any generic block, which dynamically solves all above mentioned control, observation and diagnosing tutoring tasks for all specific domain applications.

Known Bayesian, fuzzy, belief networks are known to be the finest generic tools for dynamic assessment of learning progress, but they are only the tools that again require programming, which can be done by different way by different developers with their different experience and visions. Moreover, these networks do not perform required planning functions, which are the most critical in intelligent tutoring (Mislevy and Gitomer, 1996).

Known extensions of belief networks with decision making nodes are able potentially to support simple planning operations. In (R. Murray and Kurt VanLehn, 2000), a belief/decision network has been used to automate a “coaching” task of tutoring activity. Indeed, these belief/decision networks represent a powerful tool for developing intelligent instructional applications. But again they are just tools, which require sophisticated reprogramming for each specific domain application.

Known machine learning techniques (e.g., neural networks, case-based reasoning) are able to replace inevitably complex programming with machine learning of tutoring activity demonstrated by expert-tutor, but without prior tutoring knowledge it requires unrealistically long training procedures for really intelligent tutoring.

So, it looks like there are some intractable problems in instructional technologies, which include the following:
a) no generic compact model of a learning space, specific enough to represent fine tutoring knowledge/data within any instructional unit, compliant with known pedagogical theories and best practices and ready to be used for any new specific domain and job/tasks to learn;
b) no generic model of a learner compliant with the generic learning space model and specific enough to be easily tuned for any learner from the target audience;
c) no generic model of entire tutoring job/mission specific enough to represent an integration of tutoring control and observation tasks, where latter includes testing and diagnosing tasks;
d) no generic model of a tutoring task solver (a tutoring engine) capable of dynamic adaptive planning and execution of the multitask tutoring activity in user customized manners and forms;

Despite of the facts that some solutions of said a-b problems are known, and there are always possibility to dispute solution of said c-d problems, definitely there is no any consistent solution of all these a-d problems yet.

In my past work [Goodkovsky 2002], I developed a composition and methods of computer-based intelligent tutoring system covering a reusable generic domain shell and player, tutor model and domain-tutor interface. Particularly, developed technical solution for the tutor model represents a computer program only. This program includes a mix of generic logic and specific media components. It is based on the fuzzy logic and focused mostly on the active tutoring manner, specifically on dynamic adaptive selecting only the next single tutoring assignment. Proposed tutoring task structure is pretty sophisticated and includes five tasks and three sub-tasks (named as modes and sub-modes). It does not separate logic and media of tutoring systems completely. It does not include a complete technical solution of passive tutoring. It does not include a technical solution of a multiple tutoring assignment of learning resources for the learner's own choice of single one. Learning resources are entirely separated in two categories—presentations and tests—each with quite different processing. These features make representation of tutoring knowledge/data as well as their processing excessively complex. There was not invented extensive pre-processing of tutoring data, which could accelerate processing in real time.

Actually, I authored only the provisional patent and did participate in the nonprovisional patent application [Goodkovsky 2002]. As a result, the nonprovisional patent application was not properly completed. Particularly, it did not disclose the diagnosing procedure in sufficient detail. Moreover a key component of the system, the reviser of the learner model, was not disclosed at all. Without the reviser the whole system cannot be made and used. These deficiencies eliminate any possibility to make and use described system by anybody else but me.

So, the main disadvantages of the prior art are as follows:
a) Uniqueness, low reusability, complexity, and high cost of new learning applications design;
b) Deficiencies in fundamental tutoring functionality, which eliminate a possibility to accelerate successful learning.

A goal of present invention is to solve above mentioned problems a-d representing a core of the instructional technology and intelligent tutoring. Here I developed a new combination of mutually consistent solutions of these problems. The whole system is not necessarily a computer-based program. Particularly, it can include any other kind of learning environment such as physical models, real job tools and equipment. The invention separates the logic and media of tutoring completely. It provides generic logical frameworks for tutoring knowledge/data and the generic engine for automatic generating of intelligent tutoring. A core technical solution represents a unified yet customizable generator of intelligent tutoring, which is capable of solving a complete set of fundamental tutoring tasks in both passive and active tutoring manner. In both active and passive manners of tutoring, it provides a dynamic fine assessment of learner's progress with corresponding tutoring feedback. The active manner of tutoring is realized with only three fundamental tutoring tasks, named modes (supply, testing and diagnosing). It also realizes multiple tutoring assignments by dynamic adaptive restricting of learner's access to available learning activities/resources. Learning resources of presentation and test categories are represented uniformly, which allowed unification and simplification of their processing. This tutoring generator does not require reprogramming for any new application, just entering new application-specific knowledge/data is enough.

Finally, invented methods and compositions are completely described hereinafter in sufficient detail. So any specialist with regular qualification can make and everybody will be able to use them.

### BRIEF SUMMARY OF THE INVENTION

The invention is a method and a system powered by a generator of dynamic adaptive (intelligent) tutoring of a learner in a learning environment. Its goal is to accelerate learning experience by fine monitoring and effective controlling a learning activity. It is known fact that intelligent tutoring is able to provide two sigma shift in average mastery compared with unsupervised learning (Bloom, 1984), which means 98% of learning success in average.

The invention realizes the fundamental idea to completely separate logic and media in the learning/tutoring process in order to generalize the logic and reuse it with any specific media, which can include but is not limited to traditional learning materials, computer-based media, audio/video players, physical models and real objects under study as well as their any combination.

The core component of invention, a logic generator of intelligent tutoring, includes a uniform framework-based knowledge/data model, including a learner model, and uniform tutoring engine. It can be used as a middleware between an administrative layer and content authoring/delivering layer of existing and future instructional systems, e-learning, knowledge management, job aid and performance support systems.

In an authoring stage, instructional designers do not need anymore to manually design very sophisticated rules, scripts, or flowcharts of tutoring from scratch. All they need is to fill in said uniform knowledge/data framework with their specific knowledge/data and associate them with specific (available or to be developed) media resources. It significantly simplifies very labor-consuming authoring job, prevents frequent errors and as a result guarantees a better quality of a courseware. Due to these features, a requirement bar to instructional expertise of authors can be lowered and practically everybody can be a successful author of the intelligent courseware. So, the same people can be learners and authors. It opens new horizons for a reliable transfer of knowledge/skills among people vs regular very unreliable transfer of information among them.

In a passive (non-intrusive) manner, that is most appropriate for a job/performance support and final stages of training, the generator obtains learning activity reports from a monitor tracking learning activity of the learner in the learning environment, interprets said reports, assesses current progress of the learner, optionally provides sound assessment-based (vs traditional shallow, tracked data-based only) feedback messages to the learner, and makes main tutoring decisions. Particularly, if identified faults of the learner exceed a predefined tolerance level or the faults' cause (which is a dead-end of learning process) is clearly diagnosed, then it recommends a learner to switch to the active tutoring manner.

In an active (interventional) manner, that is the most appropriate for conceptual education, initial stages of training, and fault remediation, the tutoring generator extends its passive functionality. It dynamically selects a current tutoring mode (supply, testing or diagnosing). With each of these modes depending of the learner choice, it can dynamically and adaptively pre-select available extra learning activities/resources for a final choice of the learner, rate available learning activities/resources in accordance with their current personal utility for informed learner's choice, or automatically select the best next learning activity/resource. All of these are performed to achieve desired learning objectives by the most effective way tailored to a personal learner's style preferences and current assessment of learning progress through the learning objectives.

The learning environment can be quite different. Its main mission in the tutoring system is to physically support desired learning activity of the learner by creating specific learning situations and getting back learner's response. The learning environment can include any real object for study or its more transparent, cheaper, non-dangerous physical replica. It can be a real job/mission environment: an equipment to maintain, truck to drive, telephone to communicate, computer to operate et cetera. In particular computer-based embodiment, the learning environment can include multimedia (text, audio, graphic, video, animation, simulation, game, and virtual reality) and provide pre-storing, retrieval, delivery and playing back available learning resources (presentations, simulations, exercises, and tests). The only limit for using any available environment as a learning media is our ability to enable monitoring and controlling of the learning activity in it. But this ability is defined with other parts of the tutoring system, a logic-media converter, which includes a monitor and a controller.

In general, the monitor performs:
a) tracking an actual learning behavior including tutoring assignment (i), learning situation and a corresponding learner's actual response;
b) pre-storing expected responses {k} of a learner (an expert-like response, at least) in typical learning situations {s} within tutoring assignment (i);
c) identifying an actual behavior of the learner including selected assignments, learning situations and responses by comparison their actual tracked data with corresponding pre-stored data;
d) providing the generator with behavior reports including identifiers of selected assignment (i′), recognized situation (s′) and learner's response (k′).

Specific embodiments of the monitor depend of specific embodiment of the learning environment and are well known in instructional technologies.

In general, the controller performs:
a) accepting tutoring decisions from the logic generator;
b) generating commands on the learning environment to execute tutoring decisions.

Specific embodiments of the controller also depend of specific embodiment of the learning environment and are well known in instructional technologies.

The logic generator is the most innovative component of the whole system. It deals exclusively with logical data by:
a) making main tutoring decisions including decisions to
   1. to end tutoring and provide tutoring report to the administrator,
   2. switch current passive manner to the active manner of operation,
   3. set up a current tutoring mode (supply, testing or diagnosing),
   4. pre-select available learning activities/resources for the learner's own choice,
   5. rate pre-selected learning activities/resources for learner's informed choice,
   6. directly assign specific learning situations for the learner to initiate his/her desired learning activity,
   7. decisions to provide commenting and feedback messages,
b) providing the controller with said decisions for executing in the media environment;
c) letting the learner to realize assigned learning activity in the media environment;
d) accepting the learning report from the monitor;
e) interpreting each accepted report into internal generator's knowledge/data and
f) adapting generator's current knowledge/data about current learning state of the learner.

In preferred extended embodiment, the whole system includes also an authoring tool to support logical part of courseware creation. This tool is based on a set of tutoring knowledge/data frameworks and can be integrated with existing multimedia, CBT, and simulation authoring tools in order to:
a) combine logical design and media development in the most consistent way;
b) provide logical skeletons (blue prints) for design of new media flesh;
c) reveal logical skeletons behind available media flesh;
d) check mutual logical consistency and sufficiency of courseware;
e) test and debug the created logic on an early logical stage prior to investing in any media design and development.

In terms of getting popular Advanced Distributed Learning and Sharable Content Object Reference Model (SCORM), the invention provides existing and perspective learning (content) management systems, which automates mainly administrative functions, with the following pure tutoring extensions:
a) Uniform logical frame work for specification of intelligent Shareable Content Objects to extend the regular Shareable Content Object framework;
b) Uniform sequencing engine for a tutoring run-time environment able to dynamically and adaptively sequence Sharable Content Assets in said intelligent Shareable Content Objects to extend available engines for simple sequencing: free browsing, linear, branching, etc.;
c) Uniform communication protocol between said intelligent Shareable Content Objects and said uniform sequencing engine.

The most important feature of the invented technical solution is its reusability or uniformity. The reusability or uniformity is due to the following reasons:
a) No restrictions on a domain, job/mission/task, or activity to learn.
b) No restriction on learning media environment.
c) Separation of generalizable logic (skeletons) from specific media (flesh) and dealing exclusively with generalizable logic, leaving all specific media data and operations for the learning environment and the logic-media converter.
d) generic logical representation of tutoring process as an objective-oriented control over an ill-observable and ill-controllable object (a learner) by sequencing available control (learning supply) and observation (testing/diagnosing) resources;
e) separation of domain/tasks-specific tutoring knowledge/data and generic domain/tasks-independent tutoring engine, which uses this knowledge/data;
f) providing a generic framework for said domain/tasks-specific tutoring knowledge/data.
g) use of very generic conception of learning objectives as a uniform basis to define different kind of targeted experiences, abilities, knowledge, skills, attitudes, which can be domain, tasks and activity specific;
h) combining traditionally separated known approaches to intelligent tutoring systems design on one logical basis including model tracing tutors (Anderson et al, 1995), adaptive hypermedia (Brusilovsky, 2003), belief/decision networks (Murray, 2000) etc;
i) using the same logical framework for specification of all kind of specific learning resources including presentations, simulations, exercises, tasks and questions;
j) using a uniform framework for representing specific personal data of any learner;
k) matching even uncertain specific knowledge/data into its generic formal frameworks.

The other important feature of the invention is its functional completeness which is due to:
a) Realization of passive and active manners of tutoring;
b) Realization of basic supply, testing and diagnosing modes ill the active tutoring manner;
c) Realization of strategic, tactic and operative tutoring decisions in each tutoring mode;
d) Wide scale customization of decision making based upon a plurality of variable parameters of strategic, tactic and operative decisions;
e) Mixed initiative control over learning by
   1. Generator's restriction of learner's access to available learning activities/resources for his/her personal choice,
   2. Generator's rating of learning activities/resources for informed choice by the learner or
   3. Generator's direct assignment of single learning resource to learn;
f) Wide scale dynamic personal adaptation particularly including a personal testing delay, difficulty limit, media features, and selection of learning resources.

So, the main advantages of the invention are as follows:
a) Uniformity, high reusability, simplicity, and low cost of new learning applications design;
b) Completeness of fundamental tutoring functionality, which provides a necessary basis for accelerating successful leaning.

### BRIEF DESCRIPTION OF THE SEVERAL VIEWS OF THE DRAWING

FIG. 1 is a conceptual diagram which illustrates a generic environment of the invention.

FIG. 2 is a conceptual diagram of the method of tutoring

FIG. 3 is a conceptual diagram of providing the media environment

FIG. 4 is a conceptual diagram of providing the tutoring logic generator

FIG. 5 is a conceptual diagram of providing the media-logic converter

FIG. 6 is a conceptual diagram of associating the logic generator and the media environment with the logic-media converter

FIG. 7 is a conceptual diagram of the general tutoring method

FIG. 8 illustrates an external functionality of the tutoring system

FIG. 9 illustrates a generic composition of the tutoring system

FIG. 10 illustrates an example of multi-channel tutoring communication

FIG. 11 is a flowchart of tutoring system operating

FIG. 12 illustrates composition of the learning media environment

FIG. 13 is a flowchart of general operating the learning media environment

FIG. 14 is a composition of the media-logic converter

FIG. 15. is a flowchart of general operating of the controller

FIG. 16. is a flowchart of general operating of the monitor

FIG. 17. is a flowchart of tutoring system operating in passive manner (case 1)

FIG. 18. is a flowchart of tutoring system operating in active manner (case 2)

FIG. 19. is a flowchart of tutoring system operating in active manner (case 3)

FIG. 20 is a flowchart of tutoring system operating in active manner (case 4)

FIG. 21 illustrates composition of the tutoring logic generator

FIG. 22 illustrates a flowchart of the tutoring generator operating

FIG. 23 illustrates a composition of the knowledge/data model

FIG. 24 illustrates composition of the learning space framework

FIG. 25 illustrates a state transition diagram of a single learning objective

FIG. 26 is a table representation of prerequisite relations

FIG. 27 is a sample of network representation of the state space model

FIG. 28 is a tree representation of the state space framework

FIG. 29 is a table representation of the behavior space framework

FIG. 30 is a sample of table representation of single tutoring assignments

FIG. 31 is a table representation of the state-behavior relation

FIG. 32 is a table representation of learner's requirements as a check-list

FIG. 33 is a table representation of learner's preferences as a check-list

FIG. 34 is a table representation of the learner state framework/model

FIG. 35 is an example of network representation of the learner state model

FIG. 36 is a tree representation of the tutoring knowledge/data framework. Part A.

FIG. 37 is a tree representation of the tutoring knowledge/data framework. Part B.

FIG. 38 is a table representation of initial diagnostic data

FIG. 39 is a table representation of pre-processed diagnostic data

FIG. 40 is a composition of the tutoring engine

FIG. 41 is a flowchart of the tutoring engine operating

FIG. 42 is a composition of the decision maker

FIG. 43 is a flowchart of operation of the decision maker

FIG. 44 is a flowchart of the strategic decision maker operating

FIG. 45 is a table representation of strategic decision making

FIG. 46 is a flowchart of tactic decision making

FIG. 47 is a table representation of the tactic decision making

FIG. 48 illustrates an operative decision making flowchart

FIG. 49 is a sharp filtering flowchart

FIG. 50 is an updating flowchart

FIG. 51 is a flowchart of revising.

### DETAILED DESCRIPTION OF THE INVENTION

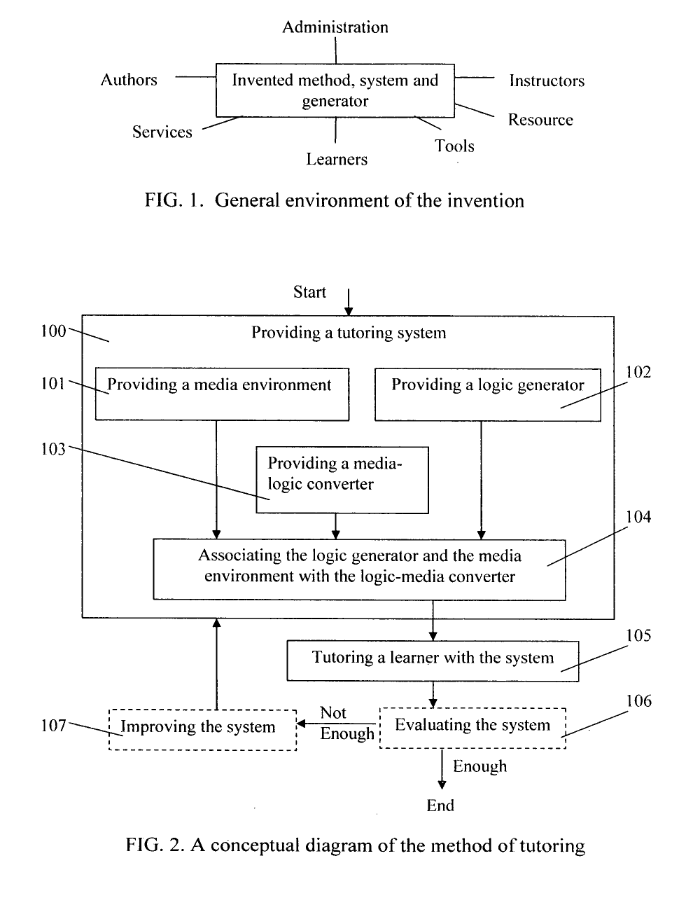

An environment or a super-system of the invention is an education, training, knowledge management, performance support and job aids. It can comprise an administration, courseware authors, instructors, and learners as well as certain services, tools and resources. See FIG. 1.

In this context, the main goals of the invention are to:
a) simplify courseware design by authors;
b) automate job of instructors;
c) accelerate learning experience of learners;
d) enable improving management by administration;
e) save labor, time and resources by providing new methods and tools.

The basic ideas of the invention are
a) complete separation of logic and media in the tutoring process,
b) rationalization and generalization of the tutoring logic and
c) reuse of generalized tutoring logic with any specific media in authoring and tutoring process.

Wherein:
a) said logic represents mainly tutoring knowledge/data and tutoring decision making;
b) said media is a physical environment to support the learning activity of the learner. Examples of the media are paper materials/books with text and graphics, electronic books, audio/video, computer-based multimedia interactive presentations, simulators, virtual reality, physical models of real objects, and even real objects under study.

The invention is a method, system and generator of dynamic adaptive (intelligent) tutoring of a learner in a wide variety of specific learning media environments.

The Method.

As illustrated in FIG. 2, an entire method for dynamic adaptive (intelligent) tutoring comprises the following main phases:
a) Providing 100 a tutoring system including
   1. providing 101 a media environment for physical supporting a learning activity of said learner;
   2. providing 102 a logic generator for making a plurality of tutoring decisions;
   3. providing 103 a media-logic converter
      A. for transforming said tutoring decisions into commands on said media environment to support said learning activity of said learner in said media environment and
      B. for reporting said learning activity into said logic generator;
   4. associating 104 said logic generator with said media environment by said media-logic converter;
b) tutoring 105 the learner with said tutoring system by controlling over said learning activity of said learner in said media environment with said logic generator through said logic-media converter;
c) Optional evaluating 106 said tutoring system;
d) Optional improving 107 said tutoring system.

Said method completely separates media and logic of the tutoring. It enables generating a media-specific tutoring process based upon generalized logic, simplifying authoring, improving quality of said tutoring process and accelerating learning success;

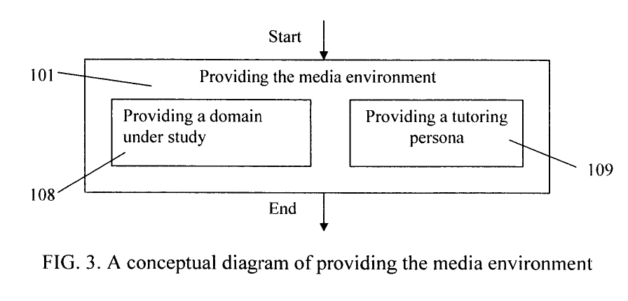

The phase 101 of providing the media environment includes but not limited to providing 108 a domain model (or a domain for short) for study and providing 109 a tutoring persona, which represents a physical embodiment of the tutoring logic generator for the learner. See FIG. 3.

Examples of the domain (model) for learner's study can be presented in paper/electronic books, audio/video clips, computer-based multimedia interactive presentations, animations, simulators, virtual reality, physical models of real objects, and even real objects for study.

Examples of the tutoring persona can be presented with pieces of instructional text in traditional paper/electronic textbook, audio device for providing a learner with feedback, device providing communication (like e-mail), computer-pictured/animated/simulated persona, a talking head, a virtual tutor, or even a real human tutor, who follows decisions/advices of the logic generator on what to do next.

Due to provided composition, the learning media environment can support several channels of communication with the learner including commenting, progress display, navigating, control over tutoring et cetera.

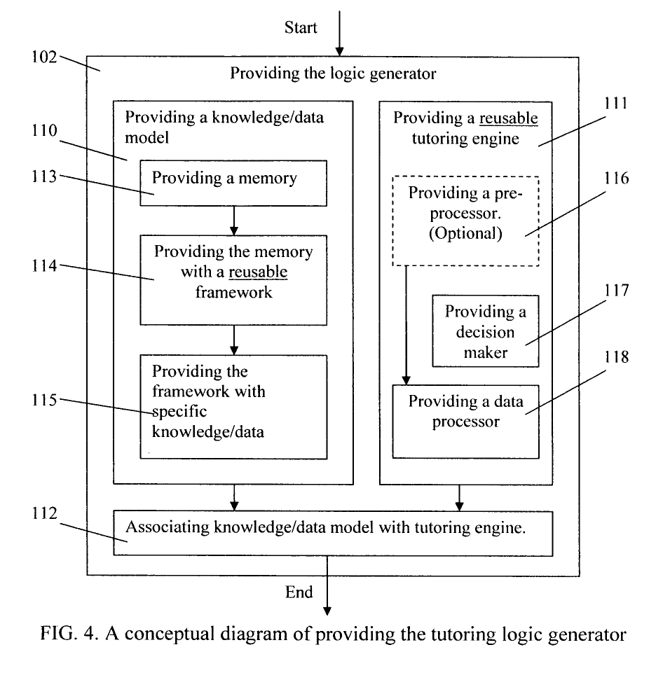

In its turn, as shown in FIG. 4, the phase 102 of providing a logic generator includes:
a) providing 110 a knowledge/data model referenced to an instructional unit, said learner, and said learning activity, which comprises:
   1. providing 113 a memory for storing tutoring knowledge/data;
   2. providing 114 the memory with a reusable uniform framework for representing said tutoring knowledge/data;
   3. providing 115 said reusable uniform framework with said tutoring knowledge/data;
b) providing 111 a reusable uniform tutoring engine for making a plurality of tutoring decisions based upon said knowledge/data model, which comprises:
   1. optional providing 116 a preprocessor for knowledge/data preprocessing;
   2. providing 117 a decision maker for making a plurality of tutoring decisions based upon said knowledge/data model;
   3. providing 118 a processor for adapting said knowledge/data model based upon a learning report about said learning activity of said learner and decisions made by said decision maker;
associating 112 said knowledge/data model with said reusable tutoring engine.

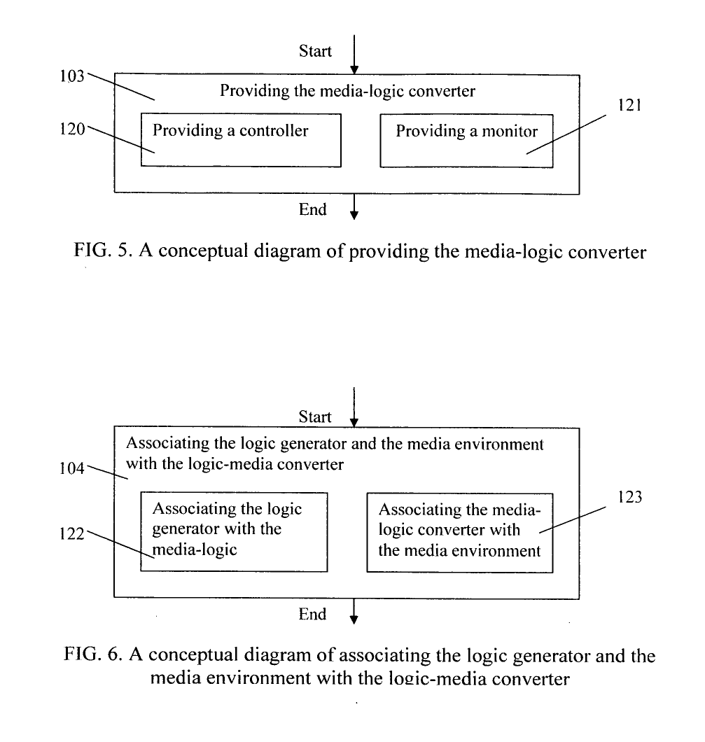

The phase 103 of providing a media-logic converter includes at least providing 120 a controller for executing tutoring decisions in the media environment and providing 121 a monitor for tracking and reporting learning activity of the learner. See FIG. 5. Depending of provided learning media environment, said providing 120 a controller and providing 121 a monitor can include providing several channels of media-logic converting, for example, for commenting, feedback, progress display, learner's control over tutoring et cetera, where each channel including a controller and/or a monitor.

As it depicted in FIG. 6, the phase 104 of associating the logic generator and the media environment with the media-logic converter includes
a) associating 122 the logic generator with the media-logic converter to enable tutoring control and communication with the media environment and
b) associating 123 the media-logic converter with the media environment to support control and monitoring of the media environment.

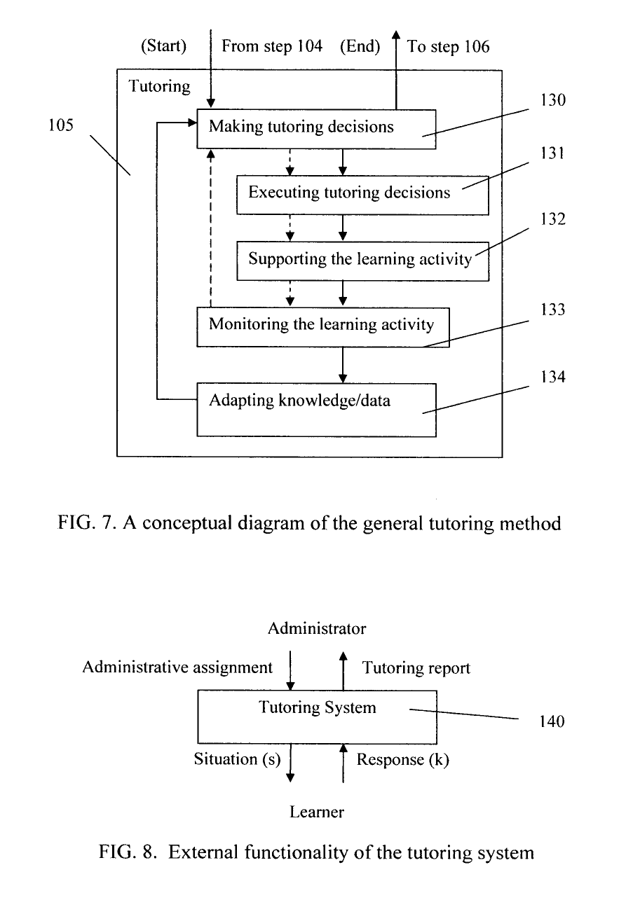

The phase 105 of tutoring can take control at any time after step 104. After completion its operation it transfers control to step 106. The tutoring can represent two nesting loops as shown in FIG. 7.

The internal loop depicted in FIG. 7 with dashed lines generates and realizes tutoring decisions (such as decisions to comment learning progress), which are not supposed to change tutoring knowledge/data and includes:
a) making 130 tutoring decisions by the decision maker based upon the knowledge/data model;
b) executing 131 said tutoring decisions by the media-logic converter providing necessary commands on the learning media environment;
c) physical supporting 132 the learning activity of the learner by the media environment;
d) monitoring 133 the learning activity and providing the decision maker with a report by the media-logic converter;
e) making 130 new tutoring decisions by the decision maker based upon the same knowledge/data model;

The external loop depicted in FIG. 7 with solid lines includes all steps 130-133 of the internal loop plus a step of adapting 134 the knowledge/data by a processor based upon the learning report and the decision made. The adapting step 134 changes the knowledge/data model and makes a difference in the following decision making 130. Namely this loop plays a key role in dynamic adaptive tutoring.

The described method provides automatic generating of a dynamic adaptive tutoring process, excludes prior manual design of the tutoring process by authors, improves quality of the tutoring process and accelerates learning success.

The optional phase 106 of evaluating the tutoring system in the finest details can include collecting data about personal progress caused by each tutoring decision, integrating these data across all learners and providing an assessment of integral efficiency of each tutoring decision.

The optional phase 107 of improving the tutoring system can be realized in manual, automated and automatic forms. In any of these forms it includes
a) analysis of learning data;
b) incrementing tutoring beliefs (from the knowledge/data model) used during a successful learning;
c) decrementing tutoring beliefs (from the knowledge/data model) used during a fault learning.

Note that steps 131-133 should be activated in described sequence, but can be performed in parallel.

The System

Definition:

The tutoring system is provided on the phase 100 of described method and realizes the tutoring of the learner on the phase 105. See FIG. 2.

Functionality:

The complete tutoring system 140 works with two main categories of users: administrators and learners. See FIG. 8.

Working with the administrator, the system accepts administrative assignments and returns tutoring reports.

Note that adult learners are often allowed to play a role of their own administrator. In this case, the learner can navigate through units of instruction, define tutoring style (to some degree), see progress reports, et cetera.

Working with the learner, the tutoring system controls over at least one specific leaning activity of the learner by
a) commenting current progress of the learner with a set of messages {c},
b) creating specific learning situations {t} including controls in the media environment and
c) monitoring the learning activity including learner responses {k}.

The tutoring system can also provide the learner with a visual display of current progress, navigation means, specific controls to select a type of tutoring assignments, et cetera.

Parameters:

System's functioning with the learner is defined by the administrative assignment provided by the administrator.

The administrative assignment includes at least:
a) an identifier of instructional unit;
b) testing threshold as a parameter of learning/tutoring sufficiency,
c) a manner of tutoring (passive or active).
   Composition

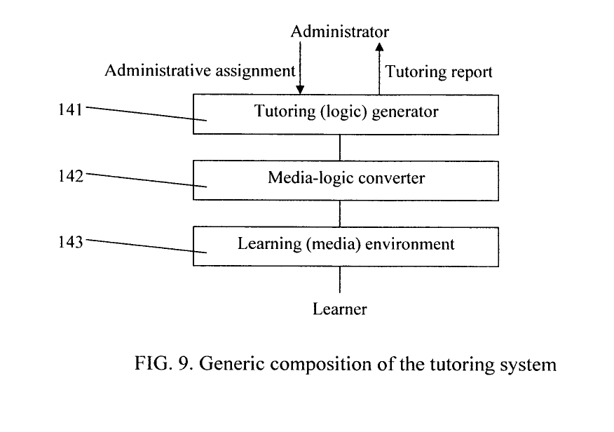

Actually, the tutoring system 140 has a complex hierarchical structure. But, as illustrated in FIG. 9, its generic composition can be simple enough and include:
a) the tutoring logic generator 141 representing a brain of the tutoring system. It includes tutoring knowledge/data and makes tutoring decisions;
b) the learning media environment 143 representing the domain under study and the tutoring persona to interact with. It physically supports at least one learning activity of the learner by providing him/her with specific learning media, controls, display, et cetera;
c) the media-logic converter 142 coupled with said tutoring logic generator 141 and said learning media environment 143 for command/control/communicating said tutoring logic generator 141 with said learning media environment 143.

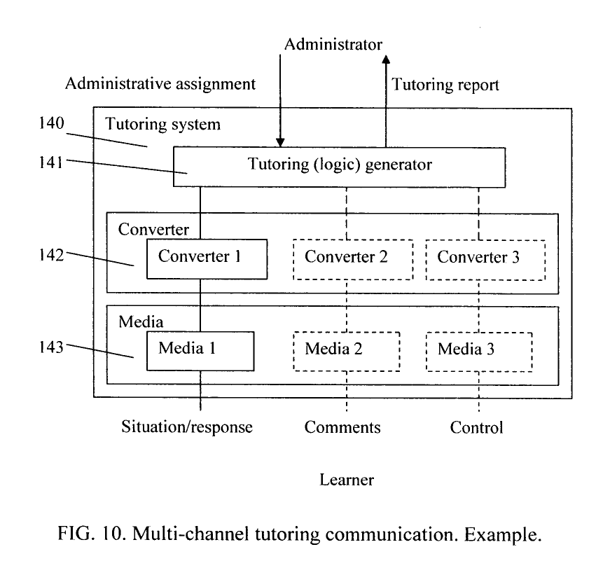

In more detail, as illustrated in FIG. 10, the tutoring system can includes a plurality of command/control/communication channels with the learner, where each channel supports a specific kind of communication.

For example:
a) channel for learner's performance feedback with (voice) messages {f};
b) channel for commenting a learning progress with messages to the learner;
c) channel for commenting a tutoring manner/mode selection;
d) channel for providing a tutoring assignment (i) to realize learning situation (s) and returning learner's response (k);
e) channel for selecting type of tutoring assignments by the learner;
f) channel for displaying current learning progress;
g) channel for supporting navigation of the learner through content;
h) channel for a question-answer service;
i) channel for help service;
j) channel for dictionary, et cetera.

Splitting the whole command/control/communication “pipeline” into these specific channels does not change the generic structure of the tutoring system (as it is in FIG. 9). Most of these channels are known in instructional technologies and can be easily realized by an average specialist. But not all are always necessary. To provide reasonable coverage, only the most representative domain/problem-independent channels will be described hereinafter.

Particularly, as depicted in FIG. 7 and FIG. 10 with dashed lines, the internal tutoring loop can include the following:
a) comment channel for providing the learner with tutoring decision commenting messages {c};
b) control channel for learner's control over the tutoring generator 141 by selecting a manner, style parameters and type of tutoring assignments;

Due to domain/problem independency these channels can be easily realized in one uniform embodiment for all possible domains and task/problems. In general tutoring procedure depicted in FIG. 7, these channels support steps 131-133 of the internal loop of tutoring 130-131-132-133-130, which does not change the knowledge/data of the generator.

In contrast, the situation/response channel for providing the tutoring assignment {i}, generating learning situation (s) and returning learner's response (k) is domain/problem specific. In FIG. 7 and FIG. 10 it is illustrated with solid lines. It also supports tutoring steps 131-133, but for the external loop of tutoring 130-131-132-133-134-130, where the tutoring knowledge/data of the generator are adapted. In comparison with comment and control channels, the design of the situation/response channel is complex and innovative, that is why the most attention will be given to it hereinafter.

Described composition of the tutoring system enables its reuse for different domains and job/tasks and allows saving on an authoring labor and improving the quality of tutoring and learning success.

Operation:

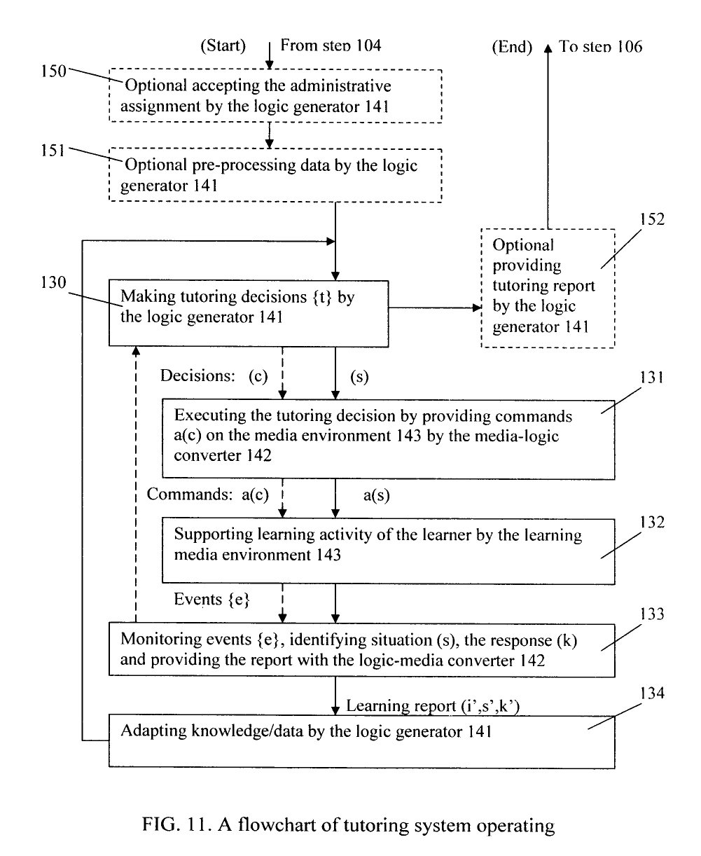

The tutoring system 140 is designed to automatically realize the tutoring phase 105 of the invented method as shown in FIG. 7. In more detail, the operation of the tutoring system is illustrated in FIG. 11.

Starting said tutoring system can be performed by any user with granted administrative rights including an administrator, author, instructor, and the learner;

Being started at any time after the step 104, the system performs the following steps of operation:
a) Optional accepting 150 the administrative assignment by the logic generator 141;
b) Optional preprocessing 151 knowledge/data model for its transforming from a storage format to an application format and system's adjustment according to the administrative assignment. It is done by the logic generator 141 as well;
c) Making 130 tutoring decisions (t) by the logic generator 141 including:
   1. Making decision to end tutoring; If this is a case, then the next steps are:
      A. Commenting this decision;
      B. Optional providing 152 the tutoring report by the logic generator 141;
      C. ending the system operation and
      D. transferring control to the step 106;
   2. Making achievement decisions and commenting these decisions;
   3. Making manner/mode {m} decisions and commenting these decisions;
   4. In active manner and in possible cooperation with the learner through the control channel, making tutoring assignment (i′) of the next target situation (s) through the situation/response channel and commenting this decision;
d) In active manner, executing 131 the assignment (i′) of specific situation (s) in the situation/response channel by providing commands a(s) on the media environment 143 by logic-media converter 142 to realize corresponding situation (s);
e) Supporting 132 learning activity of the learner through the situation/response channel by the learning media environment 143 including
   1. Generating a current learning situation (s) (under control from media-logic converter 142 or independently);
   2. Providing the learner with corresponding media to materialize the current learning situation (s) with controls for learner responsive actions. It is done by the learning media environment 143;
   3. letting the learner explore provided media and act on controls, which can provide events (e) and change the situation (s);
f) monitoring 133 learning activity of the learner through the situation/response channel of the media environment 143 and the media-logic converter 142; providing the logic generator 141 with the learning report including:
   1. tutoring assignment (i′);
   2. all identified situation (s′) and
   3. an identified response (k′) of the learner on this situation (s′);
g) adapting 134 said knowledge/data model by the logic generator 141;
h) making 130 new decisions based upon adapted knowledge/data model. It is done by the logic generator 141.

Where, said commenting means providing comments {c} through the comment channel by performing the following steps of the internal loop:
a) making 130 decision to provide comment (c) by the logic generator 14;
b) executing 131 this decision with media-logic converter 142 by providing necessary commands a(c) on media environment 143 by the media-logic converter 142;
c) supporting 132 learning activity by comment message delivery to the learner by media environment 143,
d) optional monitoring 133 and capturing delivery confirmation event (e);
e) transferring control back to the decision making 130;

The learner in the tutoring system is provided with opportunity to control over his/her own tutoring through the control channel 131-133 of the internal tutoring loop. First the media environment 143 provides 132 corresponding controls. Then the learner acts on provided controls of media environment 143 generating special events (e), which are monitored and identified 133 by the media-logic converter 142 and transferred to the logic generator for taking into account in making 130 tutoring decisions.

In FIG. 11, optional components are depicted with dashed lines and the comment and control channels of the internal loop are illustrated with dashed arrows.

Whereby said system completely separates media and logic of tutoring process provides specific media-independent and generalized logic-based generating the tutoring process, simplifies labor-consuming authoring, improves quality of said tutoring process and accelerates learning success.

Learning Media Environment

Definition:

The learning media environment 143 is a part of said tutoring system 140. It physically supports learning activity of the learner within specific instructional unit providing tangible objects to interact with. The examples of the learning environment 143 are traditional paper books, electronic books, computer/web-based presentations, simulators, games, virtual reality, physical models of real objects under study (dummies) and can even include real objects (like a car, engine, dashboard, . . . ).

This part 143 of the tutoring system 140 is not innovative and was intentionally kept “as is” in majority of traditional tutoring systems for enabling maximal reuse of a learning media legacy and lowering a cost of a new tutoring systems design. The reason for its consideration hereinafter is a maximal clarification of an operating environment of the innovative tutoring generator 141.

Functionality:

In interaction with a learner, the learning media 143 can provide the learner with
a) an introduction, specification of objectives and summary of the instructional unit;
b) comment messages {c} including
   1. achievement commenting messages {v} of the tutoring generator 141;
   2. feedback messages {f} of the converter 142 commenting learner's response;
   3. manner, mode and assignment decision commenting messages the tutoring generator 141;
c) learning progress display;
d) controls for the learner to support a choice of manners, a kind and an instance of tutoring assignments;
e) a set of learning situations {5}, each including controls for learner's responsive actions;

It accepts learner's control and responsive actions {k} on provided controls.

In interaction the with media-logic converter 142, learning media environment 143 accepts commands {a} and returns events {e} for tracking. By this way, it realizes “If (a), then (e)” function.

Parameters:

In interaction with the learner, the specific functionality of the learning media 143 is defined with commands from the media-logic converter 142. This facilitates external control over the learning media environment 143 by the tutoring logic generator 141.

Functioning of the media environment 143 may depend of other parameters such as a resolution, speed, duration, kind of media, et cetera. This provides an extra opportunity for adaptation of the learning media environment 143.

Composition

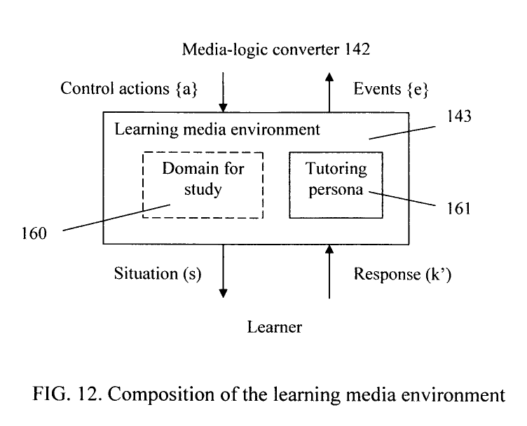

As it is illustrated in FIG. 12, the learning media environment 143 can comprise the following components:
a) a learning domain (model) 160 represented in a tangible physical form for exploring/studying by the learner. The domain supports a situation/response channel of learning communication by providing a domain aspect (d) of the learning situation (s). In general, it is optional to have the separate domain model in the tutoring system.
b) a tutoring persona 161 for tangible representing the logic generator 141 to the learner in all kind of generator-learner communications. It can provide:
   1. introduction, objectives and summary presentations;
   2. comment messages {c} including
      A. Standard achievement commenting messages {v};
      B. Standard feedback messages {f} commenting each learner's response (optional);
      C. manner, mode and assignment commenting messages;
   3. learning situations {s} including
      A. Explanations of the domain;
      B. Problem posing message;
      C. Controls to enter learner's solution;
   4. progress information about current learning state of the learner;
   5. control opportunities including a choice of manners, a kind and an instance of the tutoring assignment.

Said learning domain 160 represents a physical embodiment of what to be learned. It provides a domain aspect (d) of the whole learning situation (s). Even if the “what to be learned” is pure conceptual, like math, it has to be represented in tangible physical form for the learner to interact and explore. The learning domain can be a chapter of a paper/electronic book, a loaded audio/video player, computer-based simulator/game, physical model of real object and even a real object itself. The learner should be able to interact and explore the learning domain by browsing and acting on its controls. The learner can do it independently or under control of the tutoring generator, the latter is much more effective.

The tutoring persona 161 represents a physical embodiment of the tutoring logic generator 141. It can be represented with different media as well. The examples of different materialization forms of the tutoring generator 141 can include but not limited to certain pieces of instructional text in a traditional paper/electronic textbook, audio device for feedback providing, device providing communication (e.g., e-mail), computer-pictured/animated/simulated persona, a talking head, a virtual tutor, or even a real human tutor, which uses the logic generator for advising on what to do next and then executes this advise in real tutoring actions.

At a minimum, the learning media environment 143 can include only the tutoring persona 161, which can support all channels of learning communications somehow and particularly is able to explain the domain 160 under study for the learner. Sometimes it is enough for educational applications of the tutoring system. But in training and job-support applications of the tutoring system, presence of the domain model is rather obligatory.

In traditional learning media 143, the learning domain 160 and tutoring persona 161 are often not separated in media embodiment and represent a monolith of mixed leaning and tutoring materials. All together they provide all necessary functionality described above.

Operation:

Despite of diversity and possible complexity of the learning media environment 143, on a functional level, its operation seems to be simple.

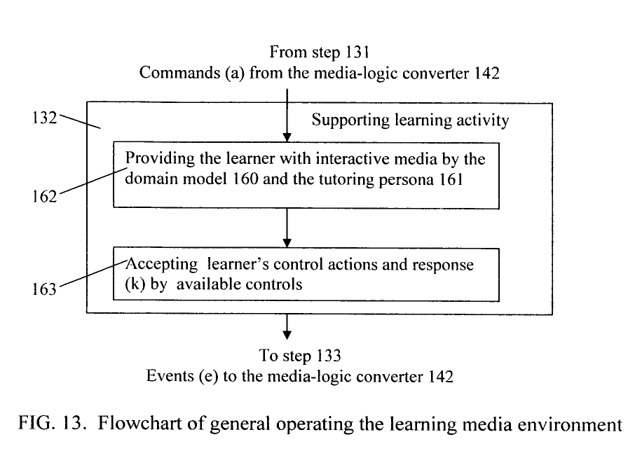

As shown in FIG. 13, the learning environment takes control from step 131 with commands from media-logic converter 142 and includes:
a) providing 162 the learner with interactive media, which can include:
   1. providing introduction, objectives and summary presentations by the tutoring persona;
   2. providing comment messages {c} by the tutoring persona 161 including:
      A. providing achievement commenting messages;
      B. providing feedback messages {f} of the converter 142 commenting learner's response (optional);
      C. providing manner, mode and new assignment commenting messages;
   3. providing problem (p) posing by the tutoring persona 161;
   4. providing domain aspect (d) of situation (s) including controls for learner's actions. It can be done the most realistically with the domain 160 and/or abstractly by the tutoring persona 161;
   5. providing progress display of current learning state of the learner by the tutoring persona 161;
   6. providing control opportunities for the learner including a choice of manners, assignment kind and instance of assignments by the tutoring persona 161;
b) accepting 163 learner's control actions and response (k) by said controls of the media domain 160 or the tutoring persona 161.

After completion of its operation, it transfers control to step 133 with events to the media-logic converter 142.

In wide range of all possible learning applications, its main functionality, can be specified in more detail and distributed among its components by different ways.

For example:
the domain model 160, let say a flight simulator, provides domain situations {d} with controls for response (k). The learner is tasked with problem (p) beforehand and knows what is required to do. The problem (p) completes the domain situation (d) up to a complete problem situation (s). In this case, the tutoring persona 161 comments learning progress with messages {c}. This case is typical for a job support with passive non-intrusive tutoring.
the domain model 160, let it be a flight simulator again, provides domain situations {d} with controls for response (k). But the learner is not tasked beforehand. In this case, the tutoring persona 161 can pose the problem (p) for the learner creating a complete problem situation (s) and comment learning progress with messages {c}. This is the case of testing the learner by posing problems to perform in the domain with real/media controls.

The domain 160 provides domain situations {d} with no controls for response (k). The learner is not tasked beforehand. The tutoring persona 161 asks the learner a question (p) creating a problem situation (s) and provides its own controls for response (k). It can comment the learning progress with messages {c} as well. This is the case of testing the learner with presenting the domain, asking questions related to the domain and getting responses.

There is no separate domain 160 at all. The learner is not tasked beforehand. The tutoring persona 161 does everything itself: explains domain situation (d), pose the problem (p) creating the complete problem situation (s) for the learner and provides him/her with necessary controls for response (k) and then comments learning progress with messages {c}; This is the typical case of tutoring by communication of tutoring persona with the learner one-one-one.

### Embodiments

The tutoring generator 141 is invented to work practically with any learning media environment 143. Examples of the learning media environment 143 (comprising the domain model 160 and the tutoring persona 161) can include, but are not limited to, the following instances.

Paper textbook. In a paper textbook, all situations {I} are presented with text and pictures on paper pages. Each external command (a) is a specific page opening. Paper textbook can provide controls (such as multiple choice for checking, blanks for filling in) and comments {c} for the learner. The learner working with the textbook can generate events (e), for example by checking alternatives of multiple choices and filling in the blanks.

Electronic book. In an electronic textbook, all learning situations {I} can be presented with text, graphics, audio, video, animation and simulation on electronic pages. Each external command (a) opens a specific electronic page. Electronic textbook can provide a wide variety of controls (such as multiple choice, fill in the blanks, buttons, hot spots, links, menus, drag and drops, . . . ) and comments {c} for the learner. The learner can generate events (e), for example by browsing, hitting buttons, clicking, dragging and dropping media objects.

Audio/video player loaded with an audio/video disk. The learning situations {s} are presented with audio/video playback. Each external command (a) launches a specific track, record. Players can provide some controls (such as buttons) and even comments {c} for a user. The learner can generate events (e), for example, by hitting these buttons.

E-mail. The learning situations {I} and comments {c} can be presented with just a text in some cases upgraded with multimedia. Each external command (a) launches a specific message to the learner. Each e-mail device (cell phone, personal digital assistance or computer) provides some controls (keyboard) for a user/learner, which the learner uses to type in a responsive message (k).

Computer-based interactive presentations. Similar to the electronic textbook, comments {c} and learning situations {s} in a computer can be presented in a form of interactive presentations including test, graphics, audio, video, animation and simulation. External commands {a} can launch specific interactive presentations for the learner. Interactive presentations can include a wide variety of controls (such as multiple choice, fill in the blanks, buttons, hot spots, links, menus, drag and drops, . . . ) for the learner. By browsing interactive presentations and acting on controls, the learner generates events {e} in this learning environment.

Computer-based applications. A majority of computer-based applications (including simulators and games) can be considered as a specific functionality mediated for the user with specific interactive presentations on a computer. Each such an application provides the user/learner with a variety of situations {s} presented in a form of windows/panels with test, graphics and controls. External commands {a} on the application can launch the entire application, its specific modes, windows, panels, and steps for the user/learner. The application can include a wide variety of controls (such as buttons, links, menus, . . . ) for the learner. Exploring the application by acting on its different controls and activating its different modes, windows, panels, and steps, the learner generates events {e} in this learning environment.

Computer-based training course. Computer-based training courses can be considered as specific computer-based applications, which already include some tutoring functions. Each such course provides the learner with a variety of intro, summary, situations {s} and coin ments {c} presented most often with electronic pages (often wired in one monolith). External commands {a} on such a course can launch the entire course and (if the monolith allows) its specific modes and pages for the user/learner. Each page can include some of controls (such as buttons, fill in the blanks, menus, . . . ) for the learner. Working with the course by acting on its different controls and activating its different modes and pages, the learner generates events {e} in this learning environment.

Physical models of real object under study. When real objects under study are not good for some reasons (dangerous, harmful, expensive, complex, distanced, invisible, not open for exploration, too slow/fast, too big/small et cetera), they can be represented with their physical replicas, models. Each such model is specially designed to provide the learner with the same essential situations {S} and controls usually provided by real objects they replace. External commands {a} on them can activate certain models and certain parts, switch from one model to another, cause certain modes, functions and steps in the model functioning et cetera. Exploring the model by acting on its controls, the learner generates events {e} in this learning environment.

Real object to learn (e.g., car, engine, dashboard). The domain model 160 can include real objects for study. This is a typical for concluding phases of training and for in-job support. Each real object provides the learner with the real domain situations {d} and real controls for exploration. External commands {a} can bring new domain objects and parts to the learner, change one domain object to another, and (if it is open enough) cause certain modes, functions and steps in the domain object behavior, et cetera. Exploring the real object by acting on its controls and causing different situations, the learner generates events {e} in this leaning media environment.

Human tutor. The media learning environment 143 can include a human tutor as well. In this case, the logic generator 141 serves as an advisor for this human tutor on how to teach the learner. Following these advices, the human tutor can bring specific domain objects to the learner, create specific situations, pose the problem, ask question, et cetera. Exploring provided domain, solving tasks, answering questions by acting on controls, the learner generates events {e} in this learning media environment.

The Logic-Media Converter

Definition.

The logic-media converter 142 is a part of said tutoring system 140. It enables communication between the logic generator 141 and the media environment 143 through different channels (for example: situation/response, comment and control channels). This part of the tutoring system 140 is not innovative as well. It was intentionally kept “as is” in many other learning/tutoring systems to be able to reuse it and to lower a cost of new tutoring system design. The reason for its consideration hereinafter is a maximal clarification of an operating environment of the innovative tutoring generator 141.

Functionality.

The media-logic converter realizes two directions of converting: logic-to-media and media-to-logic.

In logic-to-media converting 131, the logic-media converter 142 accepts tutoring decisions {t} from the logic generator 141 and transforms 131 them into commands {a} on the learning media environment 143 in order to materialize tutoring decisions {t} in a media form, including the specific situations {s} with controls for learner's actions and comments {c}. By this way it realizes “If (t), then (a)” function.

In opposite media-to-logic converting 133 within the situation/response channel, it tracks essential events {e} in the learning media environment 143 regarding an actually selected assignment (i′), created situation (s′) and actual response (k′) of the learner and then generates a learning report (i′,s′,k′) to the logic generator 141 for adapting 134. By this way, it realizes “If (e), then (i′,s′,k′)” function. Within the comment and control channels, it tracks learner's control actions, identifies confirmation/control events {e} and transfers results to the logic generator 141 for decision making 130.

Parameters:

Functioning the logic-media converter 142 depends of learning media environment 143 and learning activity to support, which can be considered as parameters predefined in the phase of providing 100 the tutoring system 140.

The logic-media converter 142 can be customized with adjustable parameters such as: a number of events {l} covered by one report, a required reliability of learning, behavior identification, et cetera.

Composition

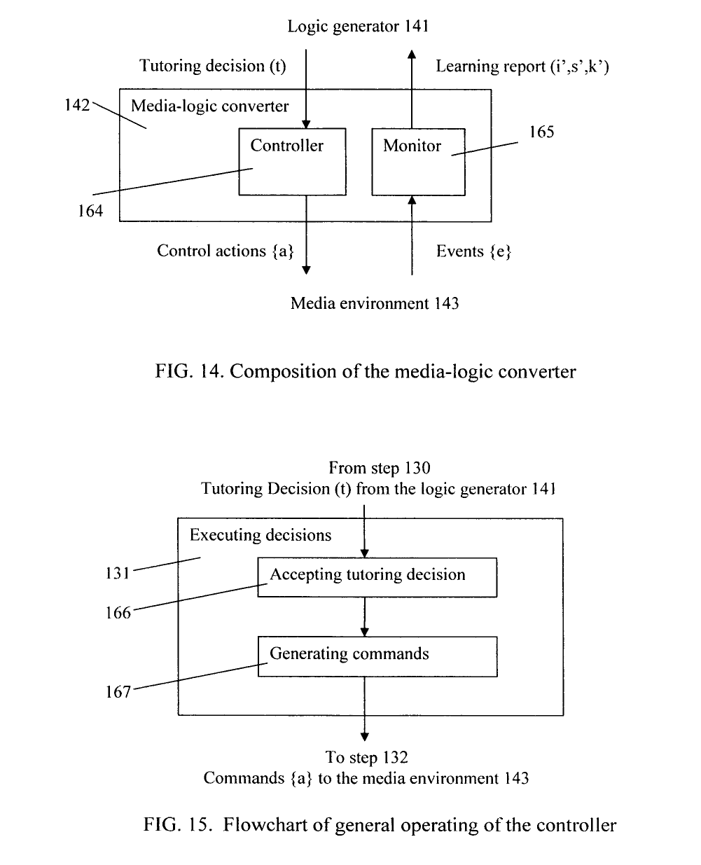

To provide mentioned functionality, the logic-media converter 142 includes the following main components, as it is shown in FIG. 14:
a) A controller 164 for providing the logic-to-media converting and generating commands {a} on the media environment 143 to realize each tutoring decision (t) from the logic generator 141;
b) A monitor 165 for providing the opposite media-to-logic converting and reporting learning activity in the media environment 143 into the logic generator 141.

To support multiple channels in the learning environment 143, the media logic converter 142 may include multiple components. For example,
a) a component for control over learning domain situation (d) in the situation/response channel;
b) a component for monitoring the actual domain situation in the situation/response channel;
c) a component for control over presentation of an introduction, objectives and summary in the comment channel;
d) a component for monitoring acceptance of the introduction, objectives and summary in the comment channel;
e) a component for control over comment messages {c} in the comment channel;
f) a component for monitoring comment acceptance confirmation events in the comment channel;
g) a component for control over a progress display;
h) a component for choice of manner, the kind and instance of assignments in the control channel et cetera.

All these components are easily realizable by traditional means. The invention does not apply any special restriction on embodiment of these components.

Operation:

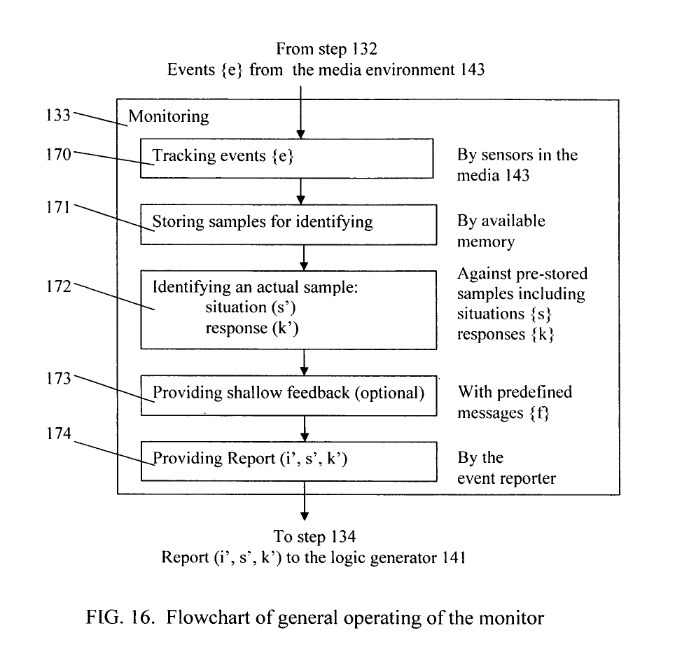

General operation of the situation/response channel of the logic-media converter 142 includes the following steps:
a) executing 131 tutoring decision (t) by the controller 164, as it is shown in FIG. 15. It takes control from decision making step 130 and includes:
   1. Accepting 166 tutoring decision (t);
   2. Generating 167 commands {a} onto the media environment 143;
   Concluding its operation, the controller transfers control to step 132 with commands to the media environment 143;
b) Monitoring 133 by the monitor 165, as it is shown in FIG. 16. It takes control from step 132 and includes:
   1. Tracking 170 events {e} in the media environment 143 characterizing an actual situation and learner's response;
   2. Optional storing 171 the tracked events {e} to be considered later by authors as a sample situation (s) and a sample response (k);
   3. Identifying 172 tracked situation and response by their comparison against corresponding pre-stored samples (s,k);
   4. Optional providing 173 the learner with the feedback message (f);
   5. Providing 174 the learning report including an identifier (s′) of identified situation sample and an identifier (k′) of identified response sample. The part (i′) of the complete report (i′,s′,k′) characterizing a finally selected instance of the tutoring assignment can come from the control channel.

Concluding its operation, the monitor 165 transfers control to step 134 with the learning report.

If the monitor 165 is notable to identify the actual behavior (s,k) with 100% reliability, it still can produce uncertain beliefs within a range [0-100%] that an actual behavior is similar to some of the samples {s, k}. If the monitor 165 is not able to identify actual behavior (s,k) at all, it can identify it as “unexpected”. It can do it with certain degree of uncertainty as well. Reporting with uncertainty will be considered hereinafter.

General operation of the comment channel of the logic-media converter 142 is trivial and includes at least the executing 131 comment decision (c) by the controller 164, which in its turn includes
a) Accepting 166 tutoring decision (c);
b) Generating 167 commands {a} onto the media environment 143.

General operation of the control channel of the logic-media converter 142 is trivial as well and includes controlling 131 over supporting 132 the learner's choice and monitoring 133 its results by the monitor 165, which comprises:
a) Tracking 170 control events {e} in the media environment 143 characterizing control actions of the learner, such as choice of the tutoring manner, the kind of the tutoring assignments and the instance of tutoring assignments;
b) Identifying 172 tracked events, which particularly includes identifying the tutoring manner, the kind of the tutoring assignments and an instance (i′) of tutoring assignment selected by the learner;
c) Optional providing 173 the feedback message (f);
d) Providing 174 the identifiers of control event into the generator 141, which particularly can include the identifiers of tutoring manner, the kind of the tutoring assignments and an instance (i′) of tutoring assignment selected by the learner.

### Embodiments

The specific embodiment of the logic-media converter 142 is dependable of specific embodiment of the media environment 143. Examples can include but are not limited to the following instances.

If the media environment 143 is embodied as a paper textbook (just for explanation), then the controller 164 can be realized as a device (a page-turner) for opening 131 a right page presenting the target situation (s) or comment (c) and providing controls (like fill in the blank, a multiple choice menu and a pencil) for the learner. Generated learning events {e} (a filled in text, checked up alternatives of the menu) can be traceable, for example, by an optical recognition device. So, the monitor 165 can be realized as a text recognition device for recognizing a learner entered text on the page, storing samples of recognized text, comparing recognized textual response against pre-stored samples, identifying which pre-stored response is closest to the pre-stored samples and reporting an identifier (k′) of the closest sample together with an identifier of presented page (s) or (c) to the tutoring logic generator 141.

If the media environment 143 is embodied as an electronic book, then the controller 164 can be realized as a program (page-turner) providing a right electronic page to deliver the target situation (s) or comment (c) to the learner. The monitor 165 can be realized as another program for tracking learner's actions on controls (buttons, menus, a multiple choice) of the e-book storing samples of responses, comparing tracked actions against pre-stored samples, identifying which pre-stored response is closest to the pre-stored samples and reporting an identifier (k′) of the closest sample together with an identifier of presented page (s) to the tutoring logic generator 141.

If the media environment 143 is embodied as a loaded audio/video player, then the controller 164 can be realized as a device assigning a right track to playback a target audio/video situation (s) or comment (c) for the learner. The monitor 165 can be realized as another device for tracking learner's actions on controls, storing tracked actions as samples, comparing tracked actions against pre-stored samples, identifying which pre-stored sample is closest to the tracked response and reporting an identifier (k′) of the closest sample together with an identifier of presented track (s) to the logic generator 141.

If the media environment 143 is embodied as E-mail device (cell phone, personal digital assistant, computer), then the controller 164 can be realized in any compatible embodiment that allows sending a specific message selected by the tutoring logic generator 141 to the learner. The learner receives an incoming message in media environment 143 and types his/her responsive text {e} In this case, the monitor can be realized on a basis of a natural language processing system, which is able to analyze the text and provide outcome in a certain form. The monitor 165 pre-stores these outcomes as samples and then compares a sample from the learner against pre-stored samples, identifies which pre-stored sample is closest to the sample from the learner and reports corresponding identifier (k′) of the closest sample together with an identifier of incoming message (s) to the tutoring logic generator 141.

If the media environment 143 is embodied as a set of computer-based interactive presentations, then the controller 164 can be realized in a compatible embodiment as a program launching a right interactive presentation to deliver at least one target situation (s) to the learner. The learner responds on the presented situation by acting oil embedded controls causing certain events {e} in the learning environment 143. The monitor 165 can be realized as another program for tracking responsive events, storing samples of complete responses, comparing each new sample against pre-stored samples, identifying which pre-stored response is closest to the new one and reporting an identifier (k′) of the closest sample together with an identifier of presented situation (s) to the tutoring logic generator 141.

If the media environment 143 is embodied as a specific computer-based application, then the controller 164 can be realized as a program causing said application to create at least a target situation (s) for the learner. Doing that the controller 164 can launch the entire application, its specific modes, windows, panels, and steps for the learner. The monitor 165 can be realized as another program for tracking events {e} concerning a learning behavior (actual situations and responsive actions), comparing the tracked behavior with pre-stored ones, identifying which pre-stored behavior is the closest to the tracked behavior and reporting identifiers (s′,k′) of the closest behavior to the logic generator 141.

If The media environment 143 is embodied as a ready made computer-based training course, then it already includes its own media environment, controller 164 and monitor 165. In a favorable case, all that is necessary to upgrade this course into intelligent tutoring system is to connect its ready-made components 164-165 with the logic generator 141. In practice, most of known computer-based courses represent a monolith of pre-wired media, logic, controller 164 and monitor 165. But even in this unfavorable case, sometimes it is possible to overrun an internal logic (prescriptions, scripts, rules) of the course with external decisions of the logic generator 141 by connecting them with the external controller 164 and/or monitor 165. In this case, the controller 164 can be realized as a program overrunning embedded internal prescriptions by assigning the target situation (s) to be presented to the learner next. Sometimes, the same internal monitor 165 of the course can still be used for tracking learner's actions on controls (buttons, menus, a multiple choice), comparing tracked actions with pre-stored ones, identifying which pre-stored response is the closest to the tracked response and reporting an identifier (k′) of the closest response as well as an identifier of presented situation (s) to the logic generator 141. It is also possible to use an external program as a monitor 165.

If the media environment 143 is embodied with physical models of real objects, then the controller 164 can be realized as device acting 131 on said physical models to create at least one target situation (s) for the learner. The monitor 165 can be realized as another device for tracking actual arising events {e} characterizing a learning behavior (actual situation and learner's actions on controls), comparing tracked behavior with pre-stored ones, identifying which expected behavior is the closest to the tracked behavior and reporting identifiers (s′,k′) of closest behavior to the logic generator 141.

If the media environment 143 is embodied with a real domain object to learn (like a car, engine, dashboard), then the controller 164 can be realized as a device acting on said domain object to create a desired situation for the learner (like engaging a break, starting the engine). The monitor 165 can be realized as another device for tracking arising events {e} characterizing a learning behavior (situation and learner's actions on controls, such as steering wheel, pedals), comparing tracked behavior with pre-stored ones, identifying which expected behavior is the closest to the tracked behavior and reporting identifiers (s′,k′) of closest behavior to the logic generator 141.

If the media environment 143 includes a human tutor, which uses the logic generator 141 as an advisor, then the controller 164 can be realized as a messaging device (for example: cell phone, personal digital assistant, computer) providing the human tutor with instructions on what to do. The monitoring function 133 can be performed manually by the human tutor with the same messaging device by reporting learner's behavior back to the logic generator 141 for adapting 134. In another embodiment, the monitor 165 can be an automatic device for tracking arising events {e} characterizing a learning behavior (situation and learner's actions on controls), comparing tracked behavior with pre-stored ones, identifying which expected behavior is the closest to the tracked behavior and reporting identifiers (s′,k′) of closest behavior to the logic generator 141.

Specific Cases of the Generic Tutoring Method

As has been said, each complete assignment (i) defines a target situation (s) including domain {d} and problem {p} aspects.

Depending of allocation of control over said aspects of situation (s) among the tutoring generator 141, the learner and the domain 160, the tutoring system 140 can realize different manners and modes of operation.

Particularly, the tutoring system 140 can realize:
a) Single tutoring manners including
   1. a passive manner of tutoring (case 1), in which the tutoring generator 141 does not control over domain (d) and problem (p) aspects of situation (s). This manner can be realized by
      A. fixing
         a. a specific domain 160 defining at least an initial domain aspect (d) of the whole learning situation (s);
         b. a specific problem defining at least ail initial problem (p) aspect of the situation (s);
      B. letting
         a. the domain 160 to evolve the domain aspect (d) of situation (s) independently;
         b. the learner to select the problem (p) aspect of situation (s) independently;
         c. the learner to drive the domain 160 intentionally transforming domain (d) and problem (p) aspects of situations (s);
      C. providing the learner with comment message (c) by the tutoring persona 161 as well as with necessary controls;
   2. an active manner of tutoring, in which the tutoring generator 141 participates in forming some or all aspects of the learning situation (s). This manner can be realize by
      A. sole controlling over all aspects (d,p) of situation (s) with logic generator 141 (case 2) including particularly
         a. control over domain 160 providing domain situations {d} for fixed problem (p). It is an example of a supply mode of tutoring.
         b. control over problem (p) for fixed domain (d). This is an example of a testing mode of tutoring.
         c. control over both domain (d) and problem (p) aspect of the situation (s). It is an example of mixed supply and testing modes of tutoring.
      B. sharing control over situation (s) between the generator 141 and the learner, (case 3):
         a. letting the generator 141 to assign multiple situations [s] for the learner's final choice;
         b. letting the learner to choose a single situation (s) from the pre-selected multiple situations [s];
         c. providing the learner with comment message (c) by the tutoring persona 161 as well as with necessary controls;
         Note that the learner and generator 141 may switch their turns. The learner can provide a pre-selection, then the final selection can be made by the generator 141. It is possible but not preferred solution.
      C. sharing control over situation (s) between the generator 141 and the domain 160 under study, (case 4):
         a. letting the generator 141 to pre-select multiple situations [d,p] for the domain's final selection;
         b. letting the domain 160 to select/evolve the single situation (s), more precisely its domain aspect (d);
         c. providing the learner with comment messages (c) by the tutoring persona 161;
         Note that the domain 160 and generator 141 may switch their turns as well. The domain can provide a pre-selection (or constraints), then the final selection can be made by the generator 141. It is possible but not preferred solution because it can cause domain-dependency of the generator 141.
      D. sharing control over situation (s) between the generator 141, the learner, and the domain 160, (case 5);
         a. letting the generator 141 to pre-select multiple initial situations {d and p aspects} for the learner's final choice;
         b. letting the learner to select a single initial situation (d and p aspects) from the pre-selected multiple situations;
         c. letting the domain 160 to evolve the next situations (d aspect);
         d. providing the learner with comment messages (c) by the tutoring persona 161 as well as with necessary controls;
b) Multiple manners by switching between single manners by
   1. The administrator;
   2. The learner;
   3. The tutoring logic generator (case 5).

Let us consider each specific case in more detail.

Case 1. Passive tutoring manner.

The logic generator 141 only observes and comments learning.

This case takes place when
a) the domain 160 for study and the tutoring persona 161 are separated in the learning media environment,
b) the domain 160 is not tinder control of the generator 141,
c) the learner and/or the domain 160 themselves drive the situation (s) independently of the tutoring generator 141,
d) the logic generator 141 controls only the tutoring persona 161 by providing the learner with on-the-fly comments {c}.

The passive tutoring manner is usually realized in job support systems, in non-intrusive training systems as well as in learner-driven learning systems. In these systems, the worker/learner can select domain (d) to work/learn, problem (p) to perform, explore the domain evolving different situations {d} and acting on domain's controls providing responses {k}.

The system 140 can take control at any time after step 104.

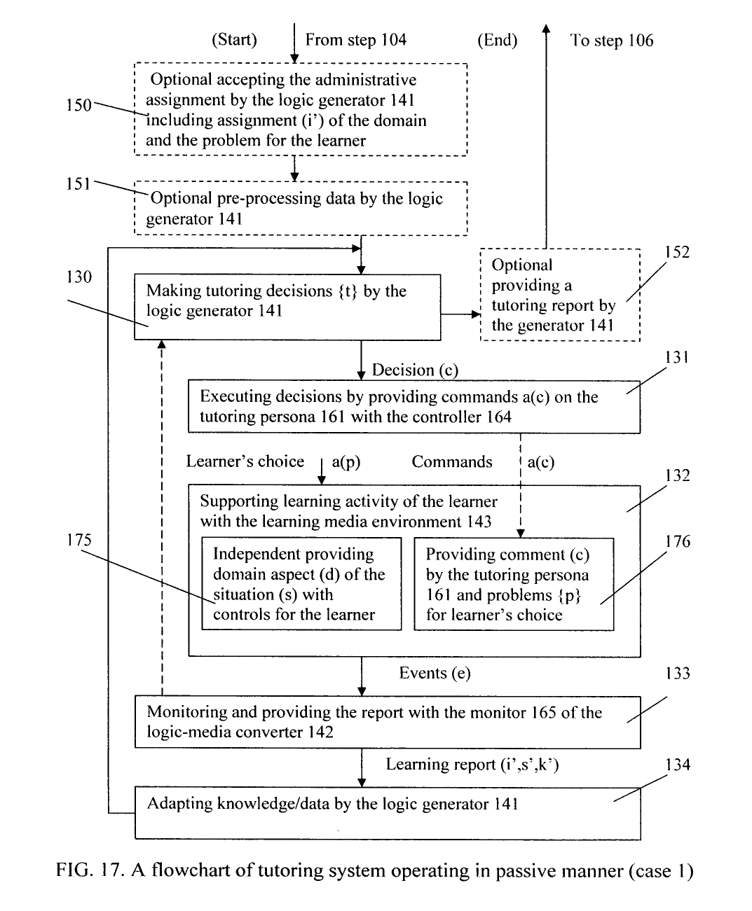

Operating 105 the tutoring system 140 in this manner represents a specific case of the generic tutoring method illustrated in FIG. 7 and depicted in more detail in FIG. 11. This specific case (case 1) is shown on FIG. 17 and includes the following steps:
a) Optional accepting 150 the administrative assignment by the logic generator 141, where
   1. the parameter of the tutoring manner has “passive” value,
   2. a fixed tutoring assignment (i′) defines an initial situation (s) including:
      A. the specific domain (d) aspect and
      B. the specific problem (p) aspect;
b) Optional preprocessing 151 knowledge/data by the generator 141 by their retrieving from a storage, possible decompressing and initializing;
c) Making 130 tutoring decisions {t} by the generator 141 comprising
   1. making decision to end tutoring; In this case, it performs:
      A. Commenting this decision through the comment channel including
         a. executing 131 comment decision with the controller 164 by providing commands a(c) on the tutoring persona 161;
         b. Supporting 132 learning activity of the learner by providing 176 the learner with comment (c) by the tutoring persona 161;
         c. Monitoring 133 learning activity of the learner by optional providing a confirmation of the message delivery and acceptance and returning control to the decision making 130;
      B. providing 152 the tutoring report by the logic generator 141 and
      C. ending the system operation;
   2. making achievement decisions, which include diagnostic decisions, and commenting them through the comment channel including:
      A. executing 131 comment decision with the controller 164 by providing commands a(c) on the tutoring persona 161;
      B. Supporting 132 learning activity by providing 176 the learner with comment (c) by the tutoring persona;
      C. Monitoring 133 learning activity of the learner by optional providing a confirmation of the message delivery and acceptance and returning control to the decision making 130;
d) Supporting 132 learning activity of the learner through the situation/response channel including
   1. Letting 175 the domain model to evolve independently and provide the learner with the current domain situation (d) including domain controls to enter his/her response (k)
   2. letting the learner to select a current problem (p) from tutoring persona 161, explore the whole situation (s) and act on available controls;
e) monitoring 133 the learning activity of the learner through the situation/response channel with the monitor 165 and providing the logic generator 141 with the learning report including:
   1. the assignment (i′), which is fixed in this case and optional due to this reason;
   2. an identified situation (s′) and
   3. an identified response (k′) of the learner on the situation (s′);
f) adapting 134 the knowledge/data model of the tutoring logic generator 141;
g) making 130 new tutoring decisions {t} based upon the adapted knowledge/data model.

After completion of its operation, the system 140 transfers control to the evaluation step 106.

Case 2. The logic generator controls solely over learning.

In this case, the domain 160 under learner's study and the tutoring persona 161 in the learning media environment 143 can be (but not necessarily) separated. The learning environment 143 can be represented even with the tutoring persona 161 only. Besides providing comments (c), the logic generator 141 is able to control over both the domain 160 and the tutoring persona 161 by assigning the learning situations {f}, which includes the domain (d) and problem (p) aspects, through the controller 164 of the logic-media converter 142.

This case is usually realized in educational and interventional training applications for children or learners who are not ready or do not want to participate in control over their own learning.

The method of active tutoring is a specific case of general tutoring method depicted in FIG. 7 and in more detail in FIG. 11. In contrast to described passive manner, in the active manner, the learner is not pre-tasked and the tutoring generator 141 has a total control over learning situations {s}. The learner does not participate in selecting learning situations {s}.

The system 140 can take control at any time after the step 104.

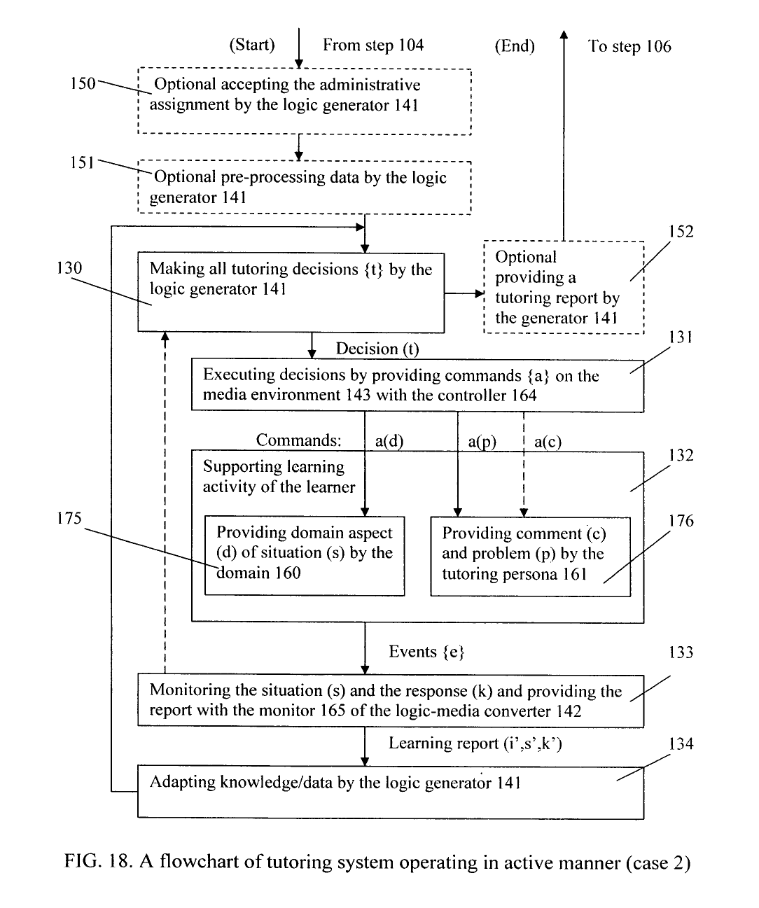

Operating 105 the tutoring system 140 in this specific case is illustrated in FIG. 18 and includes:
a) Optional accepting 150 the administrative assignment by the logic generator 141. The parameter of tutoring manner has the “active” value. The learner is not specifically pre-tasked in advance;
b) Optional preprocessing 151 knowledge/data for use by retrieving them from a storage, decompressing and initializing;
c) Making 130 tutoring decisions {t} by the logic generator 141 including
   1. Making decision to end tutoring; If this is a case, then the next steps are:
      A. commenting the decision through the comment channel;
      B. providing 152 the tutoring report by the logic generator 141 and
      C. ending the system operation;
   2. Making achievement decisions (v) and commenting them through the comment channel;
   3. Making manner and mode {m} decisions and commenting them through the comment channel;
   4. Making assignment (i) of learning situation (s) including
      A. Assigning domain situation (d) and/or
      B. Assigning problem (p),
      C. commenting the assignment through the comment channel;
d) Executing 131 decisions made through the situation/response channel by providing commands {a} onto the media environment 143 with the controller 164 to execute the tutoring assignment (i) to provide desired situation (s) including controls for learner's response;
e) supporting 132 learning activity of the learner through the situation/response channel of the learning media environment 143 including
   1. providing 175 the learner with the domain aspect (d) of situation (s) possibly including controls to enter his/her response (k);
   2. providing 176 the learner with the problem (p) aspect of situation (s) possibly including controls to enter his/her response (k);
   3. letting 175 the learner explore the domain 160 and act on available controls;
f) monitoring 133 learning activity of the learner through the situation/response channel of the media environment 143 by the monitor 165 and providing the logic generator 141 with the learning report including:
   1. the assignment (i);
   2. an identified situation (s′) and
   3. an identified response (k′) of the learner on this situation (s′);
g) adapting 134 the knowledge/data model of the tutoring logic generator 141;
h) making new tutoring 130 decisions {t} by the logic generator 141 based upon adapted knowledge/data model.

Wherein multiply said commenting the decision through the comment channel illustrated in FIG. 18 with dashed lines includes:
a) executing 131 comment decision with the controller 164 by providing commands a(c) on the tutoring persona 161;
b) Supporting 132 learning activity by providing 176 the learner with comment (c) by the tutoring persona 161;
c) monitoring 133 learning activity of the learner by optional providing a confirmation of the message delivery and acceptance;
d) returning control to the decision making 130.

After completion of its operation, the system 140 transfers control to the evaluation step 106.

Case 3. The logic generator 141 shares active control with the learner.

In this case, the domain 160 under learner's study and the tutoring persona 161 in the learning media environment 143 can be, but are not necessarily, separated. The learning environment 143 can be represented even with the tutoring persona 161 only. Besides all kinds of commenting through the comment channel, the logic generator 141 is able to control over both the domain 160 and the tutoring persona 161 in cooperation with the learner by providing the learner with multiple assignment [i] through the control channel for his/her own choice of the single assignment (i) causing the single learning situation (s) in the learning environment 143.

This case is usually realized in educational and interventional training applications for adult learners, who want and can handle more control over their own learning.

The method of active operation is a specific case of general tutoring method depicted in FIG. 7 and in more detail in FIG. 11. In contrast to previously described case 2, the learner is able to control over tutoring assignments [i] and learning situations {s}.

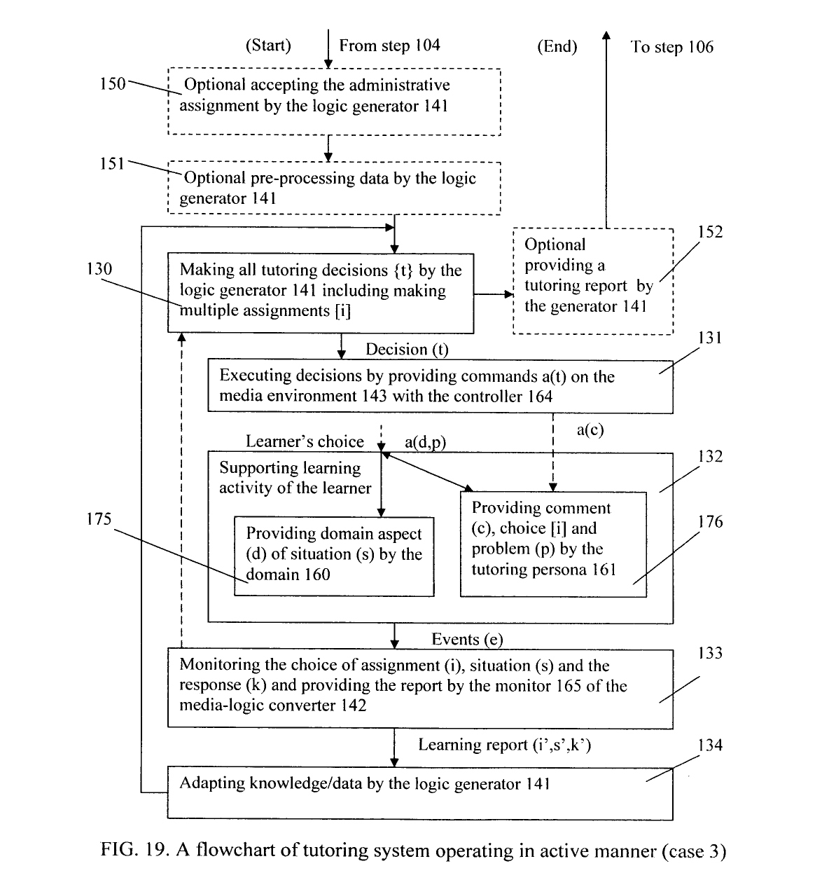

Operation of the system 140 can be started after step 104 and is performed in accordance with the tutoring phase 105. It includes the following steps as illustrated in FIG. 19:
a) Optional accepting 150 the administrative assignment by the logic generator 141. The parameter of tutoring manner has the “active” value.
b) Optional preprocessing 151 knowledge/data for use by retrieving it from a storage, decompressing and initializing;
c) Making 130 tutoring decisions {t} by the logic generator 141 including
   1. Making decision to end tutoring; In this case, the next steps are:
      A. Commenting this decision through the comment channel;
      B. providing 152 the tutoring report by the logic generator 141 and
      C. ending the system operation;
   2. Making achievement decisions and commenting them through the comment channel;
   3. Making manner and mode decisions and commenting them through the comment channel;
   4. Making multiple assignment [i] including a set of single assignments (i) for learner' final choice,
   5. Making single assignment (i) in cooperation with the learner (through the control channel) including
      A. Assigning domain aspect (d), presentation;
      B. Assigning problem aspect (p), task/question;
      C. Assigning both domain (d) and problem (p) aspects of the situation (s);
d) executing 131 the tutoring decision (t) including
   1. in case of multiple assignment [i], providing commands (a) on the media environment 143 through the control channel to provide the learner with a choice of a single assignment (i) from the multiple assignment [i];
   2. in case of single assignment (i), providing commands (a) on the media environment 143 through the situation/response channel of the controller 164 to realize the situation (s) with corresponding controls for learner responsive actions;
e) supporting 132 learning activity of the learner by the learning media environment 143 including
   1. in case of multiple assignment [i], supporting learner's choice of the single assignment (i) from said multiple assignment [i] through the control channel;
   2. in case of single assignment (i′), providing 175 the learner with the domain (d) and/or problem (p) aspect of situation (s) and controls to enter his/her response (k) through the situation/response channel;
   3. letting the learner to explore the situation (s) and act on available controls;
f) monitoring 133 including
   1. in case of multiple assignment [i], monitoring learner's choice of single assignment (i) through the control channel, which transfers control back to the logic generator 141;
   2. in case of single assignment (i′) defined through the control channel, monitoring learning activity of the learner in the media environment 143 through the situation/response channel of the media-logic converter 142 and providing the logic generator 141 with the learning report including:
      A. the single assignment (i′) defined through the control channel;
      B. an identified situation (s′) through the situation/response channel;
      C. an identified response (k′) of the learner on this situation (s′) through the situation/response channel;
g) adapting 134 the knowledge/data model of the tutoring logic generator 141;
h) making new tutoring 130 decisions by the logic generator 141 based upon adapted knowledge/data.

Wherein multiply said commenting the decision through the comment channel includes:
a) executing 131 comment decision with the controller 164 by providing commands a(c) oil the tutoring persona 161;
b) Supporting 132 learning activity by providing 176 the learner with comment (c) by the tutoring persona;
c) Monitoring 133 learning activity of the learner by optional providing a confirmation of the message delivery and acceptance and returning control to the decision making 130.

After completion of its operation, the system 140 transfers control to the evaluation step 106.

Case 4. The logic generator 141 shares control with the domain 160 under study.

In this case, the domain 160 under learner's study and the tutoring persona 161 in the learning media environment 143 have to be separated. The logic generator 141 is able to control over both the domain 160 and the tutoring persona 161 through the situation/response channel by assigning a set of desired domain situations [d] and specific problem (p) to address. The domain 160 then determines the single situation (d) out of pre-selected set [d] of situations. In other words, the tutoring generator constrains a domain's freedom for the sake of better learning of the particular learner.

This case can be realized in educational and interventional training applications, which include active learning domains such as simulators and games.

The method of active operation is a specific case of general tutoring method depicted in FIG. 7 and in more detail in FIG. 11. In contrast to described case 3, the learning domain 160 can drive the domain aspect (d) of learning situations {s} itself within the range determined by logic generator 141.

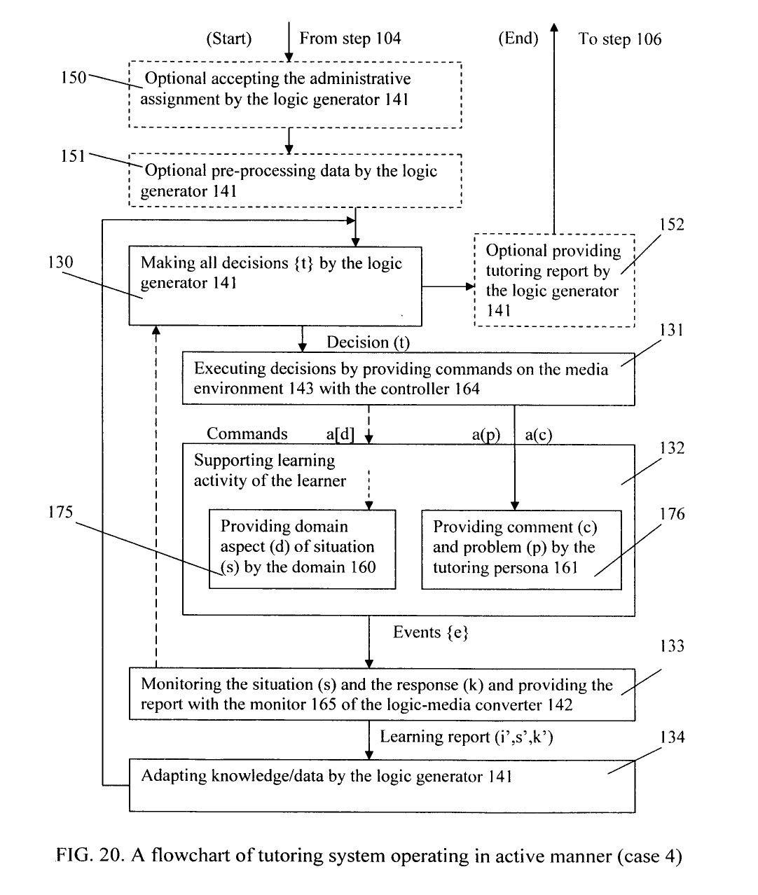

Operation of the system 140 can be started after step 104 and then it is performed in accordance with the tutoring phase 105 of the described method. It includes the following steps as depicted in FIG. 20:
a) Optional accepting 150 the administrative assignment by the logic generator. The parameter of tutoring manner has the “active” value.
b) Optional preprocessing 151 knowledge/data for use by retrieving them from a storage, decompressing and initializing;
c) Making tutoring 130 tutoring decisions {t} by the logic generator 141 including:
   1. Making decision to end tutoring; In this case, the next steps are:
      A. Commenting (c) this decision through the comment channel;
      B. providing 152 the tutoring report by the logic generator 141 and
      C. ending the system operation;
   2. Making achievement decisions and commenting them through the comment channel;
   3. Making manner and mode decisions and commenting them through the comment channel;
   4. Making multiple assignment [i] through the control channel including
      A. Assigning single problem aspect (p), task/question;
      B. Assigning a domain situation range [d] to constrain the domain 175;
d) executing 131 the tutoring decisions through the control channel by providing commands a[d] on the domain 160 with the controller 164 to constrain the domain 160 on generating 175 situations (d) within the range [d];
e) supporting 132 learning activity of the learner through the situation/response channel with the learning media environment 143 including:
   1. providing 175 the learner with single domain situation (d) from said range [d] by the domain 160 as well as controls to enter his/her response (k);
   2. providing 176 the learner with problem (p) to solve;
   3. letting the learner to explore the domain 160 and act on available controls;
f) monitoring 133 learning activity of the learner in the media environment 143 through the situation/response channel with the media-logic converter 142 and providing the logic generator 141 with the learning report including:
   1. single assignment (i′) defined the problem (p) and situation range [s];
   2. at least an identified situation (s′) and
   3. an identified response (k′) of the learner on this situation (s′);
g) adapting 134 the knowledge/data of the tutoring logic generator 232;
h) making tutoring 130 decisions by the logic generator 141.

Wherein multiply said commenting the decision through the comment channel includes:
a) executing 131 comment decision with the controller 164 by providing commands a(c) on the tutoring persona 161;
b) Supporting 132 learning activity by providing 176 the learner with comment (c) by the tutoring persona;
c) Monitoring 133 learning activity of the learner by optional providing a confirmation of the message acceptance and returning control to the decision making 130.

After completion of its operation, the system 140 transfers control to the evaluation step 106.

Case 5. The logic generator 141 shares control with the learner and the domain 160 under study.

This case combines case 3 and 4 together in two phases. On the first phase, the generator 141 narrows the choice for the domain 160. On the second phase, the domain 160 narrows the choice for the learner. The learner makes the final choice of the next tutoring assignment (i) to realize corresponding learning situation (s).

The Tutoring Logic Generator

Definition:

The tutoring logic generator 141 is an innovative part of the entire tutoring system 140 that makes it “intelligent”. It represents a “brain” of the tutoring system 140.

Functionality:

In communication with the administrator, said tutoring generator 141 receives an administrative assignment and returns the tutoring report about learner's progress.

Said administrative assignment defines the learner, the instructional unit, and tutoring manner to begin with. It also includes parameters for customizing a tutoring style realized by the tutoring generator. There are other parameters of the tutoring generator, such as adaptation coefficients (INC and DEC), which can be used by instructors for fine tuning desired speed of its adaptation process. All parameters will be described hereinafter.

In communication with the learning media environment 143 through the media-logic converter 142, the logic generator 141 receives learning activity reports, adapts its knowledge/data and makes tutoring decisions.

The tutoring decisions {t} can include but are not limited to
a) A plurality of achievement decisions {v};
b) A couple of manner decisions (passive or active);
c) A triplet of mode decisions (supply, testing, or diagnosing);
d) Tutoring assignment decisions {i} of the following three categories:
   1. A single assignment (i) of at least one learning situation (s) by the generator 141, which does not leave any choice for the learner;
   2. Multiple assignment [i] by the generator 141 representing a set of single assignments (i) for the following learner's own choice of one single assignment;
   3. Rated assignment (Weight [i]) by the generator 141 representing said multiple assignment [i], where each single assignments (i) is associated with a personal utility (Weight) value for informed learner's choice of one single assignment.

The learning activity report represents:
a) An identifier (i′) of realized single assignment;
b) Identifier (s′) of identified situation and
c) Identifier (k′) of identified response.
   Composition.

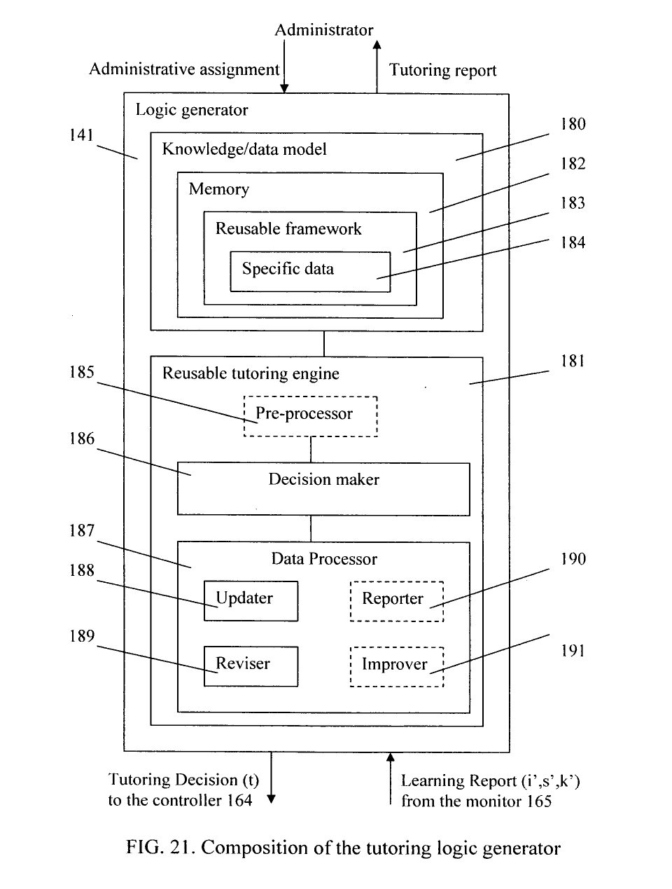

As it is illustrated in FIG. 21, the tutoring logic generator 141 includes the following main coupled modules:
a) the knowledge/data model 180, which represents a nesting hierarchy of the following modules:
   1. a memory 182 including:
      A. a reusable framework 183 including:
         a. specific tutoring data 184;
b) the reusable tutoring engine 181 that obtains the learning reports {i′,s′,k′} and generates tutoring decisions {t} based upon said tutoring knowledge model 180. It includes:
   1. an optional pre-processor 185 for data 184 pre-selecting, preparing and initializing;
   2. a decision maker 186 for making 130 tutoring decisions {t} based upon knowledge/data model 180;
   3. a processor 187 for specific data 184 adapting 134 including:
      A. Updater 188 for data 184 updating based upon learning reports,
      B. Reviser 189 for data 184 revising based upon decisions made;
      C. Optional reporter 190 for progress reporting to the administrator;
      D. Optional improver 191 for specific data 184 improving
         Operation.

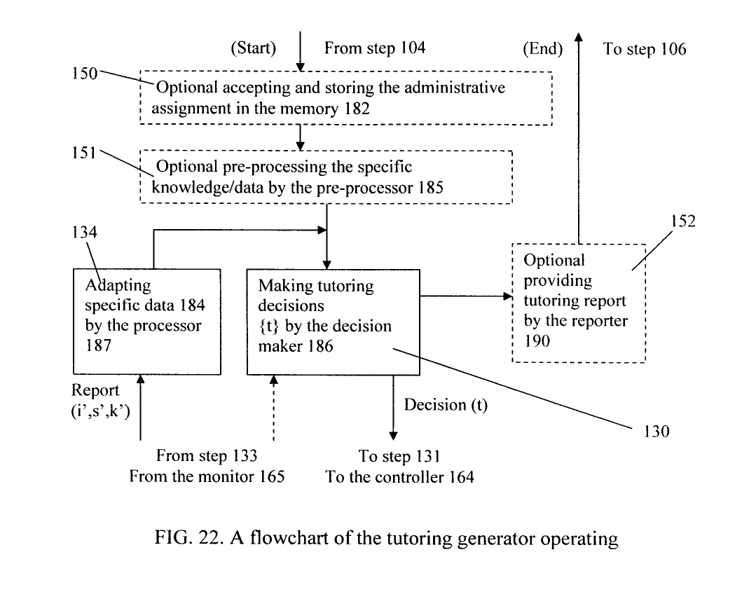

Operating the tutoring generator 141 is a part of the tutoring system 140 operating 105 depicted in general in FIG. 7 and in more detail in FIG. 11. Separately this part is illustrated in FIG. 22.

It can take control at any time after step 104.

On setup stage, operating the tutoring generator 141 can include:
a) Optional accepting 150 the administrative assignment from the administrator and storing it in the memory 182 framework 183 as a part of the specific data 184;
b) Optional pre-processing 151 stored specific data 184, which can include
   1. selecting and retrieving necessary data;
   2. transforming data from storage format to implementation format and
   3. initiating data for their use in the tutoring session.

In tutoring session, that is initiated by a user (a learner or instructor), the tutoring engine 181 makes 130 tutoring decisions {t} by decision maker 186 including a decision to stop or continue tutoring based upon available data 184.

If it decided to stop the tutoring, then the reporter 190 prepares 152 a tutoring report.

If it decided to continue tutoring, then decision maker 186 makes 130 other decisions {t} and transfers control to the controller 164 for executing 131. Then it gets back control from the monitor 165 of the media-logic converter 142 on step 133, obtains available data through the control channel and the learning report (i′,s′,k′) through the situation/response channel.

Through the control channel, illustrated with the dashed arrow, the decision maker 186 obtains data from its partner in decision making process, the learner, including chosen tutoring manner, a type and may be the instance (i′) of tutoring assignment.

When the tutoring generator 141 obtains the learning report (i′,s′,k′) through the situation/response channel, its processor 187 adapts 134 specific data 184 and enables new tutoring decisions based upon adapted specific data 184.

Adapting 134 data 184 includes:
a) specific data 184 updating by updater 188 based upon learning report (i′,s′,k′);
b) specific data 184 revising by reviser 189 based upon diagnostic decisions made;
c) optional progress report preparing by reporter 190
d) optional knowledge/data 184 improving by improver 191.

On final stage, the reporter 190 submits the tutoring report to the administrator, ends its operation and transfer control to the evaluating step 106.

This generic operating of the generator 141 has its specificity in each specific case 1-5.

Case 1. The passive (non-intrusive) tutoring manner can be determined by the administrative assignment on step 150 or at any other time by the learner through the control channel. The problem (p) aspect of the situation (s) is assigned on this step too. The decision maker 186 does not provide any assignments. It lets the domain 160 and/or the learner drive learning situations {s}The updater 188 “observes” the leaning activity through learning reports (i′,s′,k′), updates 134 its data 184 and then the decision maker 186 makes 130 occasional achievement decisions {v} and possibly the manner decision to switch from the current passive to the active tutoring manner.

Case 2. In active (interventional) manner, the decision maker 186 makes 130 tutoring decisions {t}, which include achievement {v}, manner, mode and assignment {i} decisions. For each tutoring assignment (i′), the updater 188 obtains the learning report (i′,s′,k′) from the monitor 165, updates 134 its data 184 and enables new tutoring decisions. If decision maker 186 made a diagnostic decision, then the reviser 189 revises the data 184 to enable automatic re-instructing of the learner from the diagnosed cause of faults detected.

Cases 3-5. In active (interventional) manner, the decision maker 186 shares decision making 130 with the learner and the domain 160. Particularly, in case of providing multiple [i] or rated assignment (Weight[i]), the learner chooses a single assignment (i′) him/herself through the control channel. The updater 188 gets back the learning report (i′,s′,k′) from the monitor 165, updates 134 its data 184 and enables new tutoring decisions. Again if decision maker 186 made a diagnostic decision, then the reviser 189 revises the data 184 to enable automatic re-instructing of the learner from the diagnosed cause of faults detected.

Knowledge/Data Model and its Framework

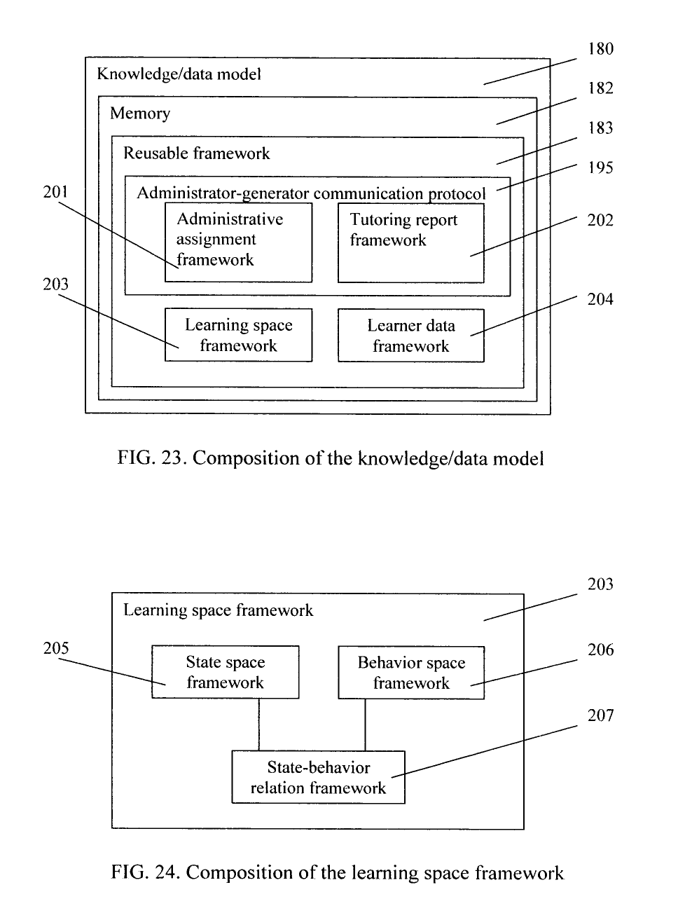

The tutoring knowledge/data model 180 is a part of said generator 141, which includes domain/learner-specific data 184 in memory 182 organized into the uniform reusable framework 183. See FIG. 23.

The memory 182 used for knowledge/data model 180 can be a standard random access type in order to support standard operations such as: data recording, storing, updating and retrieving. The memory 182 can be subdivided into long term memory and operative memory to support real time data processing in the tutoring engine 181. Data stored in long term memory can be pre-processed 151 for more effective use in the operative memory.

The uniform reusable tutoring knowledge/data framework 183 represents a special organization of the memory 182 and includes:
a) an administrator-generator communication protocol 195;
b) a learning space framework 203 representing learner-independent instructional knowledge referenced to specific instructional unit;
c) a learner data framework 204 referenced to the learner for personal adaptation of the tutoring generator 141;

Note: The tutoring knowledge/data framework 183, due to symmetry with the administrator-generator communication protocol 195, has to have a generator-converter communication protocol (including tutoring assignment and learning report framework) in order to support communication between the generator 141 and converter 142. That is fair and said generator-converter protocol will be provided for the situation/response channel by said learning space 203 and learner data 204 frameworks and described hereinafter.

The specific data 184 are filled in the uniform framework 183.

Administrator-Generator Communication Protocol

As illustrated iii FIG. 23, the administrator-generator communication protocol 195 is a part of the tutoring knowledge/data framework 183. It includes:
a) Administrative assignment framework 201 and
b) Tutoring report framework 202.
   Administrative Assignment and its Framework

The administrative assignment is a part of knowledge/data model 180. As a whole it includes a memory (a carrier), generic framework (placeholders or variables) and specific data (values). In preferable embodiment, the administrative assignment uses a part of common memory 182 organized in the administrative assignment framework 201, which represents a part of said reusable framework 183.

The administrative assignment framework 201 is also a part of the uniform communication protocol 195 between the administrator and the tutoring generator 141. It includes the following memory placeholders to be filled with specific data 184 in order to customize the tutoring generator 141:
a) a learner identifier (l),
b) a domain or instructional unit identifier (u);
c) a plurality of domain-independent and learner-independent tutoring parameters including at a minimum:
   1. Tutoring manner to begin with (passive, active or to be determined by the learner),
   2. Supply threshold, ST,
   3. Testing Threshold, TT,
   4. Diagnosing Threshold, DT.

Where,
a) said supply threshold (ST) defines required reliability of content supply, specifying what is sufficient in learning content supply to overcome known unreliability of learners with redundant set of learning activities;
b) said testing threshold (TT) defines required reliability of testing, specifying what is sufficient to overcome known unreliability of testing (in particular, possibility of guessing in multiple choice questions) with redundant set of problems and questions;
c) said diagnosing threshold (DT) defines required reliability of diagnosing, specifying what is sufficient to isolate a single cause of learners' faults from others.

These three parameters have the same range of possible values 0-1. Their default values can be the same: ST=T-r=DT=0.9.

Tutoring Report and its Framework

The tutoring report is a part of knowledge/data model 180. As a whole it includes a memory (carrier), generic framework (placeholder-s or variables) and specific data (values). In preferable embodiment, the tutoring report can use a part of common memory 182 organized in the tutoring report framework 202, which represents a part of said reusable framework 183.

A tutoring report framework 202 is also a part the uniform communication protocol 195 between the administrative system and the tutoring generator 141. It represents a learning progress of the learner in one of possible forms (for example, a traditional score, mastery profile, or a learner state model hereinafter). On demand, it can include more data. The invention does not imply any specific format for said report, but recommends using the learner data described hereinafter as the most informative representation of a learning progress.

Learning Space Model and its Framework

A real learning process of a particular learner is very complex and hidden phenomena, which cannot be directly observed and exactly measured. However, human tutors used to manage this very complex process pretty good with their mental representations and uncertain knowledge.

So does the tutoring generator 141. But in contrast with human tutor's implicit informal representations, the tutoring generator 141 uses an explicit formal representation of tutoring knowledge 180 that is necessary and sufficient for automatic generation of a tutoring 105 by the tutoring engine 181.

The learning space model is a part of knowledge/data model 180, which represents instructional declarative knowledge of the tutoring generator 141 about the learning process of any learner from a target audience at any time point within a specific instructional unit and domain. In general, it includes a memory (carrier), generic framework (placeholders or variables) and specific data (values). In preferable embodiment, the learning space model uses a part of common memory 182 organized in the learning space framework 203, which represents a part of said reusable framework 183.

As illustrated in FIG. 24, the learning space framework 203 includes the following parts:
a) a state space framework 205 for representing important but not traceable aspects of a learning process in said learning environment 143;
b) a behavior space framework 206 representing important traceable aspects of learning process in said learning environment 143 referenced to expected learning behaviors and particularly defining space holders for possible learning reports;
c) a state-behavior relation framework 207 integrating said state space framework 205 with said behavior space framework 206 into the whole learning space framework 203.

Note that any traditional instructional unit is designed for a target audience of learners and is not a priori adapted to any particular learner. In our case, such an instructional unit can be represented with the entire tutoring system 140 with empty learner data framework 204 and therefore include:
a) Specific media environment 143;
b) Specific media-logic converter 142;
c) Uniform tutoring engine 181 and
d) Uniform framework-based knowledge/data model 180, which in its turn includes:
   1. Specific learning space model 203.

In contrast to such a holistic definition of the instructional unit, there is another definition of the instructional unit as a courseware for playback. In accordance with it, a specific instructional unlit is defined as a specific (declarative) courseware separately from its uniform (procedural) player. In accordance with this definition, the intelligent instructional unit can be defined separately from its uniform multimedia (procedural) players and tutoring logic (procedural) engine 181 as well and represent the (declarative) part of tutoring system 140 including
a) in its media part:
   1. Specific learning resources of the media environment 143 and
   2. Specific media-logic relations of the converter 142 and,
b) in its logic part,
   1. specific learning space model 203 filled in uniform framework 180.

To represent general logical properties of the entire intelligent instructional unit, the specific data of the learning space model 203 can be easily aggregated into the following integral data:
a) Instructional unit identifier (u);
b) Manners coverage {passive, active};
c) Mode coverage (supply, testing, diagnosing);
d) Difficulty level range {very easy, easy, medium, difficult, very difficult}
e) Testing threshold limit {up to 1};
f) Supply threshold limit {up to 1};
g) Diagnosing threshold limit {up to 1};
h) Properties range, such as:
   1. Languages {English, Spanish, French, . . . };
   2. Age of target audience {6-10, 10-13, . . . }.

As can be seen now, the administrative assignment determines specific logical properties of entire instructional unit within their possible ranges.

State Space Model and its Framework

A state space model is a part of the learning space model, which represents important but directly untraceable aspects of learning process of each particular learner at any time within specific instructional unit.

As a whole it includes a memory (carrier), generic framework (placeholders or variables) and specific data (values). In preferable embodiment, the state space model shares common memory 182 organized in the state space framework 205, which represents a part of said learning space framework 203.

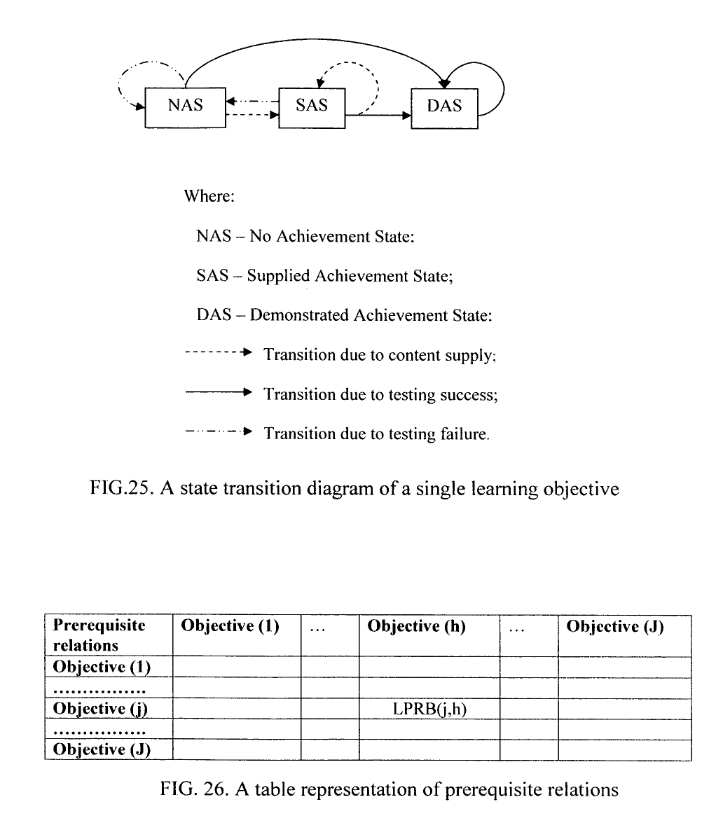

The state space framework 205 includes:
a) a plurality of learning objectives {j} of the instructional unit, where each learning objective is something to be taught and learned such as: specific expertise, knowledge, skills, attitude, aptitude, beliefs, preferences, opinions, etc.
b) a plurality of achievement states of each learning objective including at least:
   1. no-achievement state, NAS;
   2. supplied achievement state, SAS, and
   3. demonstrated achievement state, DAS.
      Where the supplied achievement state is realized due to supplying the learner with learning activities/resources/situations for learning, demonstrated achievement state is due to successful testing of the learner, and no-achievement state because of insufficient supply or a learning fault.
      Note that in contrast to a definition of known Bayesian models of learning states and so named “knowledge spaces” (Dietrich Albert Cord Hockemeyer, 1997), which represent said OR space, specified here states are not mutually exclusive. They can partially coexist and thus represent said AND-OR space. Specifically, no-achievement state can coexist with the supplied achievement state, the latter can coexist with the demonstrated achievement state, but the latter cannot coexist with no-achievement state.
c) a prerequisite relation among objective achievement states. Each objective achievement state is not static and can be changed due to some (internal or external) reasons. Specifically, any no-achievement state can transit to the supplied achievement state due to supplying the learner with learning situation/resources. The supplied achievement state in its turn is able to transit to the demonstrated achievement state in case of testing success. In contrast, a fault result of testing can provide a transition of the supplied achievement state into the no-achievement state again to initiate resupply. A state transition diagram is summarized in FIG. 25. In short, the no-achievement state is a prerequisite to the supplied achievement state, which is a prerequisite to the demonstrated achievement state:
d) A prerequisite relation among achievement states of different learning objectives. Very often an achievement of one learning objective requires achievement of some other prerequisite or enabling objectives. It means that supplied or demonstrated achievement of one objective can contribute to supply of another objective. These dependencies are usually defined by course authors. In general case, authors have no exact knowledge about prerequisite relations. But understanding the domain and conceiving a certain tutoring strategy, they can provide some, at least not very certain (fuzzy), beliefs about existence of prerequisite relation among each pair of objectives. The tutoring generator can use such prerequisite beliefs including local prerequisite beliefs LPRB(j,h) that said supplied achievement state of one objective (h) requires prior at least the supplied achievement state of another objective (j). See FIG. 26 for a table representation of the prerequisite relations. Note that by standard transposition operation, said local prerequisite beliefs LPRB(j,h) can be easily transformed into local succeed beliefs LSCB(j,h)=LPRB(h,j).

Said plurality of learning objectives {j} of the instructional unit (u) includes baseline objectives, which have no prerequisite objectives defined with the LPRB(j,h), and terminal objectives, which have no succeed objectives defined with the LSCB(j,h).

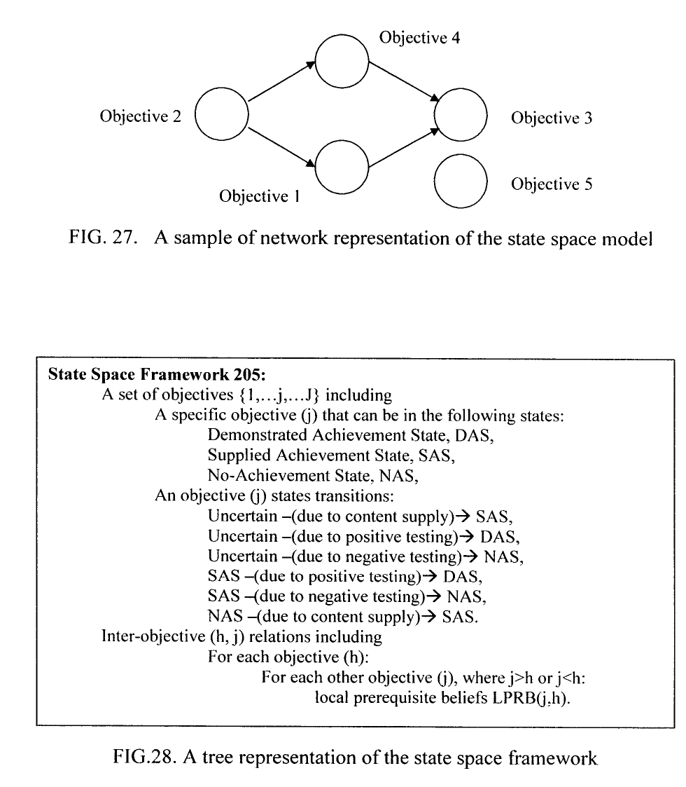

In simple visual form, the state space model can be sketched as a network of objectives connected with prerequisite binary relations. See example in FIG. 27.

In more detailed tree form, the state space model is illustrated in FIG. 28.

Behavior Space Model and its Framework

The behavior space model is a part of said learning space model representing important traceable aspects of learning process. Its framework 206 includes
a) An identifier (i) of at least one tutoring assignment or a plurality of them {i},
b) An identifier (s) of at least one learning situation or a plurality of them {s} and
c) An identifier (k) of at least one possible response or plurality of them {k}.

Despite of a possible variety of control sharing options between the generator 141, the learner and the domain 160 (see cases 1-5 above), the final cooperative decision is just a single tutoring assignment (i) to realize in media environment 143. In general, each tutoring assignment (i) can generate more than one learning situations {s} in learning environment 143. Despite of a variety and complexity of possible learner's responses on each learning situation (s), the final result of its identification represents just a single identifier (k) of the learner response.

As has been said, the completely defined situation (s) includes what is given (d) and what is required to do (p) in the domain. That is why each specific learning situation (s) is able to initiate a learning activity of the learner. As a rule, the learning media environment 143 includes controls for learner's responsive actions and the monitor 165 includes sensors to track actual situations and actions. Of course, the learner can perform uncountable number of unexpected actions as well, but all of them can be categorized just as a single “unexpected” response and denoted with one identifier (K+1).

Assuming all of these, the behavior space model includes the following data in general:
a) a plurality of identifiers {i} of corresponding plurality of single tutoring assignments in active tutoring manner (cases 2-5). In passive tutoring manner (case 1), it includes only one fixed assignment (i), which actually can be changed by the learner or domain 160:
b) a plurality of situation identifiers {s} of a corresponding plurality of learning situations provided by the leaning media environment 143;
c) a plurality of response identifiers {k=1,2, . . . ,K,K+1} of a corresponding plurality of expected responses {k=1,2, . . . ,K} of the learner in each learning situation (s) from said plurality of learning situations {s} extended with the extra identifier (K+1), which denotes all possible unexpected responses of the learner in the situation(s).

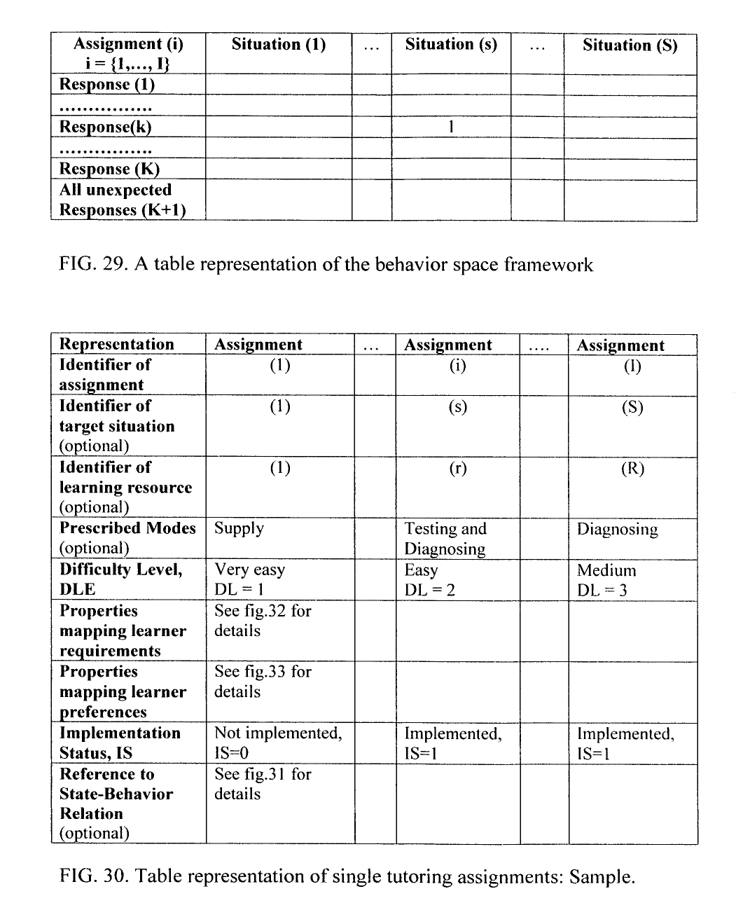

A sample of the behavior space framework 206 for each assignment (i) in a table form is given in FIG. 29. Each column in the table (i) denotes situation (s). Each row (k) denotes expected responses of the learner. “1” in intersection of the column (s) and row (k) means a possible behavior (i→s→k). If there is no certain evidence that the situation (s) provokes the response (k), then “1” can be replaced with corresponding behavior belief BB(s,k). It is a possible fuzzy extension of introduced deterministic behavior space framework 206.

The described behavior space framework 206 defines in general said communication protocol of the tutoring generator 141 with the media-logic converter 142.

Note that traditional fixed scripts/flowcharts used in widely spread regular computer-based education and training systems can be described potentially within the same framework 206 just because the invented logic generator 141 and traditional scripts/flowchart are supposed to simulate the same ideal external tutoring behavior. The problem is that the traditional manual scripting in advance of what the tutoring generator 141 automatically generates in real time operating with any particular learner is practically impossible.

Tutoring Assignment and its Framework

A tutoring assignment is a tutoring decision to realize specific learning situation (s) in the learning environment 143 for the learner. Particularly realization of said specific learning situation (s) in the learning environment 143 can be done by providing a uniform media player with a corresponding learning media resource.

In general, the learner and domain 160 can participate in the situation determination (see cases 3-5). To support such a cooperative assignment of learning situation (s), tutoring generator begins with pre-selecting the multiple assignment [i], which includes a set of single assignments. Then the learner and/or the domain model 160 can narrow this set down to one single assignment (i) to realize.

All available single tutoring assignments {i} are pre-stored in the generator memory 182. Corresponding memory is organized in a uniform tutoring assignment framework 211, as it is shown in FIG. 30, and includes placeholders for the following data:
a) an identifier (i) of single tutoring assignment;
b) an optional identifier (s) of at least one target learning situation to be created;
c) an optional identifier of learning resource (r) of the media environment 143, which is necessary to generate said learning situation (s). This direct reference to the learning resource (r) can help to simplify possibly a complex chain of logic-media conversion of each tutoring assignment (i) into specific command a(s) only the learning environment 143 to realize the target situation (s);
d) optional identifiers of tutoring modes (supply, testing or diagnosing) prescribed for the assignment by the author. By default the tutoring generator 141 can select all assignments automatically within each tutoring mode, but an author is welcome to prescribe in advance the best modes for each assignment;
e) a difficulty level of the tutoring assignment (i) comparable with said difficulty limit, DL.
f) a plurality of assignment properties corresponding to personal requirements of the learner and preferences of the learner from the learner data framework 204.
g) an implementation status (IS) having a set of values including at least “implemented” (IS=1) and “not implemented” (IS=0) values;
h) an optional reference to corresponding state-behavior relation described hereinafter.
   Learning Situation and its Logical Framework

In the learning environment 143, each specific media representation of the domain 160 and problem (p) for the learner can be quite different (see possible embodiments of the learning environment 143 above) and include different controls.

Possible examples are:
a) a static presentation slide with the “Next” button,
b) a “multiple choice” question with selectable alternatives:
c) a “fill in the blank” question with means to type in the text;
d) an “essay” kind of question with means to enter the text;
e) a dynamically evolving simulation with specific controls (buttons, joystick, etc);
f) a static moment in the game with specific controls available at the moment;
g) a dynamic voice/speech playback with controls: stop, play, pause, et cetera.

In accordance with its role in learning state framework 203, each learner situation (s) should be aimed to provide at least one of the following:
a) To supply the achievement state of at least one learning objective by the learner;
b) To check the demonstrated achievement state of at least one learning objective;
c) To diagnose the no-achievement state of at least one learning objective.

Despite of this variety, a mathematical representation (or logic behind the media) is quite simple:
it is just an identifier (s) of the situation existing in media environment 143.
   Learner Response and its Logical Framework

In the learning environment 143, physical controls for learner's action can be quite different (see possible embodiments of the learning environment 143 above).

In the monitor 165 of the media-logic converter 142, sensors for capturing learner's action events {e} on these controls can be quite different as well (see possible embodiments of the media-logic converter 142 above).

Possible examples are:
a) a click of “Next” button in a presentation slide,
b) a specific alternative selected by the student in a “multiple choice” question,
c) a text typed by the student in the “fill in the blank” type of question,
d) a text entered by the student in the essay type of question,
e) a sequence of hits on buttons of the simulator;
f) a voice/speech of the student,
g) a multi-dimensional trajectory of the joystick in a game et cetera.

In accordance with its role in the learning space framework 203, each response (k) should be able to provide at least one of the following:
a) Evidence of the achievement state of at least one learning objective by the learner;
b) Evidence of the demonstrated achievement state of at least one learning objective;
c) Evidence of the no-achievement state of at least one learning objective.

Tracking and identifying learner's responses in the monitor 165 can be very complex. It is a separate problem that has known solutions, which are supposed to be implemented in the monitor 165. But the logical representation of identification results in the tutoring generator 141 from the monitor 165 is very simple and represents just a set of identifiers {k} of expected responses. Its minimal value is k=1, if only one alternative of correct response has been predefined. It can be equal as well to k=1, 2, 3, . . . up to its maximal value k=K denoting a number of all expected sample responses of the learner available in the monitor 165 for identification of actual response of the learner in the situation (s).

In extension to said set of expected response identifiers {k}, a complete set of all possible response identifiers includes also an identifier (k=K+1) denoting a plurality of all unexpected responses, which is impossible or not necessary to predefine.

Optionally, in order to support traditional scoring, each possible identifier (k) can be complemented with a specific numerical value expressing algebraic contribution of corresponding response to the entire score.

Learning Report and its Framework

A learning report is an instance or case of said behavior space model representing a message from the monitor 165 to the tutoring generator 141.

Its framework 212 includes the following placeholders for specific data:
a) an identifier (i′) of single tutoring assignment chosen collectively by the generator, domain and learner, which in general can be unknown a priory by the generator 141;
b) an identifier (s′) of an identified learning situation from said plurality of expected learning situations {s}, which is the closest (in similarity) to the actual situation experienced by the learner. In general, the identified situation (s′) can differ from the target situation (s), which the tutoring generator intended to create, due to a generally unpredictable behavior of the domain and the learner;
c) an identifier (k′) of all identified response from said plurality of expected {k′=1, 2, 3, . . . ,K} and unexpected responses (k′=K+1), which is the closest (in similarity) to actual response of the learner in situation (s′).

In case the monitor 165 is not able to identify actual situation (s) and/or response (k) completely up to 100% reliability, it still can produce and the generator is able to accept uncertain beliefs that an actual situation (s′) and response (k′) are similar to available samples {s} and {k}. In this case, the learning report is more complex and includes the following:
a) the identifier (i);
b) a set of Situation Beliefs SB{s},
c) a set of response Beliefs RB{k}.

Note: Introduced here ontology/vocabulary of intelligent tutoring can be considered as well as a core of traditional script/flowchart-based Sharable Content Objects (SCO) from Sharable Content Object Reference Model. Indeed, widely used static linear and branching sequences of Sharable Content Assets (SCA) within Sharable Content Object (SCO) can be described with introduced here terms including:
a) an identifier (i) of specific learning activity associated with specific learning resource (r);
b) an identifier of learner's response (k) in said learning activity (i) associated with said learning resource (r);
c) association of each learner's response (k) with the next learning activity (i) to be assigned to the learner.

Note: Traditional scripts/flowcharts represent just a (manual, static, superficial media-based) shortcut of the (automatic, dynamic, sound logic-based) tutoring generator 141. Despite their quite different internal structure, their external behavior is supposed to be the same: both assign the next learning activity (i′) depending of learner's response (k′).

State-Behavior Relation and its Framework

A state behavior relation is a part of said learning space model that integrates the state space model and the behavior space model together. This relation provides an opportunity of internal interpretation of external learning behavior and by this way supports making main tutoring decisions.

For example, the correct response (k) of the learner in the problem situation (s) demonstrates the achievement state of some objectives (j). In other words, each correct behavior sample (i→s→k) provides an evidence of the demonstrated achievement state of certain objectives with certain beliefs, namely local demonstrating beliefs, LDB(j).

In contrast, a fault response (k) of the learner in the same problem situation (s) provides an evidence of the no-achievement state of some objectives, namely local fault beliefs, LFB(j).

A response (k) of the learner confirming just an acceptance of a learning domain situation(s) for study can evidence the supplied achievement state, namely local supplying beliefs, LSB(j), of certain objectives.

In general case, a learner response (k) on a situation (s) can be partially successful and partially faulty at the same time and thus provides LDB(j) and LFB(j), each on its own subsets of learning objectives. It can also evidence an acceptance of certain learning material and provide LSB(j) on certain learning objectives.

In general, the state-behavior relation includes a plurality of beliefs that a typical learner from a target audience has specific achievement states of each learning objective (i) from the state space model, if said learner realizes a specific behavior instance (i,s,k) from said behavior space model.

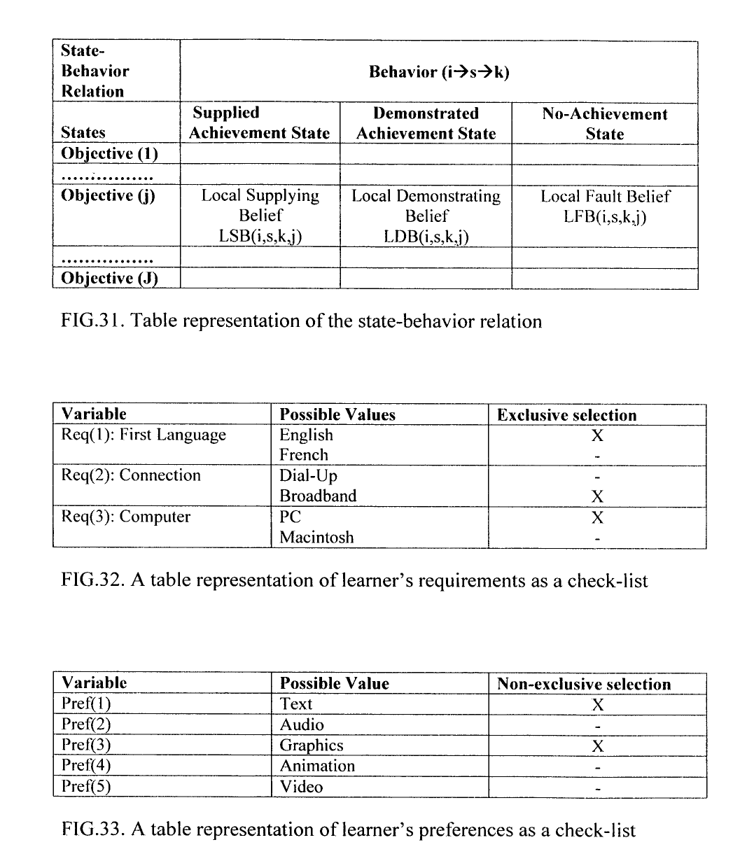

Accordingly, as illustrated in FIG. 31, the uniform state-behavior relation framework 207 comprises placeholders for the following plurality of beliefs:
a) a local demonstrating belief LDB(i,s,k,j) that the learning behavior instance (i,s,k) evidences the demonstrated achievement state of a learning objective (j) from said plurality of learning objectives {j};
b) a local supplying belief LSB(i,s,k,j) that said learning behavior instance (i,s,k) evidences said supplied achievement state of a learning objective (j) from said plurality of learning objectives {j};
c) a local fault belief LFB(i,s,k,j) that said learning behavior instance (i,s,k) evidences said no-achievement state of said learning objective (j) from said plurality of learning objectives {j}.

Note, that in a special case, when only one correct response is predefined, which means that k=K=1, there is no need to store LFB(i,s,k,j) in the memory 182 because said LFB(i,s,k,j)=LDB(i,s,k,j).

Learner Data Model and its Framework

The learner data model is a part of tutoring knowledge/data model, which represents generator's knowledge/data of the particular learner in the tutoring loop. The learner data framework 204 is a set of domain-independent and learner-independent placeholders in the memory 182 for personal data of the learner, which is important for tutoring dynamic adaptation. It includes:
a) a learner state model defined on the basis of said state space framework 205;
b) a learner behavior model defined on the basis of said behavior space framework 206;
c) a personal data model defined on the basis of said personal data framework 213;
   Personal Data Model and its Framework

Personal data model is a part of said learner data model. Its uniform framework 213 includes a plurality of possible requirements of the learner, plurality of his/her possible preferences, and plurality of current tutoring style parameters.

The possible requirements of the learner are supposed to be strict, non-negotiable and cannot be compromised by the tutoring generator 141 (but can be edited by the learner), while preferences are soft, negotiable and can be compromised by the tutoring generator as well as edited by the learner.

In preferred embodiment, requirements and preferences frameworks are presented in a checklist form. See the self explanatory example of requirement checklist in FIG. 32 and self explanatory example of preference checklist in FIG. 33.

Prior to a learning session, the tutoring style parameters can be assigned for the learner by the instructor, by the tutoring engine by default, or selected by the learner him/herself. Then during the session, they will be automatically adjusted by the processor 187. In preferred embodiment, the framework 213 includes the following adjustable parameters:
a) a difficulty limit, DL,
b) a testing delay limit, TDL,
c) a fault tolerance limit, FTL, and
d) a desired type of tutoring assignments (TAT) in active tutoring manner (multiple, rating or single).

An initial value of the difficulty limit, DL, can be selected from the following common list: {very easy, easy, medium, difficult, very difficult}. Each qualitative value of DL has a corresponding quantitative value: 1-5. Default value DL=medium=2 is recommended.

Initial value of the Testing Delay limit, TDL, denoting a number of learning objectives to supply prior their achievement testing, is from one (1) objective up to a total number of all learning objectives (J). Default value TDL=3 is recommended.

Initial value of the fault tolerance limit FTL, denoting a maximal tolerable sum of no-achievement: beliefs sufficient to switch the testing mode into the diagnosing mode, can be selected from 0.001 up to a total number of learning objectives (J). Default value FTL=0.3 is recommended.

Desired type of tutoring assignments TAT specifies one of the following types of tutoring assignments:
a) a multiple tutoring assignment, which assigns a subset [i] of single tutoring assignments from said plurality of available single tutoring assignments {i} to enable guided personal learner's choice of one single assignment (i); TAT=multiple;
b) a rating tutoring assignment (weight[i]), which rates said pre-selected subset [i] of single tutoring assignments to enable informed personal learner's own choice of zone single assignment (i); TAT=rating;
c) a single tutoring assignment from said plurality of available single tutoring assignments {i}. This option is considered as a default type of tutoring assignments, TAT=single.
   Learner State Model and its Framework

A learner state model is a part of said learner data model that positions the learner in said state space model. Its uniform framework 214 includes placeholders for the following specific data:
a) a set of beliefs of the tutoring generator 141 that the learner has specific achievement states of each specific learning objective (j). All these beliefs together represent knowledge of the tutoring generator about current state of the learner in the learning state space. At a minimum, for each learning objective (j) they include
   1. a no-achievement belief NAB(j) corresponding to said no-achievement state,
   2. a supplied achievement belief SAB(j) corresponding to said supplied achievement state and
   3. a demonstrated achievement belief DAB(j) corresponding to said demonstrated achievement state.
   All these beliefs have the same range of possible values [0-1].
   Their initial values are NAB(j)=SAB(j)=DAB(j)=0.
   The current values of these beliefs are changed during operation of the generator 141 and should be resumed if the learner quits the instructional unit to be able to restart the next session from the same state.
b) a learning prospect P(j) defining a direction of a learning progress through the plurality of learning objectives. It is necessary to keep the same direction of tutoring to terminal objectives to prevent occasional jumping of a tutoring discourse.
c) Optionally, a set of necessary learning objectives from said plurality of learning objectives {j}. It represents a subset [j] of learning objective set {j} specially selected by the learner to achieve within the instructional unit (u) and all their enabling objectives defined with local prerequisite beliefs LPRB(j,h). Isolation and further use of only these objectives [j] allows focusing of tutoring activity on exactly what the learner wants to achieve within the instructional unit.
d) Optionally, a plurality of approved achievement states from said plurality of achievement states of each learning objective (j), which are necessary to make strategic (high-stake) tutoring decisions, such as: learning of the entire unit is successfully completed, content supply of the entire unit is successfully completed, and fault diagnosing is successfully completed. These data are calculated from already available NAB(j), SAB(j) and DAB(j) and include:
1. an approved demonstrated achievement state ADAS, which corresponding demonstrated achievement belief DAB(j) is equal or exceeds said testing threshold, DT,
2. an approved supplied achievement state ASAS, which corresponding supplied achievement belief SAB(j) is equal or exceeds said supply threshold, ST, and
3. an approved no-achievement state ANAS, which no-achievement belief NAB(j) exceeds no-achievement beliefs NAB(h) of all other learning objectives {where h is not equal to j} by said diagnosing threshold, DT.

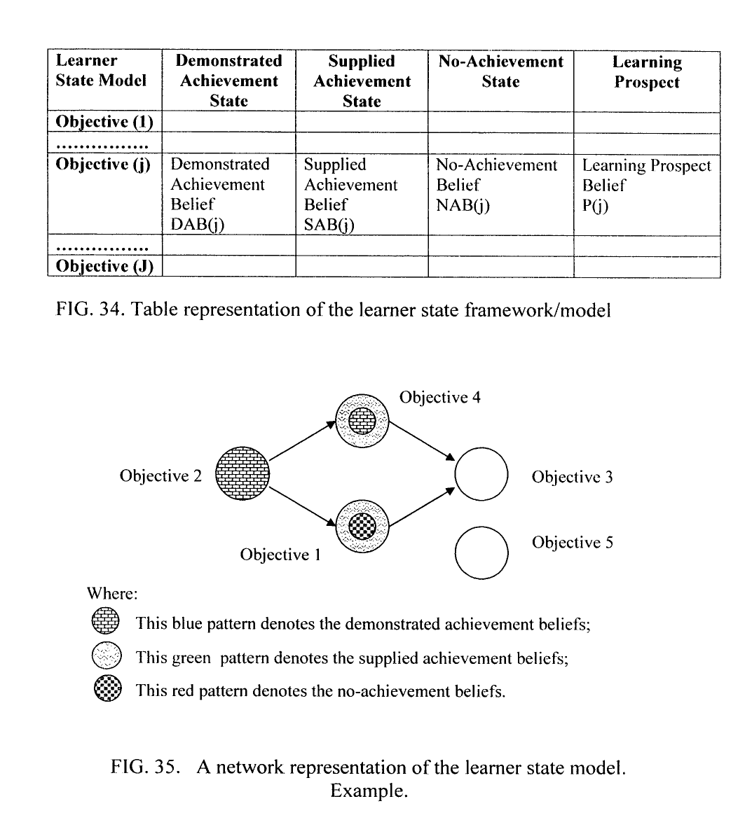

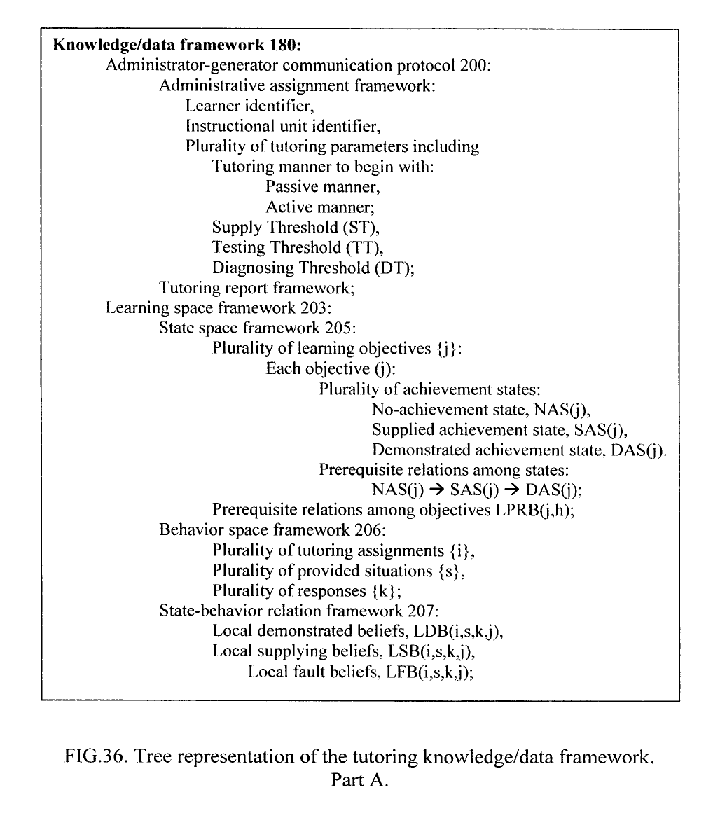

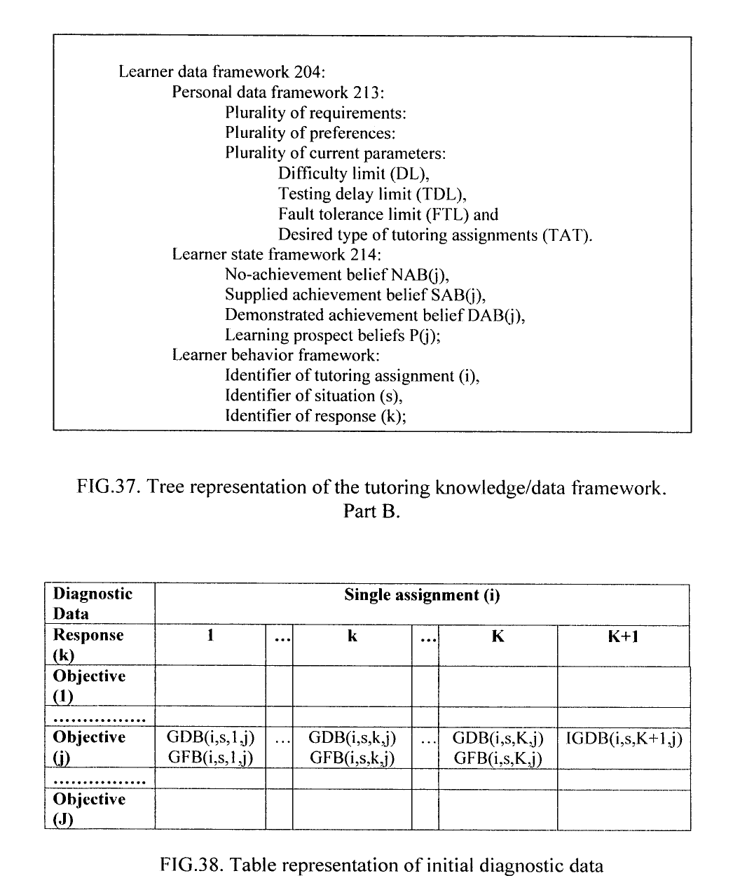

The core learner state model can be represented in table form. See FIG. 34.

In simple visual form, the learner state model can be represented as a colored objective network. See FIG. 35, where each objective is painted with a different color pattern according to its state. In preferable embodiment, green color pattern means the supplied achievement state, blue color pattern means the demonstrated achievement state, and red color pattern means no-achievement state. Belief values can be displayed, for example, with different intensity, radius or filling of said color patterns in each objective.

Learner Behavior Model and its Framework

The learning behavior model is a part of learner data model. It is defined as a specific instance or case of the behavior space model and includes:
a) the identifier of assignment (i),
b) the identifier of situation (s),
c) the identifier of response (k).

In case if the monitor 165 of the media-logic converter 142 is not able to identify actual situation (s) and response (k) completely, the generator 141 can accept and process uncertain beliefs of the monitor 165 that an actual situation and response are similar to available samples {s} and {k}. In this more generic case, the learner behavior model includes:
a) the identifier of assignment (i);
b) the set of situation Beliefs SB{s},
c) the set of response Beliefs RB{k}.

As can be seen the learner behavior model is just the learning report of the monitor 165 about learning activity of the learner into the generator 141.

Generator-Converter Communication Protocol

The generator-converter communication protocol is a part of the tutoring knowledge/data framework 183. Its framework includes already described:
a) tutoring assignment framework 211 and
b) learning report framework 212.
   Data from Authors

In process of an instructional unit design, authors are supported with authoring tools, which include described uniform frameworks, to fill in their domain/tasks-specific logical (vs media) knowledge and data 184 comprising:
a) A set of learning objectives {j} of the instructional unit,
b) A tutoring strategy described with local prerequisite beliefs LPRB(j,h) that the supplied achievement state of one objective (h) requires prior at least the supplied achievement state of another objective (j). It can be presented in table form (see FIG. 26) or preferable network form (see FIG. 27).
c) A tutoring style defined with the following parameters:
   1. Tutoring manner (passive, active, or both),
   2. said testing threshold, TT;
   3. said supply threshold, ST;
   4. said diagnosing threshold, DT;
d) Identifiers of learning situations {s} to recognize in passive tutoring manner and/or to create in active tutoring manner;
e) Every single tutoring assignment (i) specifications, as it is illustrated in FIG. 30.
f) Identifiers of expected responses {k} on each learning situation (s) for each tutoring assignment (i);
g) The state-behavior relation defined with the following beliefs:
   1. local demonstrating belief LDB(i,s,k,j),
   2. local supplying belief LSB(i,s,k,j),
   3. local fault belief LFB(i,s,k,j).

Optionally. Authors can even advice the tutoring generator 141 what to do by direct prescribing the next tutoring assignment (i) to certain behavior instances [i,s,k]. These prescriptions will allow running the intelligent instructional unit by non-intelligent regular sequencing engines, such as the current engines in the SCORM run-time environment. It allows increasing the reusability of the intelligent courseware.

Sometimes, the logical authoring by manual description of all these data can be labor consuming as well. To simplify it, it is possible, at least partially, to perform a manual demonstration and interpretation of learning behavior in the media environment 143 by the author. In this case, the author selects each tutoring assignment (i) in available media environment 143, demonstrates a sample of expected learner's activity (i,s,k) and map it into the objective {j}state network. To support this kind of advanced authoring, the authoring tool should be able to associate demonstrated samples (i,s,k) and {j} into corresponding beliefs LDB(i,s,k,j), LSB(i,s,k,j), and LFB(i,s,k,j). It is just data storing and technically obvious.

Data from Instructors

Instructors can manage the learning process within the universe provided by authors of instructional units and specify the following data in the administrative assignment:
a) learner identifier (1),
b) instructional unit identifier (u),
c) tutoring style parameters (within a range predefined by authors):
   1. Tutoring manner (passive, active, or both),
   2. Supply Threshold, IT
   3. Testing Threshold, TT,
   4. Diagnosing Threshold, DT, as well as
   5. Difficulty limit, DL,
   6. Testing delay limit, TDL,
   7. Fault tolerance limit, FTL,
   8. Types of tutoring assignments (multiple, rating, single, or all)
      Data from Learners

Learners can control over their own learning process within options predefined for them by instructors. The learner is welcome to select an instructional unit (u), tutoring manner to begin with, and tutoring style parameters within the range pre-defined by instructors including:
a) Difficulty limit, DL
b) Testing delay limit, TDL,
c) Fault tolerance limit, FTL,
d) Types of tutoring assignments (TAT=multiple, rating, single, or all).
   Data Pre-Processing

Original data 184 from authors can be stored in the generator memory 182 and be processed during run-time operation of the generator 141. If there is a need to accelerate a run-time operation, original data 184 from authors can be preprocessed 151 prior their run-lime use in a tutoring session.

In preferred embodiment, data 184 obtained originally for authors are pre-processed by the tutoring generator 141 prior their usage. The preprocessing 151 includes:
a) transformation,
b) extrapolating,
c) integrating,
d) pre-selecting and
e) preparing.

(a) Transformation of prerequisite relations into succeed relations is necessary for instructional planning of learning supply. This transformation is performed by a standard transposition of said local prerequisite beliefs LPRB(j,h) into succeed beliefs LSCB(j,h) by swapping index (j) with index (h) in said local prerequisite beliefs LPRB(j,h). So, succeed beliefs LSB(j,h)=LPRB(h,j).

(b) Extrapolating local beliefs into global ones.

This is necessary for instructional planning in order to provide the tutoring generator 141 with capability to look forward (to envisage influence of each assignment/situation) up to terminal learning objectives and to look backward (to estimate response background or backtrack causes of faults) down to baseline learning objectives within the instructional unit. Mathematically, extrapolating can be performed on the basis of standard multiplication of a matrix LPRB(j,h) or LSCB(j,h) with a vector of local beliefs: LSB(j), LDB(j) or LFB(j). It can be done as well in a classic Bayesian manner. But in the simplest and preferred embodiment, it is recommended to usc a standard MaxMin operation.

Specifically,
global prerequisite beliefs GPRB(j,h) are defined procedurally for all terminal objectives with step by step backtracking all prerequisite objectives defined within corresponding local prerequisite beliefs LPRB(j,h) down to the baseline objectives, GPRB(j,h)←LPRB(j,h);
global succeed beliefs GSCB(j,h) can be defined procedurally for all baseline objectives with step by step toward tracking its succeed objectives defined with corresponding local succeed beliefs LSCB(j,h) up to the terminal objectives, GSCB(j,h)←LSCB(j,h).

As has been said, local succeed beliefs LSCB(j,h) are just a transposition of the local prerequisite beliefs LPRB(j,h), LSCB(j,h)=LPRB(h,j). Analogically, the global succeed beliefs GSCB(j,h) are a transposition of the global prerequisite beliefs GPRB(j,h), GSCB(j,h)=GPRB(h,j). Thus, described above procedure of defining GSCB(j,h) can be performed by simple transposition of GPRB(h,j).

Specifically,
global supplying beliefs GSB(i,s,k,j) represent a result of extrapolating said local supplying beliefs LSB(i,s,k,j) with said global succeed beliefs GSCB(j,h) up to terminal learning objectives, which have no succeed learning objectives, defined by local succeed beliefs LSCB(j,h):

$$GSB ( i , s , k , j ) = {Max}_{h} Min \{ LSB ( i , s , k , h ) * GSCB ( j , h ) \} .$$

Global demonstrating beliefs GDB(i,s,k,j) represent a result of extrapolating said local demonstrating beliefs LDB(i,s,k,j) with said global prerequisite beliefs GPRB(j,h) down to baseline learning objectives, which have no prerequisite learning objectives, defined by local prerequisite beliefs LPRB(j,h):

$$GDB ( i , s , k , j ) = {Max}_{h} Min \{ LDB ( i , s , k , h ) * GPRB ( j , h ) \} .$$

Global fault beliefs GFB(i,s,k,j) represent a result of extrapolating said local fault beliefs LFB(i,s,k,j) with said global prerequisite beliefs GPRB(j,h) down to baseline learning objectives, which have no prerequisite learning objectives, defined by local prerequisite beliefs LPRB(j,h):

$$GFB ( i , s , k , j ) = {Max}_{h} Min \{ LFB ( i , s , k , h ) * GPRB ( j , h ) \} .$$

(c) Integrating beliefs.

Integrating is necessary for instructional planning in order to provide the tutoring generator 141 with a “big picture” and exclude noisy details. Mathematically, it can be performed by a standard integrating operation across a value range of a variable to exclude. Particularly, the fuzzy algebra including Max, Min and other standard operations can be used for these purposes. But in preferred embodiment, we use standard Mean operation, which implementation is much wider.

Specifically, integrated local demonstrating beliefs ILDB(i,s,j) represent said local demonstrating beliefs LDB(i,s,k,j) aggregated across all expected responses {k=1,2, . . . K} of the behavior space model. In the simplest and preferred embodiment, they are calculated with the standard Mean operation according to the following formula:

$$ILDB ( i , s , j ) = {\sum }_{k = 1}^{K} LDB ( i , s , k , j ) / K .$$

Integrated local supplying (beliefs ILSB(i,s,j) represent said local supplying beliefs LSB(i,s,k,j) aggregated across all expected responses {k=1,2, . . . K} of the behavior state model. In simplest and predefined embodiment, they are calculated analogically:

$$ILSB ( i , s , j ) = {\sum }_{k = 1}^{K} LSB ( i , s , k , j ) / K .$$

Integrated global demonstrating beliefs IGDB(i,s,j) represent an extrapolation of said integrated local demonstrating belief's ILDB(i,s,j) with said global prerequisite beliefs GPRB(j,h) down to baseline learning objectives, which have no prerequisite learning objectives, defined with said local prerequisite beliefs LPRB(j,h). In simplest and preferred embodiment, they are calculated with the following formula:

$$IGDB ( i , s , j ) = {Max}_{h} Min [ ILDB ( i , s , j ) , GPRB ( j , h ) ] .$$

Demonstrating background beliefs DBB(i,s,j) represent a pure extrapolation of said integrated global demonstrating beliefs IGDB(i,s,j) over said integrated local demonstrating belief ILDB(i,s,j) down to baseline learning objectives. In simplest and preferred embodiment, they are calculated with the following formula
DBB(i,s,j)=IGDB(i,s,j)−ILDB(i,s,j).

Supplying background beliefs SBB(i,s,j) represent a pure extrapolation of said integrated local supplying beliefs ILDB(i,s,j) with said global prerequisite beliefs GPRB(j,h) down to baseline learning objectives. In simplest and preferred embodiment, they are calculated with the following formula:

$$SBB ( i , s , j ) = {Max}_{h} Min [ ILSB ( i , s , j ) , GPRB ( j , h ) ] - ILSB ( i , s , j ) .$$

Integrated global supplying beliefs IGSB(i,s,j) represent an extrapolation of said integrated local supplying beliefs ILSB(i,s,j) with said global succeed beliefs GSCB(j,h) up to terminal learning objectives, which have no succeed learning objectives defined with said LSCB(j,h). In simplest and preferred embodiment, they are calculated in accordance with the following formula

$$IGSB ( i , s , j ) = {Max}_{h} Min [ ILSB ( i , s , j ) , GSCB ( j , h ) ] .$$

Integrated global fault beliefs IGFB(i,s,j) can be defined as an extrapolation of said integrated local fault beliefs ILFB(i,s,j) with said global prerequisite beliefs GPRB(j,h) down to baseline learning objectives, which have no prerequisite learning objectives defined with said LPRB(j,h). But in simplest and preferred embodiment, they can be approximated with said integrated global demonstrating beliefs IGDB(i,s,j),
IGFB(i,s,j)=IGDB(i,s,j).

(d) Pre-selecting.

Pre-selecting personally appropriate assignments for the learner allows reducing a number of options in a real-time selection of the next assignment in active tutoring manner. This operation checks how each candidate assignment properties meets personal requirements of each learner. Not matching assignments are rejected from a list of assignments for the learner.

(e) Preparing.

The most effective adaptive diagnosing of fault causes takes a significant amount of operations. Fortunately, it allows preparing some data in advance as follows:

Pre-selecting tutoring assignments from said plurality of tutoring assignments {i}, which prescribed mode (see FIG. 30) is diagnosing or testing.

Pre-selecting tutoring assignments from remaining plurality of tutoring assignments, which corresponding GDB(i,s,k,j)>0 on at least one learning objective (j) of diagnosing interest.

In each pre-selected assignment (i), pre-selecting only diagnostically meaningful responses (k), where [GDB(i,s,k,j) or GFB(i,s,k,j)]>0 on at least one learning objective (j) and exclusion of all other responses. See a table of diagnostic data in FIG. 38.

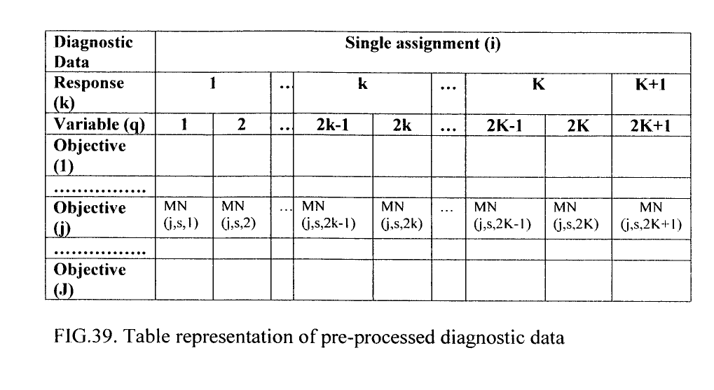

Stretching remaining GDB(i,s,k,j) and GFB(i,s,k,j) in one sequence by replacing the same index (k) in both of them with one single index (q) with different values for GDB(i,s,q,j) and GFB(i,s,q,j). See a table of diagnostic data in FIG. 39.

Inversing and renaming GDB(i,s,q,j) by the following operation:
MN(i,s,q,j)←1−GDB(i,s,q,j);

Renaming GFB(i,s,q,j) by the following operation:
MN(i,s,q,j)<GFB(i,s,q,j);
For each single tutoring assignment (i) corresponding to situation (s), calculating sum MS(i,s,j) of MN(i,s,q,j) across all possible responses q=1,2, . . . ,2K+1;

$$MS ( i , s , j ) = {\sum }_{q = 1}^{2 K + 1} MN ( i , s , q , j ) ;$$
Normalizing MN(i,s,q,j) for each assignment (i) corresponding to situation (s):
   MN(i,s,q,j)←MN(i,s,q,j)/MS(i,s,j);

Resulting data MN(i,s,q,j) are ready for run-time adaptive diagnosing. See FIG. 39.

In the simplest embodiment, each single assignment (i) creates a single learning situation (s). It means that (i) can be arranged to be equal (s) and overall dimension of tutoring data 184 can be decreased.

Knowledge/Data Verification

Specific knowledge/data 184 for the knowledge/data model 180 should be mutually consistent as well as necessary and sufficient for solving all tutoring tasks by said tutoring engine 181 in desired tutoring manners.

For passive tutoring manner:

To enable reliable testing of all learning objectives {j}, a predefined plurality of identifiable learning situations {s} within a sole assignment (i′) should be sufficient to cover all declared learning objectives {j} with predefined reliability defined with the testing threshold, TT.

Particularly, the sufficiency of the situation set {I} for passive testing can be checked by combining their integrated local demonstrating beliefs ILDB(i′,s,j) in accordance with the following procedure:
a) Initialization DAB(j)=0;
b) For all (s) beginning from s=1 and incrementing with step 1 up to s=S and for all (j) beginning from j=1 and incrementing with step 1 up to j=J Calculating: DAB(j)←DAB(j)+ILDB(i′,s,j)−DAB(j)*ILDB(i′,s,j);
c) Checking tip if for all j=1, 2,3, . . . , J corresponding DAB(j)>=TT, then the set {s} of learning situations is sufficient for testing all plurality of learning objectives, otherwise
d) Defining more situations and repeating the step (b) of calculating until sufficiency on the step (c).

To enable testing/diagnosing focused down to each single leaning objective, each learning objective (j) should be covered with at least one distinct behavior (i′,s,k) in the sole assignment (i′) characterizing achievement of only this specific learning objective (well, may be together with some prerequisite objectives) with predefined reliability, TT.

To enable on-the-fly diagnostic remediation focused down to each single learning objective, each learning objective (j) should be provided in advance with at least one extra supply assignment with lowest difficulty level (which is actually a remediation) able to correct the no-achievement state of diagnosed learning objective with at least predefined reliability, ST.

For active tutoring manner:

To enable bulk supply and testing of all learning objectives, a whole plurality of available assignments {i} of learning situations {S} should cover all declared learning objectives {j} with predefined reliability.

Particularly, this sufficiency can be checked by combining integrated local supply and demonstrating beliefs in accordance the following procedure:
a) Initialization DAB(j)=SAB(j)=0;
b) For all (i) beginning from i=1 and incrementing with step 1 Lip to i=1
   for all (s) beginning from s=1 and incrementing with step 1 tip to s=S and
      for all j beginning from j=1 and incrementing with step 1 tip to j=J
   Calculating
      1. DAB(j)←DAB(j)+ILDB(i,s,j)−DAB(j)*ILDB(i,s,j);
      2. SAB(j)←SAB(j)+ILSB(i,s,j)−SAB(j)*ILSB(i,s,j)];
c) Checking up if all SAB(j)>=ST, then the set {i} of tutoring assignments is sufficient to supply the set {j} of learning objectives;
d) Checking up if all DAB(j)>=TT, then the set {i} of tutoring assignments is sufficient to test the set {j} of learning objectives;
e) Otherwise extent the set of tutoring assignments {i} and return to calculating (b) until sufficiency.

To enable (optional) the most effective supply, testing and diagnosing all learning objectives, available plurality of tutoring assignments {i} and teaming situations {f} should be diversified enough to meet diversity of possible learning states.

To enable just in point (remedy) supply, testing and diagnosing focused down to each single objective, each learning objective (j) should be provided with at least one single supply assignment with the lowest difficulty level and a single testing/diagnosing assignment each covering only this specific learning objective (j) with at least predefined reliability defined with corresponding ST and FT.

To enable (optional) highly personalized selection of tutoring assignments for each particular learner, the plurality of all tutoring assignments {i} and learning situations {s} should be diversified enough to cover all diversity of personal requirements and preferences of all learners from the target audience.

At a minimum, to provide necessary controllability and observability of learning process within an instructional unit, each learning objective (j) from the plurality of all learning objectives {j} of an instructional unit should form a self-sufficient quartet including:
a) Single learning objective (j) itself;
b) Reference to prerequisite learning objectives [h];
c) A single supply assignment (i) of minimal difficulty, which is sufficient to supply or remedy achievement of said single objective (j) in case of all its prerequisite objectives [j] are already supplied sufficiently;
d) A single testing/diagnosing assignment (i), which is sufficient to test achievement of said single objective (j) may be together with all or some of its prerequisite objectives.
   Data Initializing

If the learner begins the unit or instruction from scratch, then the tutoring generator 141 has no any beliefs about his/her personal learning state. Initially they are equal to zero:
a) no-achievement belief NAB(j)=0;
b) supplied achievement belief SAB(j)=0;
c) demonstrated achievement belief DAB(j)=0.

An initial value of the difficulty limit, DL, can be selected by the learner personally from the following SCORM-compliant list: {very easy, easy, medium, difficult, very difficult}. Each qualitative value of DL, has a corresponding quantitative value: 1-5 Default value DL=medium=2 is recommended.

Initial value of the Testing Delay Limit, TDL can be selected by the learner personally or by instructor from one objective (TDL=1) up to a total number of learning objectives (TDL=J). Default value TDL=3 is recommended.

Initial value of the fault tolerance limit FTL can be selected by an instructor/learner from FTL=0.001 tip to a total number of learning objectives (FTL=J). Default value FTL=0.3 is recommended.

If a learner quits a unit, his/her current personal data are stored in the long term memory. When he/she returns, stored data are resumed in the operative memory 182 and used as initial ones.

The Tutoring Engine

Environment.

The tutoring engine 181 is a domain/learner-independent part of the tutoring logic generator 141 of intelligent tutoring 105.

Parameters:

It coupled with the knowledge/data model 180 that particularly provides it with the administrative assignment including identifiers of the learner (l), instructional unit (u) and tutoring parameters, which in turn includes as a minimum: the tutoring manner (passive or active), supply threshold (ST), testing threshold (TT), and diagnosing threshold (DT). The list of parameters can be extended with parameters for advanced fine tuning the generator including coefficients (INC and DEC) defining a desired speed of adaptation process.

Functions.

During the session it obtains the learning reports {i′,s′,k′} from the media-logic converter 142, processes the knowledge/data model 180 and makes all kind of tutoring decisions {t}.

In passive manner the engine 181 makes main achievement {v} and manner decisions as well as assigns corresponding comments {c} through the comment channel.

In active manner, it additionally selects its internal tutoring mode and an external tutoring assignment (i) to realize a specific learning situation (s) for the learner in learning environment 143 through the situation/response channel. Through available control channel it can also accept the type of assignments chosen by the learner in the learning environment 143.

Concluding the tutoring session, it generates a tutoring report optionally.

Composition.

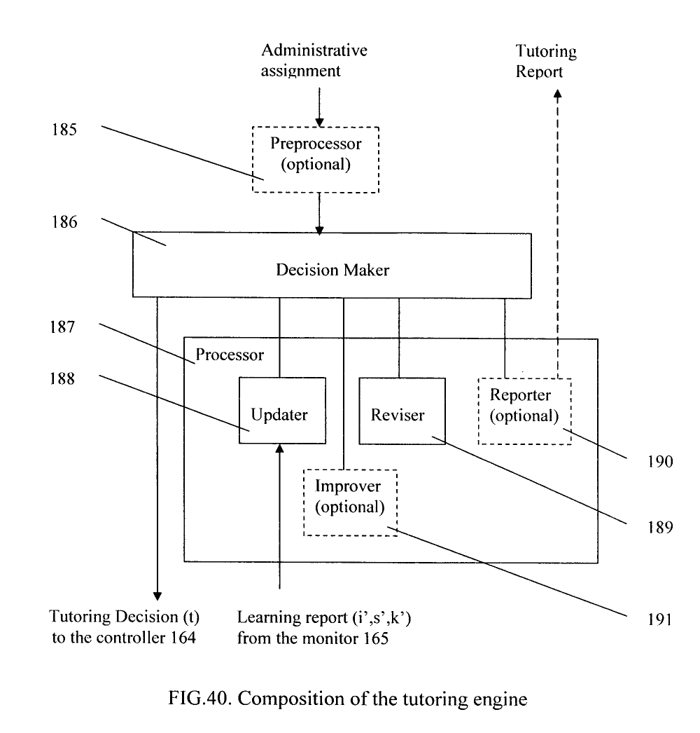

The generator engine 181 includes the optional pre-processor 185 and obligatory decision maker 186 and processor 187 coupled together as depicted in FIG. 40. The processor 187, in its turn, includes the updater 188 and reviser 189. Optionally it can include also the reporter 190 and improver 191. All components 188-190 of the processor 187 are connected to the decision maker 186.

Operation.

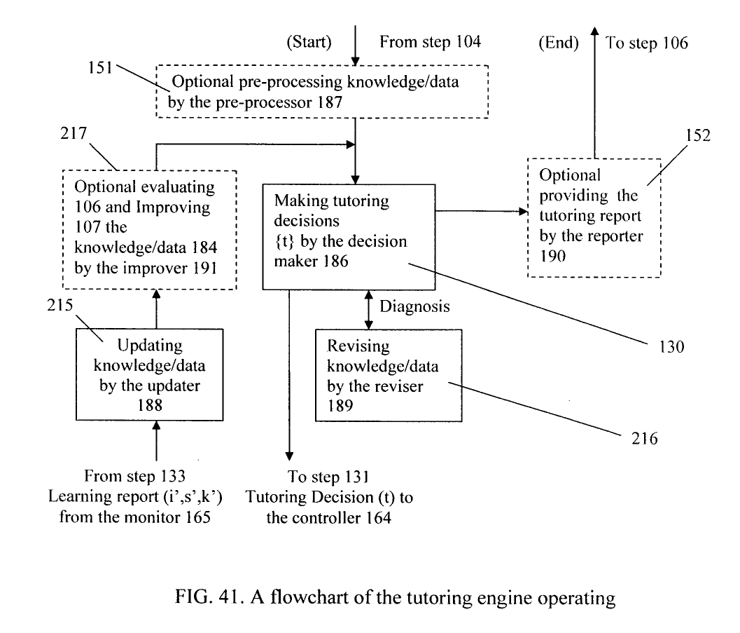

The flowchart of the engine operation is illustrated in FIG. 41.

It can take control at any time after step 104.

In the beginning of each tutoring session, the preprocessor 185 can prepare all necessary data for operating the decision maker 186.

In the passive manner, the decision maker 186 uses the knowledge/data model 180 to make 130 main tutoring decisions including decisions to end tutoring, put a diagnosis, and switch to the active manner. Then it assigns corresponding comment (c) for the learner through the comment channel of the media-logic converter 142 and the media environment 143.

In the active tutoring manner, decision maker 186 additionally decides which tutoring mode (supply, testing, diagnosing) to execute and which first (then next) tutoring assignment (i) to select and realize through the situation/response channel (optionally adjusted by the learner by selecting the desired type of tutoring assignments through the control channel).

In both passive manner when assignment (i′) is fixed and in active manner when assignment (i′) is made, after making any decision (t), the decision maker 186 transfer control to controller 164 for its executing 131.

Then the updater 188 gets control back from step 133 and accepts the behavior report (i′,s′,k′) from the monitor 165 of the media-logic converter 142.

If decision maker 186 made a diagnostic decision, then reviser 189 performs revising 216 of knowledge/data 184 and returns control to the decision maker 186 for making 130 new tutoring decisions.

Optional improver 191 monitors success and faults of learning/tutoring together with corresponding beliefs used for decisions made 130. Then it increment those beliefs that supported successful decisions and decrement beliefs that caused fault tutoring decisions. More detail is provided hereinafter.

Such operating continues until the decision maker 186 (or the learner) decides to end tutoring. Concluding the tutoring session, the reporter 190 can provide 152 the tutoring report, end its operation and transfer control to evaluating step 106.

The Decision Maker

Environment.

The decision maker 186 is a part of the generator engine 181 providing main tutoring decisions {t} in real time of the learning process.

Parameters:

It is indirectly customized by the administrative assignment available in knowledge/data model 180 including identifiers of the learner (l), instructional unit (u) and tutoring parameters which in its turn includes at a minimum: the tutoring manner to begin with (passive or active), supply threshold (IT), testing threshold (TT), and diagnosing threshold (DT).

Functions.

The decision maker 186 processes the knowledge/data model 180 and provides the media-logic converter 142 with the following decisions {t} to realize in the media environment: 143:
a) decisions to begin or end tutoring process with assigning corresponding introduction or summary of the session through the comment channel;
b) achievement decisions {v} with assigning corresponding comments through the comment channel;
c) manner decisions (passive or active) with assigning corresponding comments through the comment channel;
d) inode decisions (supply, testing or diagnosing) with assigning corresponding comments through the comment channel;
e) assignment decisions {i} to provide the learner with specific learning situations {s} through the situation/response channel.

In the active manner of tutoring, it can accept desired type of tutoring assignments chosen by the learner through the control channel.

Composition.

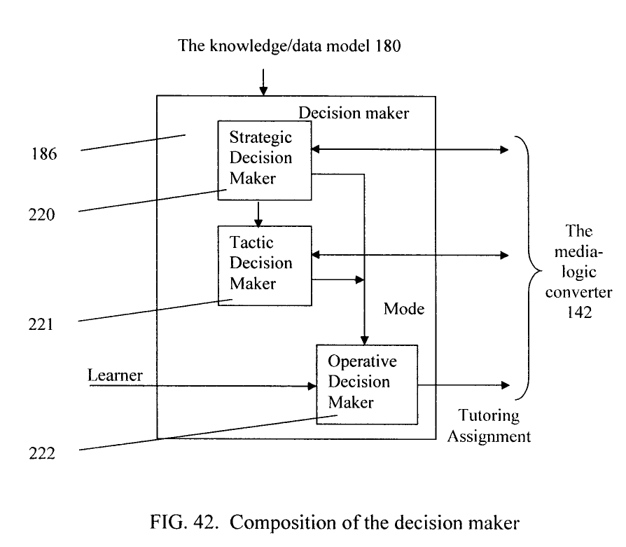

The decision maker 186 has an external input from the knowledge/data model 180 and internally comprises interconnected strategic 220, tactic 221 and operative 222 decision makers. See FIG. 42. An output of the strategic decision maker 220 is connected with an input of the tactic decision maker 221. Another output of the strategic decision maker 220 and an output of the tactic decision maker 221 are connected with an input of operative decision maker 222. The operative decision maker 222 has an external output to the controller 164 of the media-logic converter 142 and another external input for the learner's control actions mediated with the control channel. Decision makers 220 and 221 have two-directional external connections with media-logic converter 142. Strategic decision maker 220 has also external connections with the reviser 189 and reporter 190 not shown in FIG. 42.

Operation.

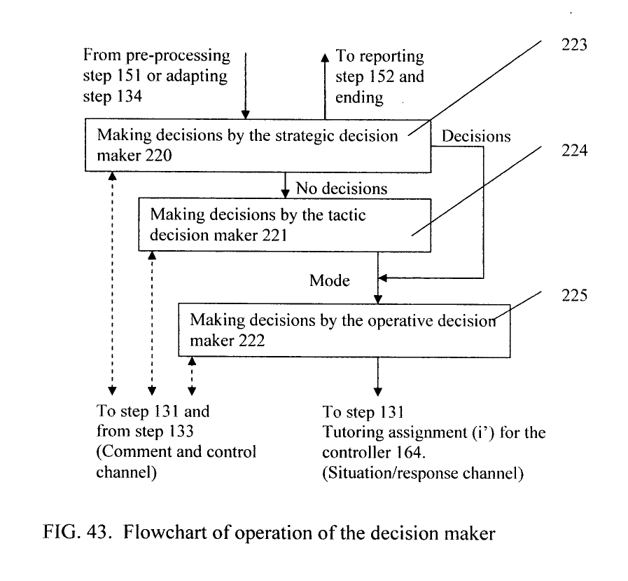

The decision maker 186 can start its operation at any time when the knowledge/data model 180 is ready. Particularly, it can take control from preprocessing step 151 or adapting step 134. The flowchart of its operating is depicted in FIG. 43.

First the strategic decision maker 220 analyses current knowledge/data 180 trying to identify typical cases among the approved achievement states and, in case of success, makes 223 corresponding achievement decisions. Decisions made can be commented for the learner by the tutoring persona 161 through the comment channel, which returns control to the strategic decision maker 220 again to continue its operation 223. Learner can participate in strategic decision making through the control channel by ending the session.

Particularly, the strategic decision maker 220 decides when to end tutoring. If it is the case, then it can optionally command the reporter 190 to provide 152 the administrator with the tutoring report. In case of diagnostic decisions, the strategic decision maker 220 transfers control to the reviser 189 and gets it back when revising is completed. It is not shown in FIG. 43.

If the strategic decision maker 220 did not make any decisions, then control is transferred to the tactic decision maker 221, otherwise control is transferred to the operative decision maker 222.

The tactic decision maker 221 also analyzes the knowledge/data 180 trying to define 224 if there is a need to switch the current tutoring mode to another one. Decisions made by the tactic decision maker 221 can be commented for the learner in media environment 143 by the tutoring persona 161 through the comment channel returning control to the tactic decision maker 221 again. In any case, was the decision made or not, an output of the tactic decision maker 221 is the current tutoring mode and control is transferred to the operative decision maker 222.

In active tutoring manner, the operative decision maker 222 analyses the knowledge/data 180 taking into account the current mode and selects the next tutoring assignment (i′) to realize 131 by the controller 164 in the media environment 143 for the learner through the situation/response channel. It also can share this decision making process with the learner by pre-selecting possible assignments for learner's final choice, mediated through the control channel of media environment 143.

In passive tutoring manner, the operative decision maker 222 skips its operation letting the domain 160 or the learner define the next learning situation.

The Strategic Decision Maker

Environment.

The strategic decision maker 220 is a part of the decision maker 186.

Parameters:

It is customized by the same administrative assignment available in knowledge/data model 180 including identifiers of the learner (l), instructional unit (u) and tutoring parameters, which in turn includes at a minimum: supply threshold (IT), testing threshold (TT), and diagnosing threshold (DT).

Function.

The strategic decision maker 220 analyses current knowledge/data model 180 trying to identify approved achievement states of the learning objectives and typical cases among them. In case of success it makes corresponding achievement {v} decisions. The learner can participate in decision making process as well through the control channel of communication.

Data to analyze include:
a) Supplied achievement beliefs SAB(j),
b) Demonstrated achievement beliefs DAB(j),
c) No-achievement beliefs NAB(j),
d) The supply threshold, ST,
e) The testing threshold, TT,
i) The diagnosing threshold, DT.

Achievement states to identify:
a) approved demonstrated achievement state, ADAS;
b) approved supplied achievement state, ASAS, and
c) approved no-achievement state, ANAS.

Typical cases to identify:
a) All objectives are in the approved demonstrated achievement state.
b) At least one terminal objective transits into the approved demonstrated achievement state.
c) All objectives are in the approved supplied achievement state.
d) At least one terminal objective transits into the approved supplied achievement state.
e) At least one learning objective (j) transits into the approved non-achievement state, a diagnosis case.
f) All objectives are in the initial state (all beliefs are zero, it is a baseline state).

Tutoring decisions to make:
a) End tutoring;
b) Assign the reporter 190 to generate the tutoring report;
c) Praise a learner for progress;
d) Provide the learner with the summary;
e) Start testing mode and comment this decision;
f) Put diagnosis, inform the learner about diagnosed learning objective;
g) Revise the learner state model (based on framework 214);
h) Provide the learner with the introduction;
i) Start supply mode and comment this decision.
   Composition.

The strategic decision maker includes at least three identifying rules 230-232, six decision rules 233-238, an assigner of the tutoring report, a switch to testing mode and a switch to supply mode.

Identifying rules 230-232 are not ordered and include the following:
a) Rule 230: If the demonstrated achievement belief DAB(j) is equal or exceeds said testing threshold (TT), then the objective (j) is in the approved demonstrated achievement state;
b) Rule 231: If the supplied achievement belief SAB(j) is equal or exceeds said supply threshold (ST), then the objective (j) is in the approved supplied achievement state;
c) Rule 232: If the no-achievement belief NAB(j) exceeds no-achievement beliefs NAB(h) of all other learning objectives {where h is not equal to j} by said diagnosing threshold (DT), then the objective (j) is in the approved no-achievement state.

Decision rules 233-238, which are arranged in a linear sequence, include:
a) Rule 233: If the approved demonstrated achievement state is identified for all (terminal) objectives {j}, then praise the learner providing the summary, assign reporter 190 to generate the tutoring report and end tutoring.
b) Rule 234: If the approved demonstrated achievement state is identified for the first time for at least one terminal objective (j), then praise the learner. This is an optional rule.
c) Rule 235: If the approved supplied achievement state is identified for all learning objectives {j}, then praise the learner and, in case of active manner, start the testing mode.
d) Rule 236: If the approved supplied achievement state is identified for the first the for at least one terminal objective (j), then praise a learner and, in case of active manner, start the testing mode. This is an optional rule.
e) Rule 237: If the approved non-achievement state is identified (a diagnosis is posed), then inform a learner about cause of his/her error(s) made, in case of passive manner, advise the learner to switch to active mode to remedy it, and in case of active manner, start revising 216.
f) Rule 238: If an initial state (all beliefs are zero) is identified for all objectives {j}, then provide the learner with an introduction to the unit of instruction and, in case of active manner, start the supply mode of tutoring.
   Operation.

The strategic decision maker 220 takes control from the preprocessing step 151 by the pre-processor 185 or from the adapting step 134 by the processor 187.

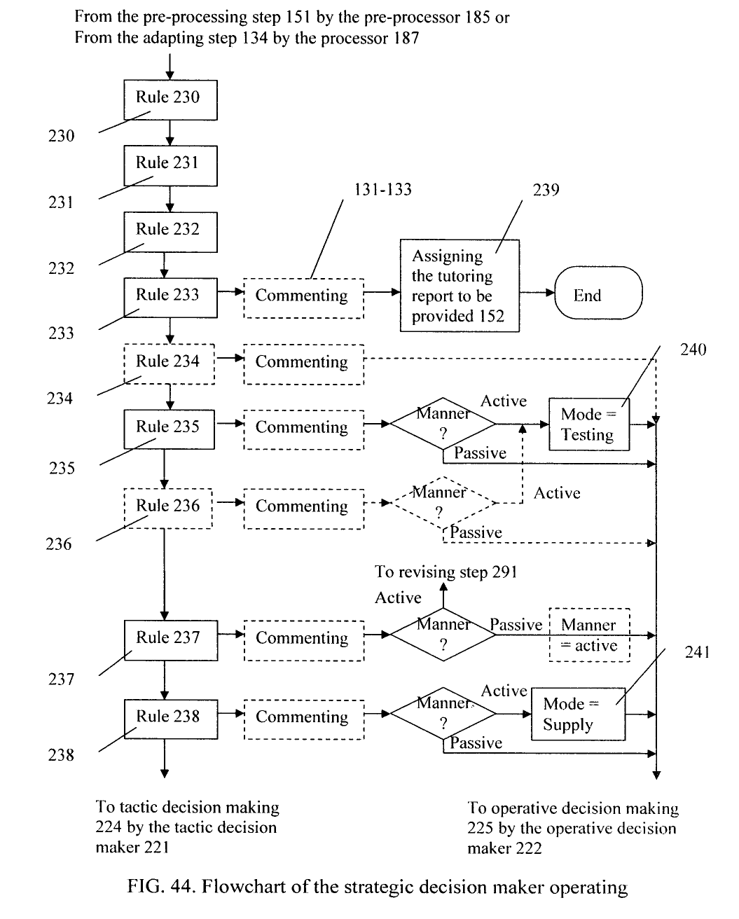

It analyses said data, identifies said approved achievement states, detects said typical cases, makes said decisions, assigns the reporter 190 to provide the tutoring report, and switches to testing 240 and supply 241 modes in active tutoring manner. The flowchart in FIG. 44 is self explanatory.

Concluding its operation, the strategic decision maker 220 transfers control to tactic decision making 224 by the tactic decision maker 221, if there was not: any strategic decision made. Otherwise it transfers control to operative decision making 225 by the operative decision maker 222.

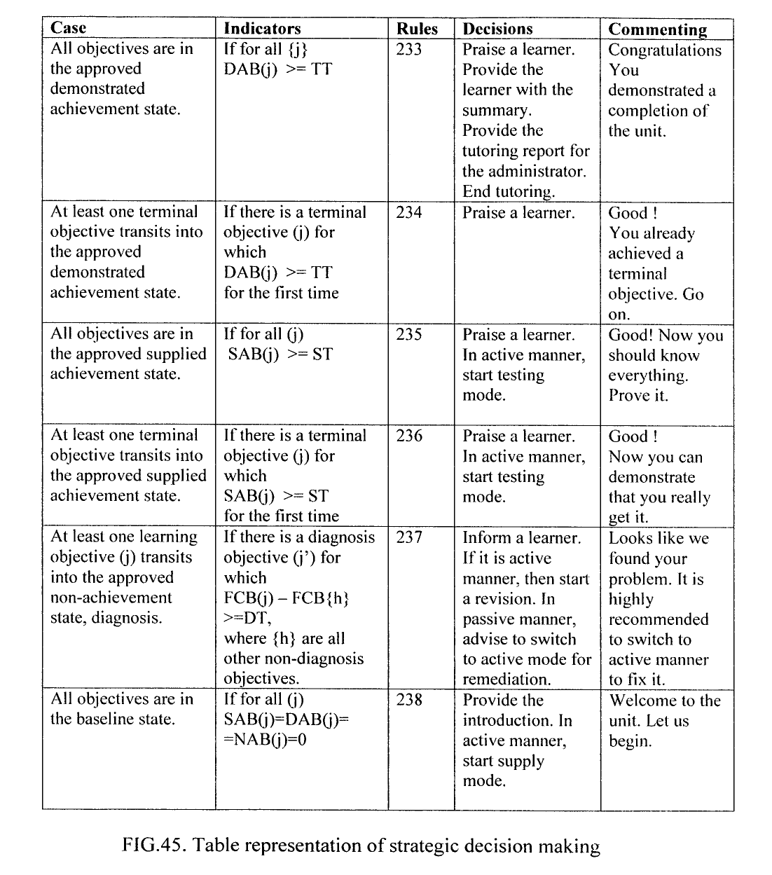

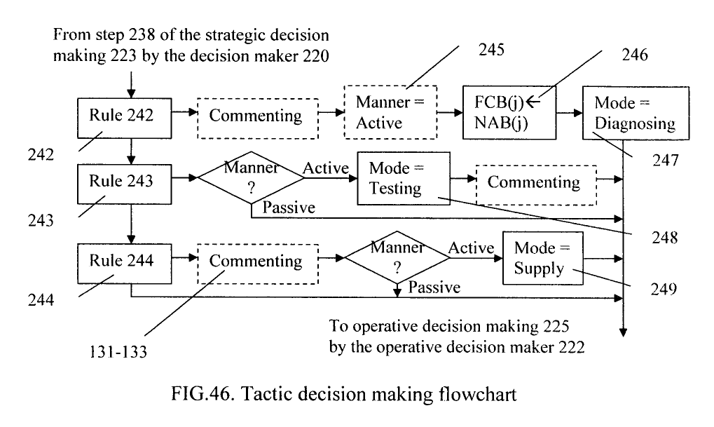

The table representation of strategic decision making with examples of possible commenting is given in FIG. 45.

The Tactic Decision Maker

Environment.

The tactic decision maker 221 is a part of the decision maker 186.

Parameters

It is indirectly customized by identifiers of the learner (l), instructional unit (u) and the tutoring parameters: the current tutoring manner (passive or active), supply threshold (IT), and testing threshold (TT).

Additionally, the tactic decision maker 221 takes into account the tolerance level TL and testing delay TD from the personal data framework 213.

Function.

In passive tutoring manner, the tactic decision maker 221 can automatically switch to a passive diagnosing mode to find causes of detected faults as well as offer the learner to switch to the active manner of tutoring for these faults remediation.

In active tutoring manner, it selects the current tutoring mode from a complete set of tutoring mode including supply, testing and diagnosing modes.

Data to analyze:
a) Supplied achievement beliefs SAB(j),
b) Demonstrated achievement beliefs DAB(j),
c) No-achievement beliefs NAB(j),
d) Supply threshold, ST,
e) Testing threshold, TT.

Typical cases to identify:
a) faults are not tolerable anymore;
b) local supply is sufficient;
c) local testing is sufficient.

Tutoring decisions to make:
a) Start diagnosing mode;
b) Start testing mode;
c) Start supply mode.
   Composition.

The tactic decision maker 221 includes three decisive rules 242-244 arranged in a linear order, optional switch 245 to the active manner, an initiator 246 of diagnosing data, and three mode switches 247-249.

Rule 242: If for all objectives {j} Sum of NAB(j)>=FTL, then offer the learner to switch to active manner and independently of his/her choice initiate diagnosing data and start diagnosing mode (in passive or active manner).

Rule 243: If number of objectives in the approved supplied state [where SAB(j)>=ST] exceeds a number of objectives in the approved demonstrated state [where DAB(j)>=TT] by testing delay parameter, TD, or more, then start testing mode.

Rule 244: If all objectives {j} in the approved supplied state (where SAB(j)>=ST) are also in the demonstrated achievement state (where DAB(j)>=TT), then start supply mode.

Operation.

The tactical decision maker 221 takes control from step 238 of the strategic decision making 223 by the strategic decision maker 220.

It analyses said data, identifies said typical cases, provides tactical decisions, which can be commented through the comment channel 131-133, and switches to diagnosing mode 247 in both passive and active manners, or to testing 248 or supply 249 modes in active manner of tutoring.

Concluding its operation, it transfer control to the operative decision making 225 by the operative decision maker 222.

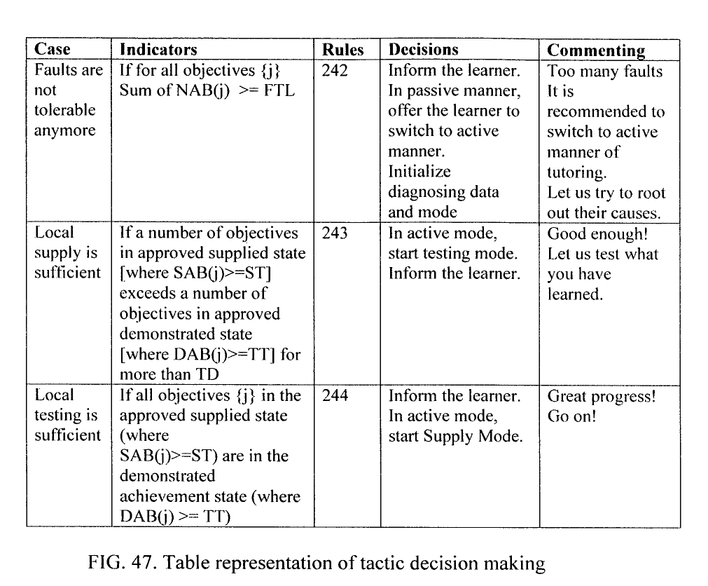

Table form of tactic decision making with examples of commenting is given in FIG. 47.

The Operative Decision Maker

Environment.

The operative decision maker 222 is a part of the decision maker 186.

Parameters

The operative decision maker 222 takes into account manner of tutoring and the learner personal data including requirements, preferences and the type of tutoring assignments chosen by the learner (multiple, rating, or single assignment) through the control channel.

Optionally the operative decision maker 222 can take into account author's opinions (script) on what to do next (when it is desirable to integrate several sequencing mechanisms).

Function

It can provide the following different types of tutoring assignments:
a) a single tutoring assignment (i) to create target learning situation (s) in the media environment 143 in order to initiate desired learning activity of the learner;
b) a multiple tutoring assignments [i] representing a subset of the whole set {i} of single tutoring assignments for a learner's personal choice of just one single assignment (i);
c) a rating tutoring assignment Weight [i] representing said multiple tutoring assignment [i] with single assignments rated (with Weight) by the engine 181 in accordance with their personal current utility for the learner.

Finally the operative decision maker 222 alone or in cooperation with the learner provides the media-logic converter 142 with the single tutoring assignment (i′) to realize in the media environment 143 through the situation/response channel.

By default, the operative decision maker 222 provides only single tutoring assignments.

Composition.

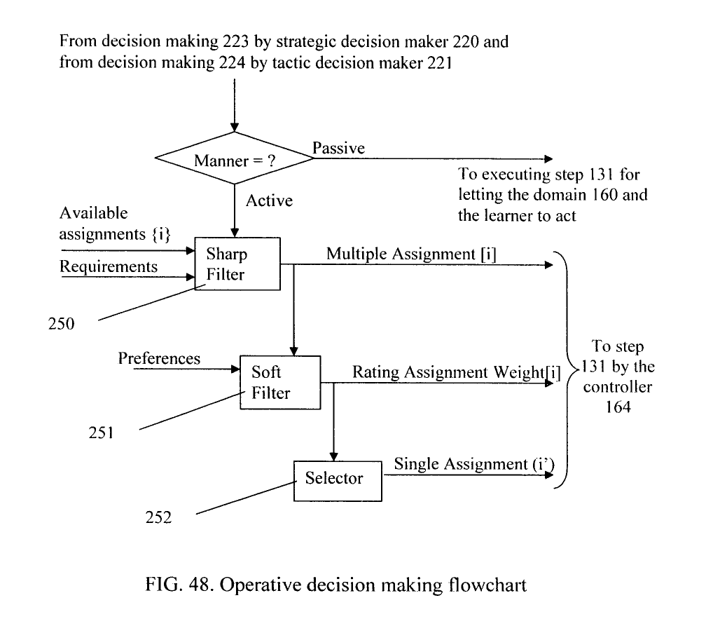

The operative decision maker 222 includes the following modules 250-252 connected in a sequence as it is shown in FIG. 48:
a) a sharp filter 250 generating said multiple tutoring assignment [i] for the following manual choice by the learner or automatic processing by the soft filter 251
b) a soft filter 251 generating said rating tutoring assignment Weight [i] for a manual choice by the learner or automatic selection by selector 252,
c) a selector 252 selecting the single tutoring assignment (i) for the learner if the learner did not do it yet by him/herself.
   Operation.

The operative decision maker 222 takes control from strategic decision maker 220 on step 223 and from tactic decision maker 221 on step 224.

In passive manner of tutoring, the operative decision maker 222 transfers control to the executing step 131 for learning domain 160 and the learner to act.

In active mode, depending of type of tutoring assignments chosen by the learner, the operative decision maker 222 activates only the sharp filter 250 for multiple assignments, or sharp 250 and soft 251 filters for rating assignments, or all three of them 250-251 for single assignments. They operate sequentially beginning from the sharp filter 250 taking into account learner requirements, through the soft filter 251 taking into account learner's preferences and ending with the selector 252. The learner can make his/her own choice on each step of this process. The result of filtering are transferred for the executing 131 to the controller 164. The final result of operative decision maker 222 and the learner cooperation is always the single assignment (i′). More detail follows hereinafter.

The Sharp Filter

Environment.

The sharp filter 250 is a part of the operative decision maker 222.

Function.

The sharp filter 250 works in active manner of tutoring only. It analyses available tutoring assignments {i}, rejects inappropriate candidates and by this way narrows a choice down to the multiple assignment [i] for the following soft filter 251 or the learner's consideration.

Input: The sharp filter 250 takes into account the following data:
a) Assignment properties including the implementation status, IS(i), see FIG. 30;
b) State-behavior relation (may be pre-processed), see FIG. 31;
c) Learner requirements, see FIG. 32;
d) Learner state model, see FIGS. 34, 35;
e) Current tutoring mode: supply, testing, or diagnosing;
f) Current Difficulty limit, DL;
g) Current Testing Delay, TD.

Output: a subset [i] of the available set {i} of tutoring assignments.

Composition.

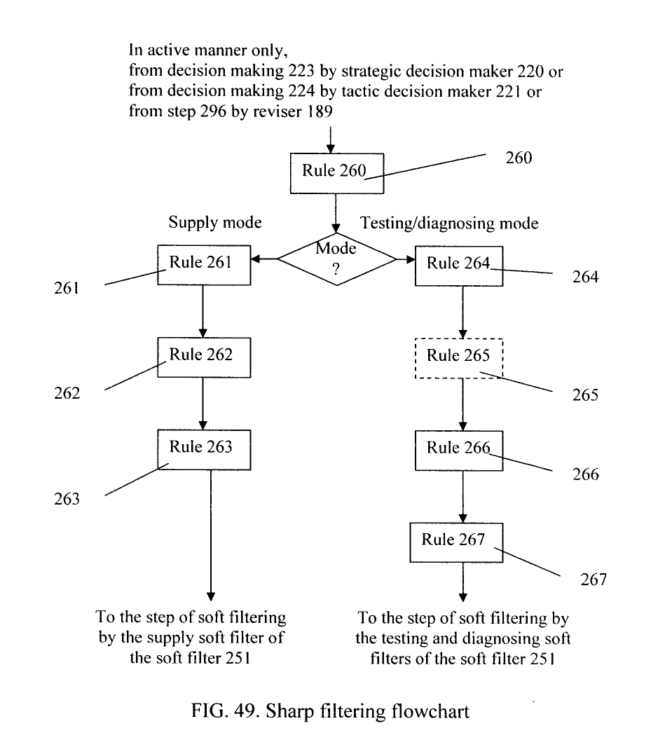

The sharp filter 250 includes eight rejecting rules 260-267 arranged in two mode-dependent branches as it is shown in FIG. 49. The first rule 260 is followed by linear sequence of rules 261-263 and a linear sequence of rules 264-267.

Operation.

The sharp filter 250 works in active tutoring manner only. The flowchart of its operation is illustrated in FIG. 49.

The operation is initiated from decision making 223 by strategic decision maker 220 or from decision making 224 by tactic decision maker 221 or from step 296 by reviser 189. Operating begins from the rule 260 rejecting too difficult candidate assignments, which difficulty level from assignment's data (see FIG. 30) exceeds the current difficulty limit (DL) of the learner from his/her learner model based on the framework 204;

Further operation is different for different tutoring modes (supply, testing and diagnosing).

In supply mode, the sharp filter considers all available assignments {i} (remaining after optional pre-processing) by default or only assignments specifically prescribed for this mode by the author (which is optional, see FIG. 30) and performs the following sequence of the rules 261-263:

Rule 261: rejecting not-grounded candidate assignments, which are grounded on at least one learning objective (j) in not yet supplied achievement state. In quantitative form, this rule looks like: if an assignment (i) has corresponding supplying background beliefs SBB(i,s,j)>0 on at least one learning objective (j), for which SAB(j)<ST, then this assignment (i) is definitely rejected. The optional less restrictive form of this rule uses the condition SAB(j)=0. Actually, there is an optional possibility to customize rejecting power of this rule by implementing a variable supply threshold (VST) for SAB(j) in a range: 0=<VST<ST.

Rule 262: rejecting overkill (too big for the learner) candidate assignments, which coverage of learning objectives that are not yet in said supplied achievement state exceeds testing delay unit, TDL. In quantitative form this rule is as follows: if in an assignment (i), sum of ILSB(i,s,j) for all objectives {j}, where SAB(j)<ST, is more than TDL, then assignment (i) is rejected. The optional less restrictive form of this rule uses the condition SAB(j)=0. There is also all optional possibility to customize rejecting power of this rule by implementing a variable supply threshold (VST) for SAB(j) in a range: 0=<VST<ST.

Rule 263: rejecting excessive candidate assignments, which are able to supply achievement of learning objectives only in already approved supplied achievement state. In quantitative form this rule looks like: if in an assignment (i), corresponding ILSB(i,s,j)>0 only on objectives, where SAB(j)>ST, then this assignment (i) is rejected. After completion, this rule transfers control to a supply sub-filter of the soft filter 251.

In testing and diagnosing modes, the sharp filter considers all available assignments {i} (remaining after optional pre-processing) by default or only assignments specifically prescribed for these modes by the author (which is optional, see FIG. 30) and performs the following learner sequence of the rules 264-267:

Rule 264 rejecting already implemented candidate assignments, which said implementation status has said “implemented” value, IS=1;

Rule 265 rejecting not-grounded candidate assignments, which are grounded on at least one learning objective (j) in not yet demonstrated achievement state. In quantitative form, this rule looks like: if an assignment (i) has corresponding demonstrating background beliefs DBB(i,s,j)]>0 on at least one learning objective (j), for which DAB(j)<TT, then this assignment (i) is rejected. The optional less restrictive form of this rule uses the condition DAB(j)=0. There is an optional possibility to customize rejecting power of this rule by implementing a variable testing threshold (VTT) for DAB(j) in a range: 0=<VTT<TT. This rule is optional to provide a specific “bottom-up” order of objective testing and diagnosing.

Rule 266 rejecting aside candidate assignments, which cover at least one learning objective (j) that is not yet: in said supplied achievement state. In quantitative form this rule looks as follows: if in an assignment (i) has ILDB(i,s,j)>0 on at least one learning objective (j) where SAB(j)<ST, then assignment (j) is rejected. The optional less restrictive form of this rule uses the condition SAB(j)=0. There is also an optional possibility to customize rejecting power of this rule by implementing a variable supply threshold (VST) for SAB(j) in a range: 0=<VST<ST.

Rule 267 rejecting excessive candidate assignments, which are able to test achievement of learning objectives only in already approved demonstrated achievement state. In quantitative form this rule looks like: if an assignment (i) has ILDB(i,s,j)>0 only on objectives where DAB(j)>TT, then this assignment (i) is rejected. After completion, this rule transfers control to testing and diagnosing soft-filters of the soft filter 251.

The Soft Filter

Environment.

The soft filter 251 is a part of the operative decision maker 222.

Function.

It analyses assignment candidates [i] remained after the sharp filter 250, rates them in accordance with their current utility for the learner providing the following selector 252 or the learner with a decisive basis to select the best possible assignment.

Input: The soft filter takes into account the following data:
a) Assignment properties (see FIG. 30) including:
b) Properties mapping learner preferences,
c) Implementation status, IS(i).
d) type of tutoring assignment selected by the learner through the control channel (multiple, rating, or single);
e) Current tutoring mode: supply, testing, or diagnosing;
i) Learner's preferences, see FIG. 33;
g) Current Difficulty limit of the learner, DL, from the personal data framework 213;
h) State-behavior relation (may be pre-processed), see FIG. 31;
i) Learner state model, see FIGS. 34, 35;

Output: a rated Weight [i] subset [i] of available tutoring assignments {i}.

Composition

Soft filter 251 includes three separate sub-filters: a supply soft-filter for supply mode, a testing soft-filter for testing mode, and diagnosing soft-filter for diagnosing mode.

Operation.

In supply mode,

the supply soft-filter uses the following data:
a) expected progress provided by each candidate assignment (i) and defined with integrated global supplying beliefs IGSB(i,s,j) on learning objectives {j} in said no-achievement state defined with said no-achievement beliefs NAB(j)>0;
b) expected progress provided by each candidate assignment (i) and defined with integrated global supplying beliefs IGSB(i,s,j) on learning objectives {j} in not yet supplied achievement state defined with a complement to said supplied achievement beliefs [1-SAB(j)]>0;
c) current prospect through learning objectives {j} provided by previous assignments and quantitatively defined with P(j).
d) preferences of the learner, see FIG. 33;
e) Difficulty level DLE(i), see FIG. 30;
f) Implementation status, IS(i), see FIG. 30.

The supply soft-filter considers the following dependencies.

The more an assignment (i) can contribute to supplying no-achieved yet objectives, the better. In other words, the more IGSB(i,s,j) falls into NAB(j)>0, the more its weight should be. In simple preferred form, this dependence can be represented by the following mathematical expression:

$$Weight ( i ) is proportional to {\sum }_{j} IGSB ( i , s , j ) * NAB ( j ) .$$

The more an assignment (i) can contribute to the learner's progress expectation, the better. In other words, the more IGSB(i,s,j) falls into not supplied yet objectives defined with [1-SAB(j)]>0, the more its weight should be. In simple preferred form, this dependence can be represented by the following mathematical expression:

$$Weight ( i ) is proportional to {\sum }_{j} IGSB ( i , s , j ) * [ 1 - SAB ( j ) ] .$$

The more an assignment (i) matches the prospect P(h) of learning supply provided by previous assignments, the more weight it should have. This rule prevents jumping aside from the current learning thread. In simple preferred form, this dependence can be represented by the following mathematical expression:

$$Weight ( i ) is proportional to {\sum }_{j} IGSB ( i , s , j ) * P ( j ) .$$

The more an assignment properties Prop(i,q) match personal preferences Pref(q) of the learner the more its weight should be. In simple preferred form, this dependence can be represented by the following mathematical expression:

$$Weight ( i ) is proportional to {\sum }_{q} Prop ( i , q ) * Pref ( q ) .$$

The higher difficulty level DLE(i) of an assignment within personal current difficulty limit, DL, the better.

Weight (i) is proportionial to DLE(i).

Not yet implemented assignment is better, than already implemented.

Weight (i) is less for implemented assignments by implementation status, IS(i).

In quantitative form, these (generally conflicting) dependencies can be compromised by the following formula:

$$Weight ( i ) = DLE ( i ) * {\sum }_{j} IGSB ( i , s , j ) * [ 1 - SAB ( j ) + NAB ( j ) ] * P ( j ) \} * {\sum }_{q} Prop ( i , q ) ** Pref ( q ) - IS ( i ) ;$$

which represents a simple preferred solution of the supply soft-filter.

This expression is open for further customizing and fine tuning.

In testing mode,
the testing soft-filter weights each assignment (i) characterized by the ILDB(i,s,j) in accordance with its expected coverage of learning objectives in the supplied achievement state defined with SAB(j)>0 but not yet in said demonstrated achievement state defined with a complement to DAB(j)>0. Relevant dependencies look like follows:

The more the testing assignment (i) covers supplied learning objectives defined with SAB(j)>0, the better. In other words, the more ILDB(i,s,j)>0 covers SAB(j)>0, the more weight it should have.

The more the testing assignment (i) covers untested or ill-tested learning objectives, the better. In other words, the more ILDB(j)>0 covers [1-DAB(j)]>0, the more weight it should have.

The more the testing assignment (i) matches the prospect P(j) of previous supplying assignments, the more weight it should have. This dependency prevents jumping aside of testing thread, but is optional.

(4) The higher difficulty level, DLE(i), of an assignment within personal current difficulty limit. DL, the better.

Weight (i) is proportional to DLE(i).

In quantitative form, these (in general, conflicting) rules can be compromised by the following formula:

$$Weight ( i ) = DLE ( i ) * {\sum }_{j} ILDB ( i , s , j ) * SAB ( j ) * [ 1 - DAB ( j ) ] * P ( j ) ,$$

which represents a single preferred solution of the testing soft-filter.

This expression is open for further customizing and fine tuning).

In diagnosing mode,
the diagnosing soft-filter weights each assignment (i) characterized at least by global demonstrating beliefs GDB(i,s,k,j) and optionally with said global fault beliefs GFB(i,s,k,j) in accordance with its ability to differentiate a set of fault causing objectives defined with a fault cause beliefs FCB(j) into more subsets of equal size. It is known from Information Theory, that such method insures the most effective diagnosing procedure.

The more the diagnosing assignment (i) is able to differentiate Suspected fault causes defined by FCB(j), the more weight it should have

In quantitative form, this dependency can be expressed by the following formula, which represents a preferred solution of the diagnosing soft-filter:

$$Weight ( i ) = {\sum }_{q} {\sum }_{j} {\sum }_{h = j + 1} \vert MN ( i , s , q , j ) - MN ( i , s , q , h ) \vert * FCB ( j ) * FCB ( h ) ;$$

Where MN(i,s,q,j) and MN(i,s,q,h) represent pre-processed global demonstrating beliefs GDB(i,s,k,j) and global fault beliefs GFB(i,s,k,j). See FIGS. 38 and 39.

Note that if for some reasons, such as a customer's wish, it is desired to use several sequencing engines in parallel, then their different selections from the same set of possible assignments can be compromised by the soft filter in the same manner.

Indeed, if each local engine provides its own subset of the same set {i} of assignments with local weight(i), then a compromise decision can be made by any standard voting procedure, for example, by summing weight(i) from different engines for each (i).

The Selector

The Selector 252 is a part or operative decision maker 222. In preferred simplest form, it selects the leading assignment candidate N with maximal weight Weight[i], (if the learner did not do it yet):
i′=Argument Max Weight,
where [i] is a subset of initial set {i} of assignments pre-selected by the sharp filter 250.

Other possible embodiments of the selector 252 can require a certain degree of leadership (like leading by more than X-number of points) or certain confidence in leadership (like confidence level should exceed certain limit). However, in order to satisfy high requirements, the tutoring engine requires a larger pool of assignments, which design and development are labor consuming.

The Updater

Environment.

The updater 188 is a part of the data processor 187.

Parameters:

Functioning of the updater 188 is defined with the following parameters:
a) Tutoring learner (passive or active);
b) Tutoring mode (supply, testing, or diagnosing);
c) Customizable adaptation coefficients (INC and DEC) defining a desired speed of adaptation process.
   Function.

The updater 188 automates very complex “intelligent” function of human tutors “to under stand” what is going on with learning/tutoring of the learner. To make it possible, it accepts learning reports (i′,s′,k′) from the step 133 performed by the monitor 165, interprets them into said learning state space model using said state-behavior relation, and updates current beliefs of the learner state model.

Initial data (in case of the first use of the instructional unit by the learner) include:
a) no-achievement beliefs NAB(j)=0;
b) supplied achievement beliefs SAB(j)=0;
c) demonstrated achievement beliefs DAB(j)=0;
d) the tutoring prospect P(j)=0;
e) the difficulty limit (DL) from the learner personal data. Default DL=2;
f) the testing delay limit (TDL) from the learner personal data. Default TDL=3,
g) the fault tolerance limit FTL from the learner personal data. Default value is one (0.3):
h) FCB(j)=NAB(j).
   Input:
a),earning behavior report including
   1. assignment identifier (i′),
   2. situation identifier (s′) and
   3. response identifier (k′);
b) Beliefs of the state-behavior relation: LDB(i,s,k,j), LSB(i,s,k,j) and LFB(i,s,k,j), may be pre-processed;

Outcome:
a) Current beliefs of the learner state model: DAB(j), SAB(j), NAB(j), P(j);
b) current difficulty limit (DL);
c) current testing delay limit (TDL).
   Composition

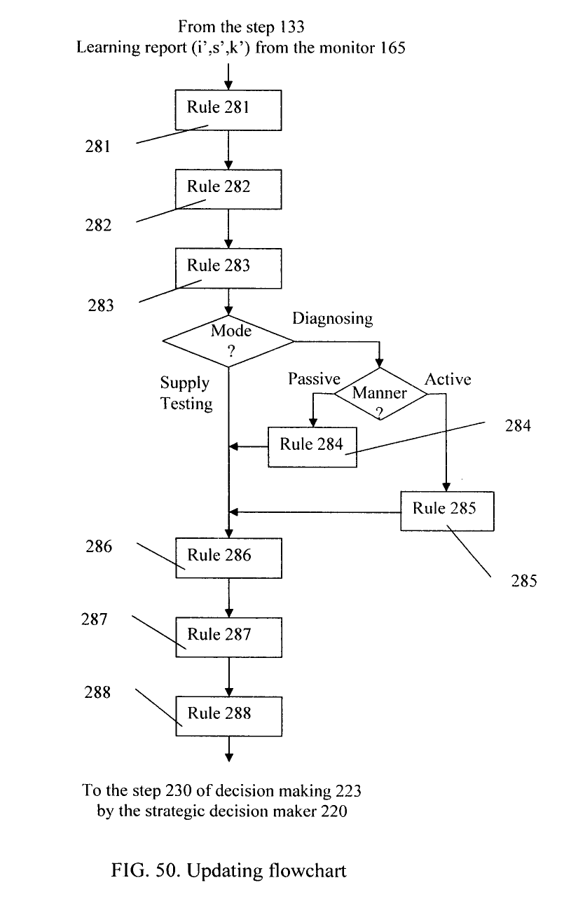

The updater 188 comprises eight updating rules 281-288. Rules 281-283 and 286-288 are arranged in a linear order. The gap between rules 283 and 286 is filled with rule 284 in case of passive diagnosing mode, and with rule 285 in case of active diagnosing mode. The composition of the updater is illustrated in FIG. 50.

Operating.

Operating of the updater 188 is initiated with the learning report (i′, s′,k′) from the step 133 performed by the monitor 165.

In both passive and active tutoring manners, the updater accepts the learning report (i′,s′,k′) from the monitor 165, then it retrieves a corresponding part of state-behavior relation and uses these data to update current beliefs of the learner state model. An entire updating procedure includes the following steps executed by corresponding rules:

Rule 281: said demonstrated achievement beliefs DAB(j) from the learning state model is combined with the local demonstrating beliefs IDB(i′,s′,k′,j) from the part of the state-behavior relation corresponding to the tutoring assignment (i′), identified situation (s′) and response (k′) from said learning report and considered as the DAB(j) again. In case of unexpected response identified with k′=K+1, IDB(i′,s′,k′=K+1,j)=0. In quantitative preferred form, this step represents the following iteration:
DAB(j)←DAB(j)+LDB(i′,s′,k′,j)−DAB(j)*LDB(i′,s′,k′,j).

Rule 282: said supplied achievement belief SAB(j) from the learning state model is combined with the local supplying belief LSB(i′,s′,k′,j) from the part of the state-behavior relation corresponding to the tutoring assignment (i′), identified situation (s′) and response (k′) from said learning report. Then the result of combining is compared with the DAB(i) and the highest value is considered as the SAB(j) again. In case of unexpected response identified with k′=K+1, LSB(i′,s′,k′=K+1,j)=0.

In quantitative preferred form, this step looks like the following iteration step:
SAB(j)←Max{DAB(j), [SAB(j)+LSB(i′,s′,k′,j)−SAB(j)*LSB(i′,s′,k′,j)]}.

Rule 283: said no-achievement belief NAB(j) from the learning state model is combined with the global fault belief GFB(i′,s′,k′,j) representing the preprocessed part of the state-behavior relation corresponding to the tutoring assignment (i′), identified situation (s′) and response (k′) from said learning report. Then the result of combining is compared with a complement to the DAB(j) and the lowest value is considered as the NAB(j) again. In case of unexpected response identified with k′=K+1, said global fault beliefs GFB(i′,s′,k′=K+1,j)=IGDB(i′,s′₄).

In quantitative preferred form, this step looks like the following iteration:
NAB(j)←Min{[1−DAB(j)], [NAB(j)+GFB(i′,s′,k′,j)−NAB(j)*GFB(i′,s′,k′,j)]}.

Rule 284: in case of said diagnosing mode of passive tutoring manner, said fault cause beliefs FCB(j), which prior to said diagnosing mode were equal to the no-achievement beliefs NAB(j) are summed with said global fault beliefs GFB(i′,s′,k′,j) from the preprocessed part of the state-behavior relation corresponding to the tutoring assignment (i′), identified situation (s′) and response (k′) from said learning report. Then the sum is compared with a complement: to the DAB(j) and the lowest value is considered as the FCB(j) again. In case of unexpected response identified with k′=K+1, GFB(i′,s′,k′=K+1,j)=IGDB(i′,s′,j).

In quantitative preferred form, this step looks like the following iteration:
FCB(j)←Min{[1−DAB(j)], [FCB(j)+GFB(i′,s′,k′,j)]}.

Rule 285: in case of said diagnosing mode of active tutoring manner, said fault cause beliefs FCB(j), which prior to said diagnosing mode were equal to the no-achievement beliefs NAB(j), are intersected with said global fault beliefs GFB(i′,s′,k′,j) from the preprocessed part of the state-behavior relation corresponding to the tutoring assignment (i′), identified situation (s′) and response (k′) from said learning report. Then the result of intersecting is compared with a complement to the DAB(j) and the lowest value is considered as the FCB(j) again. In case of unexpected response identified with k′=K+1, GFB(i′,s′,k′=K+1,j)=IGDB(i,s,j).

In quantitative preferred form, this step looks like the following iteration:
FCB(j)←Min{[1−DAB(j)],FCB(j)*GFB(i′,s′,k′,j)}.

Rule 286: said tutoring prospect P(j) from the learning state model is combined with global supplying beliefs GSB(i′,s′,k′,j) from the preprocessed part of the state-behavior relation corresponding to the tutoring assignment (i′), identified situation (s′) and response (k′) from said learning report and considered as the said tutoring prospect P(j) again. In case of unexpected response identified with k′=K+1, said global supplying beliefs GSB(i′,s′,k′=K+1,j)=0. In order to emphasize the last supply, this combination should take into account the latest values of GSB(i′,s′,k′,j) with higher weight and gradually fade off old ones. In preferred simple embodiment, a quantitative form of this rule looks like the following iteration:
P(j)←[P(j)+GSB(i′,s′,k′,j)]/2;
Rule 287: incrementing the current value of personal difficulty limit DL in accordance with a last increment of DAB(j) and decrementing said DL in accordance with a last increment of NAB(j). In preferred simple embodiment, a quantitative form of this rule looks like the following iteration:

$$DL ← Max \{ 1 , DL + INC * {\sum }_{j} [ DAB ( j ) - {DAB ( j )}^{′} ] - DEC * {\sum }_{j} [ NAB ( j ) - {NAB ( j )}^{′} ] \} ,$$

Where:
DL is automatically kept>=1;
INC is an incrementing coefficient;
DEC is a decrementing coefficient. Recommended INC=DEC=1/J:
J is a number of learning objectives in an instructional unit;
DAB(j)′ and NAB(j)′ are corresponding DAB(j) and NAB(j) from the previous cycle of updating.

Rule 288: incrementing the current value of testing delay limit TDL in accordance with the last increment of DAB(j) and decrementing said TD in accordance with the last increment of NAB(j). In preferred simple embodiment, a quantitative form of this rule looks like the following iteration:

$$TDL ← Max \{ 1 , TDL + INC * {\sum }_{j} [ DAB ( j ) - {DAB ( j )}^{′} ] - DEC * {\sum }_{j} [ NAB ( j ) - {NAB ( j )}^{′} ] \} ,$$

Where:
TDL is automatically kept>=1;
INC is an increment coefficient;
DEC is a decrement coefficient. Recommended INC=DEC═1/J;
J is a number of learning objectives in an instructional unit;
DAB(j)′ and NAB(j)′ are corresponding DAB(j) and NAB(j) from the previous cycle of updating.

After completion, the rule 288 transfers control to the step 230 of decision making 223 performed by the strategic decision maker 220.

Uncertain Identification of Behavior

Sometimes, the monitor 165 cannot identify the learning behavior (i,s,k) exactly but with uncertainty.

In this generic case, the monitor 165 can provide the tutoring generator 141 wraith behavior reports which instead of just (k′) includes beliefs RB(k) defining likelihood of actual response of the learner to each expected response (k) from said plurality of expected responses (k=1,2, . . .K) plus one unexpected response (K+1).

Actually, the same is fair for situation (s) identification. But in tutoring practice, the learning situation(s) can be determined by assigning specific learning resource (r) which is a common practice, while response (k) cannot be determined because of unpredictability, of the learner. That is why the most practical interest represents behavior reports such as (i′, s′, RB(k)).

In this case, described updating method realized by the updater 188 can be performed separately for each response (k), for which corresponding RB(k)>0 as it has been described above. Then each separate results DAB(j,k), SAB(j,k), NAB(j,k), FCB(j,k), and P(j,k) depending of (k) should be integrated together by calculating their Mean value across all {k} with corresponding weight of RB(k):
In rule 281, the DAB(j) in right side of equation should be replaced with

$$DAB ( j ) = {\sum }_{k = 1}^{K + 1} DAB ( j , k ) * RB ( k ) / ( 1 + K ) ;$$
In rule 282, the SAB(j) in right side of equation should be replaced with

$$SAB ( j ) = {\sum }_{k = 1}^{K + 1} SAB ( j , k ) * RB ( k ) / ( 1 + K ) ;$$
In rule 283, the NAB(j) in right side of equation should be replaced with

$$NAB ( j ) = {\sum }_{k = 1}^{K + 1} NAB ( j , k ) * RB ( k ) / ( 1 + K ) ;$$
In rule 284, 285, the FCB(j) in right side of equation should be replaced with

$$FCB ( j ) = {\sum }_{k = 1}^{K + 1} FCB ( j , k ) * RB ( k ) / ( 1 + K ) ;$$
In rule 286, the P(j) in right side of equation should be replaced with

$$P ( j ) = {\sum }_{k = 1}^{K + 1} P ( j , k ) * RB ( k ) / ( 1 + K ) ;$$
Described use of learning reports with uncertainty (i′, s′, RB(k)) can be easily extended up to (i′, SB(s), RB(k)) or even (AB(i), SB(s), RB(k)), where SB(s) and AB(i) denotes correspondingly situational beliefs and assignment beliefs.
   The Reviser
   Environment.

The reviser 189 is a part of the data processor 187.

Function.

The reviser 189 revises the learner state model, if the approved no-achievement state (diagnosis) is identified for a learning objective.

Input:
a) supplied achievement beliefs SAB(j);
b) demonstrated achievement beliefs DAB(j);
c) tutoring prospect P(j);
d) global succeed beliefs GSCB(j,h);
e) personal difficulty limit, DL;
f) personal testing delay limit, TDL,

Outcome:
a) revised learner state model;
b) personal difficulty limit, DL;
c) personal testing delay limit, TDL,
   Composition.

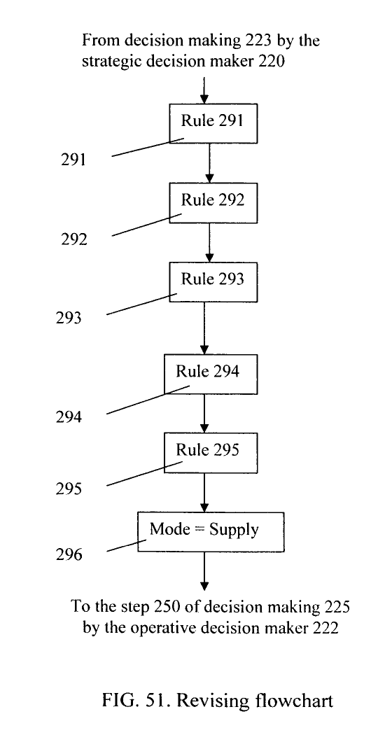

The reviser 189 comprises five revising rules 291-295 and a mode switch 296 arranged in linear order. See FIG. 51.

Operation.

Operating the reviser 189 starts from decision making 223 performed by the strategic decision maker 220 and represents a linear step by step execution of the rules 291-295 and switch 296 as it illustrated in FIG. 51.

Rule 291: setting up said supplied achievement belief SAB(j′) and demonstrated achievement belief DAB(j′) of the diagnosed objective (j′) to zero, SAB(j′)=DAB(j′)=0;

Rule 292: revising said supplied achievement belief SAB(j) and demonstrated achievement belief DAB(j) of all other (no j′) learning objectives {j} by their intersecting with a complement to the global succeed beliefs GSCB(j,j′) and considering result as said supplied achievement belief SAB(j) and demonstrated achievement belief DAB(j) again. In simple preferred form, it can be done by the following operations:
SAB(j)←SAB(j)*[1−GSCB(j,j′)],
DAB(j)←DAB(j)*[1−GSCB(j,j′)].

Rule 293: setting tip said tutoring prospect P(j) to start from the diagnosed objective (j′) by setting the h=j′ in said global succeed beliefs GSCB(j,h=j′) and considering it as a tutoring prospect P(j)=GSCB(j,h=j′);

Rule 294: setting up said difficulty limit DL to its minimum value, DL=1;

Rule 295: setting up said testing delay limit TDL to its minimum value, TDL=1.

Setting up the supply mode of active tutoring by the switch 296. Completing this rule initiates the step 250 of decision making 225 by the tactic decision maker 222.

Evaluating the Instructional Unit

Collecting personal learning histories provides an opportunity to analyze them and evaluate general efficiency of the instructional unit. The methods of general evaluating are known as summative evaluation. Analysis allows also detecting common learning problems, backtracking their possible causes and revealing what exactly to improve in the instructional unit. It is a formative evaluation. Both represent the optional evaluating 106 step of the tutoring method as shown in FIG. 2.

In addition to known summative, the formative evaluating 106 of the instructional unit may include the following steps:
a) accumulating problematic objective beliefs POB(j) of the learner in the instructional unit. POB(j) can be expressed, for example, by said fault cause beliefs FCB(j) or by number of diagnosis made per objective. It can be done, for example, by summing said fault cause beliefs FCB(j) in each updating cycle of the updater 188 with said POB(j) or by counting number of diagnosis made per objective (j) within each instructional unit. The latter is a preferred solution;
b) accumulating the personal problematic objective beliefs POB(j) across the entire audience. It can be done, for example, by summing the personal said problem objective beliefs POB(j) or by summing personal number of diagnosis made per objective (j) for all learners from the target audience;
c) Inference of problematic assignment beliefs PAB(i,s) for each assignment (i) and learning situation (s). It can be done by standard operation of linear production of said problematic objective beliefs POB(j) with the integrated local supplying beliefs ILSB(i,s,j) and the integrated local demonstrating beliefs ILDB(i,s,j):
1. Problematic assignment beliefs for supply PABS(i,s)=

$${\sum }_{j = 1}^{J} POB ( j ) * ILSB ( i , s , j ) ;$$
2. Problematic assignment beliefs for testing PABT(i,s)=

$${\sum }_{j = 1}^{J} POB ( j ) * ILDB ( i , s , j ) ;$$
d) Providing authors with advices to fix specific tutoring assignments [i] and specific learning situations [s] according to the value of said problematic assignment beliefs for supply PABS(i,s) and for testing PABS(i,s). The assignment with the maximal value is advised to be fixed first.
   Composition.

Evaluating 106 is performed by the improver 191 including
a) Means to accumulate said personal and audience problematic objective beliefs POB(j) during learning process within each specific instructional unit.
b) Means to perform inference of problem assignment beliefs PABS(i,s) and PABT(i,s) for the tutoring report extended with these data by demand;
c) Means to provide advises to the authors in an appropriate media form.

After this evaluation 106, the following improving 107 step performed by authors manually is supposed to improve the media 143 and the logic 184, which include beliefs LSB(i,s,k,j) and LDB(i,s,k,j).

Automatic Improving the Logic of the Instructional Unit

During normal course of operating with learners from the target audience, the generator 141 is able to improve its specific knowledge/data 184 within the instructional unlit by automatic performing the optional steps 106-107 of the outer tutoring loop as illustrated in FIG. 2.

The automatic improving is based on the following generic rules:

Rule A: if achievement of certain objective was successful, then it is rather due to the fact that
a) tutoring supply was proper;
b) testing of used background was proper.
c) Thus implemented supply and demonstrating beliefs can be incremented;

Rule B: if learning was unsuccessful, but diagnosed, re-supplied and tested successfully, then it is rather due to the fact that
a) tutoring supply of diagnosed objective was improper;
b) diagnosis was proper;
c) Thus supply beliefs implemented for diagnosed objective can be decremented and
d) fault beliefs implemented for the correct diagnosis can be incremented,

Rule C: if learning was unsuccessful, and diagnosed, re-supplied and tested unsuccessfully again, then it is rather due to the fact that diagnosis was incorrect.
a) Thus implemented for the incorrect diagnosis fault beliefs can be decrement.

Automatic evaluating 106 and improving 107 extends the whole operational cycle of the tutoring generator 141 with the couple of outer steps. The automatically performed steps 106-107 can be aggregated in one step 217 of the generator operating and as it is demonstrated in FIG. 41 inserted between updating 215 and decision making 130 steps.

Automatic evaluating/improving 217 include the following steps:

In the beginning of each tutoring session, initializing the following memory registers:
a) Current supply register=empty;
b) Previous supply register=empty;
c) Pre-previous supply register=empty;
d) Current testing register=empty;
e) Previous testing register=empty;
f) Current diagnosing register=empty;
g) Previous diagnosing register=empty;
h) Previous DAB(j)′=0.

In normal course of tutoring 105, the improver 191 stores identifiers (i′,s′,k′) of implemented assignments, realized situations, and recognized responses in 3 following memory registers accordingly to the current mode:
a) Current supply register in supply mode;
b) Current testing register in testing mode.
c) Current diagnosing register in diagnosing mode;

In normal course of generator 141 operating, changing the current mode initiates the following operations:
a) if supply mode is stopped, then
   1. Previous supply register←Current supply register.
   2. Pre-previous supply register←Previous supply register;
b) if testing mode is stopped, then Previous testing register←Current testing resgister
c) if diagnosing mode is stopped, then Previous diagnosing register←Current diagnosing register;
d) Previous DAB(j)′←current DAB(j);

In normal course of generator 141 operating, checking: If tutoring was successful, which means that during testing/diagnosing mode, there is an objective (j′), for which [DAB(j′)−DAB(j′)′]>TT, then for this objective (j′):
a) incrementing LSB(i′,s′,k′,j′) and GSB(i′,s′,k′,j′) of all assignments/situations/responses (i′,s′,k′) from the previous supply register that properly supplied this achievement of this objective (j′):
   1. LSB(i′,s′,k′,j′)←LSB(i′,s′,k′,j′)+SPD*[1−LSB(i′,s′,k′,j′)];
   2. GSB(i′,s′,k′,j′)←GSB(i′,s′,k′,j′)+SPD*[1−GSB(i′,s′,k′,j′)];
b) incrementing LDB(i′,s′,k′ j) and GDB(i′,s′,k′,j) of all assignments/situations/responses (i′,s′,k′) from the previous testing register that properly confirmed the background GPRB(j,j′)>0 of this objective (j′):
   1. For all (j) where GPRB(j,j′)>0 do:
   2. LDB(i′,s′,k′,j)←LDB(i′,s′,k′,j)+SPD[1−LSB(i′,s′,k′,j)];
   3. GDB(i′,s′,k′,j)←GDB(i′,s′,k′,j)+SPD*[1−GSB(i′,s′,k′,j)];

In normal course of generator 141 operating, detecting if a diagnosis has been posed.

In normal course of generator 141 operating, specifically after diagnosing of objective (j′), revising 216, re-supplying and testing positively [DAB(j′)−DAB(j′)′]>TT,
a) incrementing GFB(i′,s′,k′,j′) of all assignments/situations/responses (i′,s′,k′) from the previous diagnosing register that correctly suspected this objective (j′):
   1. GFB(i′,s′,k′,j′)←LSB(i′,s′,k′,j′)−SPD*[1−GFB(i′,s′,k′,j′)];
b) decrementing LSB(i′,s′,k′,j′) and GSB(i′,s′,k′,j′) of all assignments/situations/responses (i′,s′,k′) from the pre-previous supply register that failed to supply this objective (j′):
   1. ISB(i′,s′,k′,j′)-77 (LSB(i′,s′,k′,j′)−SPD[1−LSB(i′,s′,k′,j′)];
   2. GSB(i′,s′,k′,j′)←GSB(i′,s′,k′,j′)−SPD*[1−GSB(i′,s′,k′,j′)];
c) decrementing LDB(i′,s′,k′,j′) and GDB(i′,s′,k′,j′) of all assignments/situations/responses (i′,s′,k′) from the previous testing register that improperly confirmed achievement of this objective (j′) prior to the current testing:
   1. LDB(i′,s′,k′,j′)←(LDB(i′,s′,k′,j′)−SPD*[1−LSB(i′,s′,k′,j′)];
   2. GDB(i′,s′,k′,j′)←GDB(i′,s′,k′,j′)−SPD*[1−GSB(i′,s′,k′,j′)];

In normal course of generator 141 operating, specifically after diagnosing of objective (j′), revising 216, supplying and testing negatively [DAB(j′)-DAB(j′)′]<1−TT.
a) decrementing GFB(i′,s′,k′,j′) of all assignments/situations/responses (i′,s′,k′) from the previous diagnosing register that may be incorrectly suspected this objective (j′);
b) GFB(i′,s′,k′,j′)←GFB(i′,s′,k′,j′)−SPD[1−GFB(i′,s′,k′,j′)];

Where

SPD is an adjustable speed of improvement with a range 0=<SPD=<1 and recommended default value SPD=0,01;

Composition.

The described method is performed by the improver 191 which has memory 182 registers:
a) Current supply register;
b) Previous supply register;
c) Pre-previous supply register;
d) Current testing register;
e) Previous testing register;
f) Current diagnosing register;
g) Previous diagnosing register;
h) Previous DAB(i′,s′,k′,j) register;
i) and a processor for performing described operations.

Note that this automatic improvement is supposed to change only logic not media of leaning resources.

In principle, the described procedure of self-improvement can be used in order to develop the logic by demonstration, not by its description even in such simplified form as filling in the frameworks. But it takes long time. That is why a preferred solution begins from prior manual authoring followed by the automatic self-improvement.

In Depth Description of the Tutoring Generator Operating

Now, after describing all details of the tutoring system 140 and the tutoring method 105 it is possible to detail the whole operating of the tutoring generator 141 (as it was illustrated in FIG. 22) in finest grains.

In passive manner, in each cycle of the tutoring, the tutoring generator 141 performs the following cycle of operations:
a) making 223 decisions by the strategic decision maker 220 (accompanied with corresponding comment messages through the comment channel).
   1. Particularly, the rule 233 decides: If the approved demonstrated achievement state is identified for all (terminal) objectives {j}, then praise the learner, provide a summary, assign 239 reporter 190 to generate the tutoring report and end tutoring.
   2. The rule 237 decides: if the approved no-achievement state of one of said plurality of learning objectives is identified (diagnosis), then commenting this case and advising the learner to switch to active manner for remedy diagnosed learning problem;
b) making 224 limited tactic decisions 242-247 by the tactic decision maker 221.
   1. Particularly, rule 242 decides: if sum of no-achievement beliefs NAB(j) ir all learning objectives {j} exceeds said fault tolerance limit (FTL), then it begins passive diagnosing mode by focusing its beliefs updating 284 oil a cause of detected faults starting from setting up the fault cause beliefs FCB(j) equal to current no-achievement beliefs NAB(j), FCB(j)=NAB(j);
c) obtaining said learning behavior report (i′,s′,k′) by the updater 188 from the monitor 165;
d) updating 281-288 said learner state model and personal data by the updater 188;
e) making 223 new tutoring decisions by the strategic decision maker 220.

In active tutoring manner, which can be administratively assigned manually by an administrator/instructor/learner or automatically selected by the tutoring generator 141 being in passive manner, the tutoring generator 141 dynamically switches 240, 241, 247-249 the current tutoring mode from the plurality of available (supply, testing and diagnosing) modes. Then within each mode it dynamically selects 260-267 multiple assignment [i] by sharp filter 250, rated assignment Weight[i] by soft filter 251 or single assignment by selector 252 for the learner by performing the following cycle of operations:
a) making 223 (including steps 230-241) decisions by the strategic decision maker 220.
   1. Particularly, the rule 233 decides: If the approved demonstrated achievement state is identified for all (terminal) objectives {j}, then praise the learner, provide a summary, assign 239 the reporter 190 to generate the tutoring report and end tutoring.
b) making 224 (including steps 242-249) decision by the tactic decision maker 221;
c) making 225 (including 250-252) decision by the operative decision maker 222;
d) obtaining the learning behavior report (i′,s′,k′) by the updater 188 from the monitor 165;
e) optional evaluating/improving 217 knowledge/data 184 by the improver 191;
f) updating 281-288 the knowledge/data 184 by the updater 188;
g) making 223 (including steps 230-241) new decisions by the strategic decision maker 220.
   The Big Picture of the Logic Generator Implementation

The big picture of the generator 141 implementation in tutoring design 100 and implementing 105 looks as follows:
a) Instructional unit design 100:
   1. Designing the logical learning space of the instructional unit by filling in the specific domain/task-specific data 184 into the uniform reusable framework 203;
   2. Automatic verification of entered logical data for consistency and sufficiency as it was described hereinbefore;
   3. Running the instructional unit by the tutoring engine 181 in provided logical learning space for its testing (evaluating 106) and debugging (improving 107) purposes prior to investing in developing any media yet. A reusable fake learning environment 143 and converter 142 should be constructed in advance in order to support this logical operation.
   4. Collecting 101 available and/or developing new media learning resources and their playback tools to realize desired learning situations to support desired learning activities;
   5. Assembling 104 a complete instructional unit including created logic (the learning space) and media (learning resources and tools);
   6. Optional publishing developed instructional unit for use in available administrative/management systems;
   7. Optional but recommended design of the learning model for each learner from the target audience by filling in the learner data framework 204 with personal requirements and preferences;
b) Optional administering:
   1. Identifying a specific instructional unit (u);
   2. Identifying the learner (l) and corresponding learner model;
   3. Providing tutoring generator 141 with the administrative assignment;
c) Tutoring session 105:
   1. unit data initialization and optional pre-processing by the tutoring engine 181;
   2. conducting a learning session by the entire tutoring system 140;
   3. providing tutoring report to an administrative level;

Described big picture explains developing new instructional units from scratch. Available instructional units can be upgraded as well by revealing a hidden logic behind available multimedia learning resources in order to fill in provided logical frameworks.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCES

Bloom, B. S. (1984) The 2 sigma problem: The search for methods of group instruction as effective as one-to-one tutoring. Educational Researcher, 13 (6):4-16, 1984.
Anderson, J. R., Corbett, A. T., Koedinger, K. R., & Pelletier, R. (1995). Cognitive Tutors: Lessons learned. The Journal of the learning Sciences, 4, 167-207.
Mislevy, R. J., & Gitomer, D. H. (1996). The role of probability-based inference in an intelligent tutoring system. User Modeling and User-Adapted Interaction 5 (3-4).
Goodkovsky, V. A. (1992). Intelligent Tutoring Systems: Theory, Technology, and Practice. In Proceeding of International “East-West” Conference on Emerging Computer Technologies in Education. Moscow, ICSTI, 1992.
Goodkovsky, V. A. (1993). Intelligent Tutoring Systems. From theory to practice. In Proceedings of the East-West conference on Artificial Intelligence (pp. 305-309). Moscow, Russia. 1993.
Goodkovsky, V. A. (1993). Practical Knowledge Diagnostics. Theoretical Systems Approach. In Proceedings of the International Conference on Computer Technologies in Education. (pp. 141-143). Kiev, Ukraine, 1993.
Goodkovsky, V. A. (1994). Intelligent Tutoring System: Theoretical Systems Approach. In Proceedings of Japan—CIS Symposium on Knowledge Based Software Engineering. (106-109). Pereslavl-Zalesskiy, Russia, 1994
Goodkovsky, V. A. (1997). “Intelligent Tutor”: Top-down Approach to Intelligent Tutoring System Design. Learning Technology Standards Committee (P1484)—Developing Technical Standards for Learning Technology. http://ltsc.ieee.org/archive/harvested-2003-10/miscellaneous/goodkov/goodkov.htm
Goodkovsky, V. A. (1997). Pop Class Intelligent Tutoring Systems: Shell, Toolkit & Design Technology. In book “New Media and Telematic technologies for Education in Eastern European Countries”. pp. 179-192, The Netherlands, Twente University Press, 1997.
Goodkovsky, V. A. (2000). Intelligent Tutoring System. U.S. Patent Application #20020107681, Kind A1, Aug. 8, 2002.
Woolf, B. P., Beck, J., Eliot, C., & Stern, M. (2001). Growth and maturity of intelligent tutoring systems: A status report, In K. D. Forbus & P. J. Feltovich (Eds.), Smart machines in education (pp. 100-144). Cambridge, Mass.: MIT Press.
Graesser A. C., Person, N. K., & Harter, D. (2001). Teaching tactics and dialog in autotutor. International Journal of Artificial Intelligence in Education, 12, 12-23.
Richard Stottler & Nancy Harmon (2003). An Intelligent Tutoring System (ITS) for Battlespace Geometry Tutoring. Interservice/Industry Training, Simulation, and Education Conference (I/ITSEC), 2003.
Bruce Mills. (2002) Using the Atlas Planning Engine to Drive an Intelligent Tutoring System: CIRCSIM-Tutor. Version 3. Proc. of the Fourteenth International Florida Artificial Intelligence Research Soc. Conf., Key West, Fla., May 2001, pp. 211-215.
Rob Hubal & Curry Guinn. A Mixed-Initiative Intelligent Tutoring Agent for Interaction Training.
Valerie Shute, et al. (1997). Automating Cognitive Task Analysis. Cognitive Technologies for Knowledge assessment symposium. AERA, Chicago, Ill., 1997.
Joseph M. Scandura (2003). Domain Specific Structural Analysis for Intelligent Tutoring Systems: Automatable Representation of Declarative, Procedural and Model-Based Knowledge with Relationship to Software Engineering. Tech., Inst., Cognition and Learning. Vol. 1, pp. 7-57.Old City Publishing Inc. 2003.
Brian P. Butz. Freedom of Choice in an Intelligent Tutoring System*Session 3630. Electrical and Computer Engineering Department. Temple University, Philadelphia, Pa. 19122
R. Charles Murray and Kurt VanLehn (2000). DT tutor: A decision-Theoretic, Dynamic Approach for Optimal selection of Tutorial Actions. In G. Gauthier, C. Frasson, and VanLehn (Ed.), Intelligent Tutoring systems, 5th International Conference, ITS 2000, pp. 153-162. New York: Springer.
A. Patel et al. An initial framework of contexts for designing usable intelligent tutoring systems. The contexts of intelligent tutoring systems 1.
Ashok Patel and Kinshluik. KNOWLEDGE CHARACTERISTICS: RECONSIDERING THE DESIGN OF INTELLIGENT TUTORING SYSTEMS.
Babbitt, et al. (2000). Intelligent flight tutoring system. U.S. Pat. No. 6,053,737 Apr. 25, 2000.
Sun-Teck Tan (1996) Architecture of a generic instructional planner. In Journal of Network and Computer Applications, 1996, 19, 265-274.
Jens O. Liegle and Han-Gyun Woo. Developing Adaptive Intelligent Tutoring Systems: A General Framework and Its Implementations.
Eman El-Sheikh and Jon Sticken. (1998). A framework for Developing Intelligent Tutoring Systems Incorporating Reusability. IEA-195-AIE: 11th International Conference on Industrial and Engineering Applications of Artificial Intelligence and Expert Systems, Benicassim, Catellon, Spain, Springer-Verlag (Lecture Notes in Artificial Intelligence, vol. 1415).
Dietrich Albert Cord Hockemeyer. (1997). Adaptive and Dynamic Hypertext tutoring Systems Based oil Knowledge Space Theory. http://wundt.kfunigraz.ac.at/rath/publications/aied-97/aied-97.html
Brusilovsky Peter (2003). Adaptive Navigation Support in Educational Hypermedia: The Role of Student Knowledge Level and the Case for Meta-Adaptation British Journal of Educational Technology, 34 (4), 486-497, 2003.

What I claim as my invention is:

1. a method of tutoring a learner including:
a) Providing a tutoring system including
1) providing a media environment for physical supporting at least one learning activity of said learner;
2) providing a unified tutoring logic generator for making a plurality of tutoring decisions;
3) providing a media-logic converter
a. for executing said tutoring decisions in said media environment to support said learning activity of said learner and
b. for providing said logic generator with at least one report about said learning activity in said media environment;
4) associating said logic generator with said media environment by said media-logic converter:
b) tutoring the learner with said tutoring system by controlling over said learning activity of said learner in said media environment with said logic generator through said logic-media converter whereby said method completely separates media and logic of tutoring, enables unified logic-based generating of a specific media-dependent tutoring process, simplifying authoring, improving quality of the tutoring process and accelerating learning success;

2. a method as in claim 1, wherein said providing a logic generator for making a plurality of tutoring decisions including
a) providing a unified knowledge/data model referenced to said learner and said leaning activity including
1) providing a memory for storing knowledge/data;
2) providing a unified reusable knowledge/data framework for representing specific knowledge/data in said memory;
3) providing said unified reusable knowledge/data framework with said specific knowledge/data;
b) providing a unified reusable tutoring engine including
1) providing a decision maker for making a plurality of tutoring decisions based upon said knowledge/data model;
2) providing a processor for adapting said knowledge/data model based upon at least one said learning, report about at least one said learning activity of at least one said learner:
c) associating said knowledge/data model with said tutoring engine;
whereby said method provides unified reusable components for building any specific tutoring system, excludes manual design of the tutoring process by authors, improves quality of said tutoring process and accelerates learning success;

3. a method as in claim 1, wherein said tutoring the learner with said tutoring system including
a) making tutoring decisions from said plurality of tutoring decisions by said decision maker based upon said unified knowledge/data model;
b) executing said tutoring decisions by said media-logic converter providing necessary control over said learning media environment;
c) supporting said learning activity of said learner by said media environment;
d) monitoring said learning activity and providing, said logic generator with at least one said report by said media-logic converter;
e) adapting said unified knowledge/data model by said processor including particularly updating said knowledge/data model based upon said report;
f) making new tutoring decisions from said plurality of tutoring decisions by said decision maker based upon adapted unified knowledge/data model;
whereby said method dynamically adapts said tutoring system, improves quality of said tutoring process and accelerates learning success;

4. a method as in claim 3, wherein said making tutoring decisions from said plurality of tutoring decisions including making a plurality of diagnostic decisions each revealing at least one cause of a fault behavior of said learner in said learning activity,
whereby said method enables focusing of the tutoring process on said cause of said fault behavior and corresponding acceleration of successful learning;

5. a method as in claim 4, wherein said adapting said knowledge/data model by said processor including revising said knowledge/data model based upon a diagnostic decision from said plurality of diagnosing decisions
whereby said method focuses the tutoring process on said cause of said fault behavior of said learner and accelerates successful learning;

6. a method as in claim 3, wherein said making tutoring decisions from said plurality of tutoring decisions by said decision maker including making a plurality of assignments from said plurality of tutoring decisions to said media environment through said media-logic converter to initiate respectively a plurality of extra learning activities of said learner,
whereby said method realizes an active manner of tutoring, eliminates prior manual sequencing of learning activities by authors, improves quality of sequencing and accelerates successful learning;

7. a method as in claim 6, wherein said making a plurality of assignments including
a) making an assignment from said plurality of assignments to supply progress of said learner;
b) making an assignment from said plurality of assignments to test progress of said learner and detect at least one fault behavior of said learner;
c) making an assignment from said plurality of assignments to diagnose at least one cause of said fault behavior of said learner,
whereby said tutoring method dynamically realizes supply, testing and diagnosing modes of active tutoring to accelerate learning progress;

8. a method as in claim 6, wherein said making a plurality of assignments including making a multiple assignment assigning a subset of the best learning activities from said plurality of extra learning activities for final choice of one learning activity by said learner
whereby said tutoring method supports mixed initiative learning/tutoring and accelerates learning progress;

9. a method as in claim 3, wherein said adapting including improving said knowledge/data model including
a) incrementing knowledge/data supported tutoring decisions justified by learning process;
b) decrementing knowledge/data supported tutoring decisions not justified by learning process;
whereby said tutoring method improves itself and accelerates learning progress;

10. a system for tutoring a learner comprising
a) a media environment for physical supporting at least one learning activity of said learner,
b) a unified logic generator for making a plurality of tutoring decisions;
c) a media-logic converter associated with said media environment and said logic generator for executing said tutoring decisions in said media environment and for providing said logic generator with at least one learning report about said learning activity of said learner in said media environment,
wherein said logic generator monitors and controls over said learning activity of said learner in said media environment through said media-logic converter,
whereby said system includes separated media and logic components, provides unified logic-based generating the specific media-dependent tutoring process, simplifies authoring, improves quality of said tutoring process and accelerates learning success;

11. a system for tutoring the learner as in claim 10, wherein said unified logic generator including
a) a unified knowledge/data model referenced to said learner and said learning activity including
1) a memory for storing knowledge/data,
2) a unified reusable framework for representing specific knowledge/data in said memory;
3) said specific knowledge/data about said learner and said learning activity filled in said unified reusable framework.
b) a unified reusable tutoring engine including
1) a decision maker for making a plurality of tutoring decisions based upon said unified knowledge/data model;
2) a processor for adapting and particularly for updating said unified knowledge/data model based upon at least said learning report about at least said learning activity of at least said learner;
wherein said unified logic generator obtains said learning report about said learning activity of said learner in said media environment, adapts said unified knowledge/data model and makes said plurality of tutoring, decisions to control over said learning activity of said learner,
whereby said system provides unified reusable components for easy building any specific tutoring systems simplifies authoring, improves quality of said tutoring process and accelerates learning success,

12. a system as in claim 11, wherein said unified reusable framework including
a) a learning space framework for representing a logical space of said learning activity;
b) a learner data framework for representing said learner in said logical space;
whereby said unified reusable framework specifies a priori unknown generic structure of said tutoring knowledge/data model;

13. a system as in claim 12, wherein said learning space framework including at least
a) a behavioral space framework for representing essential traceable aspects of said learning activity including at least one said report;
b) a state space framework for representing untraceable aspects of said learning activity essential for making said plurality of tutoring decisions,
c) a state-behavior relation for associating said state space framework with said behavioral space framework;
whereby said learning space framework further specifies the generic structure of said tutoring knowledge/data and enables logical inference of untraceable aspects of the learning activity from traceable behavior;

14. a system as in claim 13, wherein said state space framework including
a) a plurality of learning objectives;
b) a plurality of possible achievement states of each learning objective from said plurality of learning objectives including at least
1) a no-achievement state,
2) a supplied achievement state and
3) a demonstrated achievement state;
wherein said no-achievement state can transit into said supplied achievement state and said supplied achievement state can transit into said demonstrated achievement state;
whereby said state space model further specifies a priori unknown generic structure of said tutoring knowledge/data about said untraceable aspects of said learning activity essential for making said plurality of tutoring decisions;

15. a system as in claim 12, wherein said learner data framework representing at least a plurality of beliefs corresponding to each learning objective from said plurality of learning objectives including at least
a) a no-achievement belief corresponding to said no-achievement state,
b) a supplied achievement belief corresponding to said supplied achievements state,
c) demonstrated achievement belief corresponding to said demonstrated achievement state,
whereby said beliefs flexibly position said learner into said state space framework;

16. a system as in claim 13, wherein said state-behavior relation for each learning objective from said plurality of learning objectives including
a) a local demonstrating belief associating a specific behavior from said behavioral space framework with said demonstrated achievement state of said learning objective;
b) a local supplying belief associating said specific behavior from said behavioral space framework with said supplied achievement state of said learning objective;
c) a local fault belief associating said specific behavior from said behavioral space framework with said no-achievement state of said learning objective;
whereby said state-behavior relation flexibly associates the expected cases of learning behavior with the learning states enabling logical inference of the learning states of said learner from the reported behavior of said learner in said learning media environment;

17. a system as in claim 11, wherein said decision maker including a strategic decision maker making particularly a plurality of diagnostic decisions each revealing at least one cause of a reported fault behavior of said learner in said learning media environment,
whereby said reusable tutoring engine enables focusing of the tutoring process on said cause of said fault behavior and corresponding acceleration of successful learning;

18. a system as in claim 17, wherein said processor including a reviser for revising said knowledge/data model based upon the diagnostic decision from said plurality of diagnosing decisions and focusing said logic generator on said cause of said fault behavior of said learner,
whereby said reviser focuses the whole tutoring system on said cause of said fault behavior of said learner and accelerates successful learning;

19. a system as in claim 11, wherein said decision maker including a tactic decision maker for making particularly a plurality of mode decisions including at least
a) a rule for setting up supply mode of tutoring;
b) a rule for setting up testing mode of tutoring;
c) a rule for setting up diagnosing mode of tutoring;
whereby said uniform tutoring engine dynamically adapts the mode of tutoring in order to accelerate successful learning;

20. a system as in claim 11, wherein said decision maker including an operative decision maker for assigning at least one best learning activity from said plurality of extra learning activities for the learner in each mode from said supply, testing and diagnosing modes,
whereby said logic generator eliminates prior manual sequencing of extra learning activities during authoring process, improve quality of said sequencing and accelerates successful learning in the tutoring stage.
